(19) United States
(12) Patent Application Publication
(10) Pub. No.: US 2026/0005907 A1
(43) Pub. Date: Jan. 1, 2026

(54) Device with Dual Correlator for Synchronizing to OFDM and Single Subcarrier OFDM Waveforms

(71) Applicant: Texas Instruments Incorporated, Dallas, TX (US)

(72) Inventors: Tomas Motos, Hamar (NO); Thomas Almholt, Murphy, TX (US)

(21) Appl. No.: 19/250,610

(22) Filed: Jun. 26, 2025

Related U.S. Application Data
(60) Provisional application No. 63/666,321, filed on Jul. 1, 2024.

(51) Int. Cl. H04L 27/26; H04J 11/00

(52) U.S. Cl. CPC H04L 27/2657; H04J 11/00

(57) ABSTRACT

In an embodiment, a device includes: a first receiver configured to: detect a first synchronization sequence of a first packet in a first subcarrier of a plurality of subcarriers, and in response to detecting the first synchronization sequence, receive, using a single subcarrier of the plurality of subcarriers at a time, a rest of the first packet using a first hopping sequence hopping through subcarriers of the plurality of subcarriers; and a second receiver configured to: detect a second synchronization sequence of a second packet in multiple subcarriers of the plurality of subcarriers, and in response to detecting the second synchronization sequence, receive a rest of the second packet using multiple subcarriers at a time.

### CROSS-REFERENCE TO RELATED APPLICATIONS

This application claims the benefit of U.S. Provisional Application No. 63/666,321, entitled “DEVICE WITH DUAL CORRELATOR FOR SYNCHRONIZING TO OFDM AND SINGLE SUBCARRIER OFDM WAVEFORMS,” and filed on Jul. 1, 2024, which application is hereby incorporated herein by reference.

This application is related to co-pending U.S. patent application Ser. No. ______, filed on the same day as this application, entitled “SINGLE SUBCARRIER OFDM COMMUNICATION WITH MULTIPLE SYNCHRONIZATION WAVEFORMS AND HOPPING SEQUENCES,” and associated with Attorney Docket No. T105002US02; and co-pending U.S. patent application Ser. No. ______, filed on the same day as this application, entitled “DEVICE WITH COMMON DEMODULATOR FOR SINGLE SUBCARRIER OFDM COMMUNICATION WITH MULTIPLE SYNCHRONIZATION WAVEFORMS AND HOPPING SEQUENCES,” and associated with Attorney Docket No. T105004US02, which application is hereby incorporated herein by reference.

### TECHNICAL FIELD

The present disclosure relates generally to an electronic system and method, and, in particular embodiments, to a device with dual correlator for synchronizing to orthogonal frequency-division multiplexing (OFDM) and single subcarrier OFDM waveforms.

### BACKGROUND

In frequency-division multiplexing (FDM), a transmitter can encode data in multiple frequency bands and transmit a radio-frequency (RF) signal that combines the signals from those frequency bands. The RF signal is a combination of multiple sub-carrier signals, each of which encodes information. Because unique information can be encoded in each frequency band, an FDM system typically has a higher data throughput relative to other systems that use only one carrier frequency.

In an orthogonal FDM (OFDM) system, each frequency band is orthogonal to the adjacent frequency bands (e.g., a center frequency of a first frequency band aligns with the null frequency of each adjacent frequency band). The orthogonality of the frequency bands may result in reduced interference across the carrier signals. As such, in an OFDM system, spacing between the center frequency of each sub-channel (also referred to as channel, sub-carrier band, or frequency band) can be closer to each other (e.g., sub-channels may overlap in frequency) than in an FDM system without orthogonality, where sub-channels do not overlap in frequency, as illustrated in FIG. 1. In addition, the orthogonality may allow for an OFDM receiver to more easily extract information from each frequency band of the combined RF signal.

### SUMMARY

In accordance to an embodiment, a device includes: a first receiver configured to: detect a first synchronization sequence of a first packet in a first subcarrier of a plurality of subcarriers, and in response to detecting the first synchronization sequence, receive, using a single subcarrier of the plurality of subcarriers at a time, a rest of the first packet using a first hopping sequence hopping through subcarriers of the plurality of subcarriers; and a second receiver configured to: detect a second synchronization sequence of a second packet in multiple subcarriers of the plurality of subcarriers, and in response to detecting the second synchronization sequence, receive a rest of the second packet using multiple subcarriers at a time.

In accordance to an embodiment, a device includes: a transmitter; and a controller configured to: during a first time, transmit, via the transmitter, a first synchronization sequence of a first packet in a first subcarrier of a plurality of subcarriers, and transmit, via the transmitter using a single subcarrier at a time, a rest of the first packet using a first hopping sequence hopping through subcarriers of the plurality of subcarriers; and during a second time, transmit a second synchronization sequence of a second packet using multiple subcarriers at a time.

In accordance to an embodiment, a method includes: detecting a first synchronization sequence of a first packet in a first subcarrier of a plurality of subcarriers; in response to detecting the first synchronization sequence, receiving, using a single subcarrier of the plurality of subcarriers at a time, a rest of the first packet using a first hopping sequence hopping through subcarriers of the plurality of subcarriers; and detecting a second synchronization sequence of a second packet in multiple subcarriers of the plurality of subcarriers.

In accordance to an embodiment, a method includes: during a first time, transmitting, by a device, a first synchronization sequence of a first packet in a first subcarrier of a plurality of subcarriers; and transmitting, by the device using a single subcarrier at a time, a rest of the first packet using a first hopping sequence hopping through subcarriers of the plurality of subcarriers; and during a second time, transmitting, by the device, a second synchronization sequence of a second packet using multiple subcarriers at a time.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates various exemplary channel arrangements for wireless communication;

FIG. 2 illustrates a communication system, according to an embodiment of the present disclosure;

FIG. 3 shows a schematic diagram illustrating an RF core, according to an embodiment of the present disclosure;

FIG. 4 shows a block diagram of a processing pipeline for generating a modulated signal for wireless transmission, according to an embodiment of the present disclosure;

FIGS. 5 and 6 show block diagrams of processing pipelines for processing a received modulated signal, according to embodiments of the present disclosure;

FIG. 7 shows a schematic diagram of a scrambler, according to an embodiment of the present disclosure;

FIG. 8 shows a schematic diagram of a de-scrambler, according to an embodiment of the present disclosure;

FIG. 9 shows a block diagram of a forward error correction (FEC) encoder, according to an embodiment of the present disclosure;

FIG. 10 shows a schematic diagram of a convolutional encoder, according to an embodiment of the present disclosure;

FIG. 11 shows a block diagram illustrating the operation of an interleaver, according to an embodiment of the present disclosure;

FIG. 12 shows a block diagram illustrating the operation of a de-interleaver, according to an embodiment of the present disclosure;

FIG. 13 shows a block diagram of a direct sequence spread spectrum (DSSS) modulator, according to an embodiment of the present disclosure;

FIGS. 14 and 15 show chip sequences for different DSSS values and polarities, according to embodiments of the present disclosure;

FIG. 16 shows a block diagram of a DSSS demodulator, according to an embodiment of the present disclosure;

FIG. 17 shows a block diagram of a BPSK encoder, according to an embodiment of the present disclosure;

FIG. 18 shows a block diagram of a BPSK decoder, according to an embodiment of the present disclosure;

FIG. 19 shows a block diagram of a single sub-carrier mapper, according to an embodiment of the present disclosure;

FIG. 20 shows a block diagram of an Inverse Fast Fourier Transform (IFFT) block 2000, according to an embodiment of the present disclosure;

FIG. 21 shows a block diagram of a Fast Fourier Transform (FFT) block, according to an embodiment of the present disclosure;

FIG. 22 illustrates the operation of a cyclic prefix with windowing function, according to an embodiment of the present disclosure;

FIGS. 23A-23D show data rates for various possible settings of an RF core, according to an embodiment of the present disclosure;

FIG. 24 shows a flow chart of an embodiment method for selecting communication parameters, according to an embodiment of the present disclosure;

FIG. 25 illustrates a packet structure of a physical layer (PHY) protocol data unit (PPDU), according to an embodiment of the present invention;

FIG. 26, shows a short training field (STF) bit sequence, according to an embodiment of the present disclosure;

FIG. 27, shows a long training field (LTF) bit sequence, according to an embodiment of the present disclosure;

FIG. 28 illustrates transmission of a packet encoded across multiple sub-carrier frequencies, according to an embodiment of the present disclosure;

FIGS. 29A and 29B show sets of possible values for two coefficients, respectively, of a linear congruential generator (LCG) for determining a hopping sequence, according to an embodiment of the present disclosure;

FIGS. 30-33 shows transmission of a plurality of packets, according to an embodiment of the present disclosure;

FIG. 34 shows a block diagram of a modulator, according to an embodiment of the present disclosure;

FIGS. 35 and 36 show block diagrams of demodulators, according to embodiments of the present disclosure;

FIG. 37 shows a flow chart of an embodiment method for receiving a packet, according to an embodiment of the present disclosure;

FIG. 38 shows a flow chart of an embodiment method for generating a hopping sequence, according to an embodiment of the present disclosure;

FIGS. 39 and 40 show flow charts of embodiment methods for packet exchanges, according to embodiments of the present disclosure;

FIG. 41 illustrates a communication system, according to an embodiment of the present disclosure;

FIGS. 42 and 43 shows a flow chart of an embodiment method for packet exchange, according to an embodiment of the present disclosure;

FIG. 44 illustrates symbol transmission of a communication system, according to an embodiment of the present disclosure;

FIGS. 45 and 46 illustrate communication systems, according to embodiments of the present disclosure;

FIG. 47 illustrates a device having N receivers for listening to N different synchronization carriers and hopping sequences, according to an embodiment of the present disclosure;

FIG. 48 illustrates a device having a common receiver path, N synchronizer blocks for listening to N different synchronization carriers, and a common demodulator, according to an embodiment of the present disclosure;

FIG. 49 illustrates a device having common receiver path, a dual correlation structure, and a dual demodulator, according to an embodiment of the present disclosure;

FIG. 50 illustrates a device having common a receiver path, a dual correlation structure, and reconfigurable demodulator, according to an embodiment of the present disclosure; and

FIG. 51 illustrates a device 5100 having a reconfigurable modulator, according to an embodiment of the present disclosure.

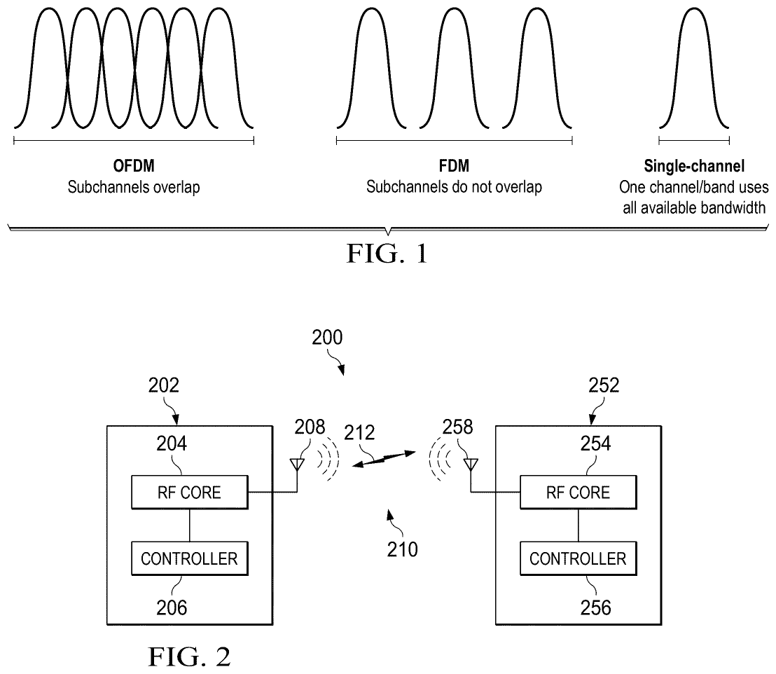

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Embodiments of the present disclosure are described in specific contexts, e.g., a long-range OFDM-based wireless communication system and method, e.g., suitable for internet-of-thing (IoT) devices. In some embodiments, long-range OFDM modulation offers a good tradeoff between long range (e.g., >150 dB of link budget), network capacity (e.g., multiple code access), and being a standardized solution without expensive central nodes and carrier subscriptions of other protocols. Long-range OFDM can also allow for good utilization of the time/frequency grid. Some embodiments may be used in short-range wireless communication systems. Some embodiments may not be OFDM-based, and may rely in other schemes, such as non-orthogonal FDM.

Some embodiments may operate in sub-1 GHz band(s) (e.g., bands between 470 MHz and 925 MHz). Some embodiments may, alternatively or in addition to sub-1 GHz band(s), operate in bands above 1 GHz, such as 2.4 GHz, 5 GHz, 6 GHz, 7 GHz, or higher, such as 60 GHz or higher.

Some embodiments may be implemented in or for IoT devices, such as in or for sensor devices that collect data and transmit such sensed data and/or for devices used for (e.g., remotely) controlling another device. In some embodiments, such IoT devices are battery powered (and may not be powered by mains). In some embodiments, such IoT devices may be battery-less (e.g., implemented with a small battery) or battery-free (implemented without a battery) and may harvest energy using energy harvesting methods, such as backscattering.

Some embodiments may be implemented in or for devices that may not be considered IoT devices.

Some embodiments may be implemented in or for devices powered by mains.

Some embodiments may be used in applications such as asset management, such as applications for monitoring/tracking assets. For example, in some embodiments, a device (e.g., an IoT device) may be attached to an asset (e.g., a tool, package, truck, etc.) and transmit location and/or other information/data to a receiver.

Some embodiments may be used in applications such as agriculture, such as applications for monitoring/tracking cattle, soil conditions etc. For example, in some embodiments, a device may be attached to cattle and transmit location and/or other information/data (e.g., health status, etc.) to a receiver. As another example, in some embodiments, a device may sense soil conditions (e.g., humidity, etc.) and transmit such sensed data to a receiver.

Some embodiments may be used in applications such as smart city. For example, in some embodiments, a device may monitor/track status of parking spots, and may transmit such information/data to a receiver (e.g., to allow for a driver to find an empty parking spot). As another example, in some embodiments, a device may be used to receive a controlling signal and control street lights based on the received signal.

Some embodiments may be used in metering applications. For example, in some embodiments, a device may monitor/track one or more parameters associated to electricity, water, and/or gas usage. The device may then transmit sensed data to a receiver.

In an embodiment of the present disclosure, a seed value for selecting a hopping sequence for wireless data transmission (e.g., for transmission of a long training field, a header field and/or a payload field of a packet) is selected based on a synchronization sequence (e.g., a short training field) associated with the packet.

In some embodiments, the seed value is selected based on which sub-channel the synchronization sequence is transmitted. In some embodiments, the seed value is selected based on one or more bits of the synchronization sequence.

In some embodiments, the hopping sequence is determined based on the seed value and on one or more coefficients. In some such embodiments, the seed value and/or the one or more coefficients change for each packet.

In some embodiments, the use of different hopping sequences may advantageously reduce the probability of collision between different transmitters, which may advantageously allow for multiple independent networks to coexist and use the same available sub-channels in the same geographical area, e.g., for long range transmissions. The use of different hopping sequences may also advantageously allow for a transmitter to (e.g., independently) serve multiple receivers (e.g., using a different synchronization sequence, synchronization channel, and/or hopping sequence for each).

In general, frequency-division multiplexing (FDM) transmitters encode information in multiple frequency bands and combine signals from the frequency bands for transmission. FDM systems have high throughput, as compared to some other communication systems. However, a transmitter implementing FDM may consume large amounts of power at peak conditions, resulting in a high peak-to-average-power ratio (PAPR). For example, the SUN OFDM PHY described in chapter 20 of IEEE Std 802.15.4-2020 and incorporated herein by reference, implements an OFDM modulation scheme that may exhibit a PAPR of about 8-9 dB.

In an embodiment, a transmitter using channels of an OFDM-based channel arrangement (e.g., having sub-channels overlapping in frequency), may encode information/data in only one sub-channel at a time, which may result in reduced PAPR (e.g., PAPR closer to one) compared to conventional OFDM systems. A reduced PAPR may advantageously result in higher data throughput (e.g., transmission of more bits per second) compared to systems with higher PAPR. In some embodiments, a reduced PAPR may be advantageous for long range transmissions.

Interference or noise experienced by a transmitter, receiver, or transceiver may be classified as vertical interference and horizontal interference. In an example of vertical interference, a transmitter, receiver, or transceiver, experiences a short burst of interference that impacts all of the frequencies used by transmitter, receiver, or transceiver. In an example of horizontal interference, a transmitter, receiver, or transceiver, experiences narrowband interference that impacts some, but not all, of the frequency bands in which the transmitter, receiver, or transceiver, operates.

In some embodiments, a transmitter may spread information/data across time using techniques such as direct sequence spread spectrum (DSSS). By spreading information/data across time, some embodiments may be advantageously more robust and resilient to vertical interference, such as temporary burst of energy that may temporarily jam or otherwise render unusable one or more (or all) communication channels available to the transmitter. In addition, DSSS spreading may advantageously provide redundancy for low sensitivity in some embodiments. As such, in some embodiments, transmitting information/data spread across time may advantageously facilitate long range transmissions.

Some embodiments may use, instead or in addition to DSSS, other spread spectrum techniques, such as frequency-hopping spread spectrum (FHSS), time-hopping spread spectrum (THSS), chirp spread spectrum (CSS), and/or a combination of two or more of DSSS, FHSS, THSS, and CSS.

In some embodiments, a transmitter may spread information across multiple frequency bands using techniques such as single carrier-frequency-division multiple access (SC-FDMA). By spreading information/data across frequency, some embodiments may be advantageously more robust and resilient to horizontal interference, such as temporal or permanent unavailability of one or more communication channels available to the transmitter (e.g., due to jamming, noise or other factors that may render a communication channel unusable). In some embodiments, a single carrier OFDM has no back-off and a PAPR of zero dB, creates an orthogonal time/frequency grid, and/or uses a set of pseudo-random codes that provide code diversity between nodes and networks. As such, in some embodiments, transmitting information/data spread across frequency may advantageously facilitate long range transmissions.

In some embodiments, a transmitter may use error correction techniques, such as forward error correction (FEC), which may advantageously allow a receiver to recover corrupted data. By enabling error detection and correction, in some embodiments, a receiver may be able to reconstruct the received data, even when portions of the received data is incomplete (e.g., due to lost packets, e.g., as a result of one or more (or all) channels being temporary unavailable, and/or due to one or more channels being permanently unavailable). As such, in some embodiments, transmitting information/data with error correction capabilities may advantageously facilitate long range transmissions.

In some embodiments, a transmitter may use cyclic prefix to repeat all (or a portion) of each symbol (e.g., before or after transmission of each symbol), which may advantageously result in additional transmission redundancy. As such, in some embodiments, transmitting information/data with cyclic prefix may advantageously facilitate long range transmissions.

In some embodiments, a transmitter may add a guard interval between symbols, which may advantageously reduce intersymbol interference between adjacent symbols. As such, in some embodiments, transmitting symbols with an intersymbol guard interval may advantageously facilitate long range transmissions.

In some embodiments, a transmitter may transmit symbols in pairs, where each pair of symbols is transmitted in a single sub-channel, and where each symbol of each pair is differentially encoded (e.g., using binary phase shift keying (BPSK)). By transmitting a pair of differentially encoded symbols (e.g., using BPSK) in a single sub-channel, in some embodiments, the pair of symbols share a common phase reference, which may advantageously allow for successful decoding without precise channel equalization. Further, in some embodiments, BPSK may provide a good demodulation signal-noise ratio.

Some embodiments may use, instead or in addition to BPSK, other digital modulation techniques, such as frequency-shift keying (FSK), gaussian FSK (GFSK), amplitude-shift keying (ASK), quadrature amplitude modulation (QAM), amplitude and phase-shift keying (APSK), continuous phase modulation (CPS), minimum shift keying (MSK), on-off keying (OOK), and/or a combination of two or more of PSK, GFSK, BPSK, FSK, ASK, QAM, APSK, CPS, MSK and OOK.

In some embodiments, each pair of symbols is sent in respective sub-channels selected in accordance with a hopping sequence. In some embodiments, the use of different hopping sequence may reduce the probability of collision between different transmitters operating according to different hopping sequences, which may advantageously allow for multiple independent networks to coexist and use the same available sub-channels in the same geographical area, e.g., for long range transmissions.

In some embodiments, a synchronization sequence is used to transmit a seed indicative of the hopping sequence from a transmitter to a receiver. As such, in some embodiments, a transmitter may independently serve a plurality of receivers. In some embodiments, multiple transmitter may independently serve multiple receivers by each transmitter using a distinct hopping sequence, e.g., for long range transmissions.

In some embodiments, the synchronization sequence is transmitted (e.g., in its entirety) in a single (e.g., predetermined) sub-channel. As such, in some embodiments, a (e.g., low power) receiver (e.g., such as an IoT device) may periodically transition from a low power mode to a high power mode to listen to a predetermined sub-channel. Upon detection of the synchronization sequence, the receiver may begin hopping according to a hopping sequence based on the synchronization sequence for transmission and/or reception of data. As such, in some embodiments, using a single predetermined sub-channel for transmission of the synchronization sequence may advantageously allow for low power consumption of a receiver (e.g., since the receiver monitors a single sub-channel for predetermined windows of times as opposed to scanning multiple sub-channels).

In some embodiments, multiple independent networks may advantageously coexist and use the same available sub-channels in the same geographical area by transmitting respective synchronization sequences in respective (different) sub-channels.

FIG. 2 illustrates communication system 200, according to an embodiment of the present disclosure. Communication system 200 includes wireless devices 202 and 252 communicating via network 210.

In some embodiments, communication between device 202 and device 252 may be symmetrical. As such, in some embodiments, the method for transmitting data from device 202 to device 252, and receiving data by device 252 from device 202, may be similar or identical to the method for transmitting data from device 252 to device 202, and receiving data by device 202 from device 252. Although some features of some embodiments may be described with respect to a particular device (e.g., 202/252), such features may be equally applicable to other devices (e.g., 252/202).

In some embodiments, device 202 may be an access point (AP) with access, via a wired or wireless protocol, to another network (e.g., an intranet, the Internet, etc.), while device 252 may be an IoT device, such as an IoT sensor. In some embodiments, devices 202 and 252 may each be an IoT device, such as an IoT sensor. In some embodiments, devices 202 and 252 may each be an AP device with access, via a wired or wireless protocol, to another network (e.g., an intranet, the Internet, etc.).

For clarity purposes, many of the embodiments describe assume that device 202 is an AP device while device 252 is an IoT sensor device. However, it is understood that the illustrated features and inventive concepts may equally apply to embodiments in which device 202 is not an AP (e.g., is an IoT device, or a non-IoT device that is not an AP), and/or device 202 is not an IoT sensor device (e.g., is a non-sensor IoT device, an AP device, or another device that is not considered an AP device or an IoT device).

In some embodiments, device 252 may enter a low power mode between (e.g., periodic) data transmissions, and may operate in a high power mode during the data transmissions. In some embodiments, device 252 may not enter low power mode between data transmissions.

In some embodiments, device 252 may use Pure ALOHA medium access schemes or similar while device 202 is in an always listening mode (e.g., does not enter low power mode). In some such embodiments, device 252 may transmit a packet to device 202 and then immediate change to receiver mode to receive an acknowledgement (ACK) from device 202. As a result, in some embodiments, device 252 can be in idle/low power mode the majority of the time and only spend energy when device 252 needs to transmit data and then receive the corresponding ACK. This mechanism may be understood as half-duplex.

In some embodiments, device 202 may enter a low power mode between (e.g., periodic) data transmissions, and may operate at a high power mode during the data transmissions. In some embodiments, device 202 may not enter low power mode between transmissions.

In some embodiments, device 252 may send one or more packets (e.g., including sensor data, and/or a command) at any time (e.g., synchronously or asynchronously) to device 202; device 202 may receive such packet(s). In response, device 202 may transmit one or more packets (e.g., including an ACK, a command, and/or data) to device 252, which may be listening for such packet(s). In some such embodiments, device 252 may enter low power mode between transmissions and device 202 may not enter low power mode between transmissions. In other such embodiments, one of devices 202 and 252 may enter low power mode between transmissions while the other one of devices 202 and 252 does not enter low power mode between transmissions. In yet other such embodiments, devices 202 and 252 do not enter low power mode between transmissions.

In some embodiments, device 202 may transmit (e.g., synchronously or asynchronously) one or more packets to device 252, e.g., not in response to packets received from device 252. In some such embodiments, device 252 may periodically wake up from low power mode to listen for communications, e.g., from device 202. In other such embodiments, device 252 may not enter low power mode between transmissions and may continuously listen for such packet(s).

During normal operation, device 202 wirelessly transmits via RF core 204 and antenna 208 first data to device 252. Device 252 receives the first data, and then decodes and processes the first data. Device 252 may then wirelessly transmit, via RF core 254 and antenna 258, second data to device 202 (or to another device, not shown in FIG. 2).

In some embodiments, devices 202 and 252 may be separated by a distance that is relatively large, such as 1 Km, 2, Km, 10 Km, 15 Km, or larger. In some embodiments, devices 202 and 252 may be separated by a distance shorter than 1 Km, such as 500 m, 100 m, 30 m, 10 m, 5 m, 1 m, or shorter.

In some embodiments, device 202 and/or device 252 may be a mobile device, and may move during transmission of data (such that the distance between devices 202 and 252 may dynamically change). In some embodiments, device 202 and/or device 252 may be at a fixed location during transmission of data.

In some embodiments, device 252 may comprise a sensor such as a temperature sensor, humidity sensor, location sensor, vibration sensor, etc. In some such embodiments, device 252 may wireless transmit data to device 202 based on sensed data sensed by the sensor.

In some embodiments, device 202 may, in response to data received from device 202, operate another device (not shown in FIG. 2) or cause an action in the another device based on the received data. In some embodiments, the another device includes a motor, a speaker, a microphone, a solenoid, a (e.g., LED) light, a solar cell, a battery, a radar, a memory, and/or other electronic circuit(s), such as a processor, power management circuits, etc. In some embodiments, device 252 may, in response to data received from device 202, cause the start, stop, or change a mode of energy harvesting; activate, deactivate, or change operation of a motor, solenoid or light; store/erase/modify data to/from a memory; play or stop playing a sound; begin or stop recording data using a sensor, such as microphone, humidity sensor, temperature sensor, etc.; activate, deactivate, or change operation of a radar; change operation of an electronic circuit of another device coupled to device 252, etc.

As shown in FIG. 2, device 202 includes RF core 204 and controller 206; and device 252 includes RF core 254 and controller 256.

In some embodiments, RF cores 204 implements the physical (PHY) layer and at least part (or all) of the data link layer (e.g., MAC layer) of wireless protocol 212 used for communicating via network 210, while controller 206 implements higher level layers (e.g., network layer, transport layer, session layer, presentation layer, and/or application layer). In some embodiments, controller 206 may implement all of the data link layer of wireless protocol 212. In some embodiments, controller 206 may implement at least part of the PHY layer of wireless protocol 212. Other implementations are also possible.

In some embodiments, RF core 204 is configured to assemble bits in a given packet structure for transmission using antenna 208.

In some embodiments, RF core 204 supports multiple modulation formats, including (e.g., multilevel) GFSK and MSK, OOK, BPSK, and CSS, among others.

In some embodiments, RF core 204 has dedicated handling accelerators, e.g., for forward error correction, data whitening, and/or automatic cyclic redundancy checks (CRC). In some embodiments, RF core 204 includes additional accelerators. In some embodiments, RF core 204 does not include any hardware accelerators.

In some embodiments, RF core 204 includes a wireless transceiver including a transmission path and a reception path coupled to antenna 208. In some embodiments, the transmission path includes a power amplifier having an output coupled to antenna 208. In some embodiments, the reception path includes a low-noise amplifier having an input coupled to antenna 208. In some embodiments, RF core 204 includes one or more analog-to-digital converters (ADCs), one or more digital-to-analog converters (DACs), one or more mixers, a combiner circuit (e.g., a parallel to serial circuit), and/or a splitter circuit (e.g., a serial to parallel circuit), a (e.g., digital) phase-locked-loop (PLL), a modem, read-only memory (ROM), random-access memory (RAM), such as SRAM, one or more filters, and/or one or more amplifiers, to facilitate wireless transmission and reception of data using antenna 208. Other implementations may also be possible. For example, in some embodiments, RF core 204 may be implemented using direct RF sampling.

In some embodiments, such as shown in FIG. 2, a single antenna 208 is used for transmission and reception of data. In some embodiments, more than one antenna may be used for transmission and reception of data (e.g., one or more antennas may be used for transmission while other antenna(s) may be used for reception).

In some embodiments, controller 206 may generate or cause generation of data to be wirelessly transmitted by RF core 204 via antenna 208, and/or may process data received by RF core 204 via antenna 208.

In some embodiments, controller 206 may be implemented as a generic or custom controller, processor, or processing core, e.g., coupled to a memory and configured to execute instructions in such memory. In some embodiments, controller 206 may be implemented using a field programmable gate array (FPGA). In some embodiments, controller 206 includes a state machine. In some embodiments, controller 206 may be implemented with or include synthesized logic. Other implementations are also possible.

In some embodiments (such as shown in FIG. 2), controller 206 may be external to RF core 204. In some embodiments, controller 206 may be partially or entirely implemented inside RF core 204.

In some embodiments, RF core 204 and controller 206 may be implemented in a single monolithic semiconductor substrate. In some embodiments, RF core 204 and controller 206 may be implemented in different dies in a single package. In some embodiments, RF core 204 and controller 206 may be discrete integrated circuits implemented in a printed circuit board (PCB). Other implementations are also possible.

As shown in FIG. 2, RF core 204 may be coupled to antenna 208. In some embodiments, antenna 208 is external to a package including RF core 204. In some embodiments, antenna 208 is implemented in the same package as RF core 204.

In some embodiments, RF core 254 may be implemented in a similar or identical manner as RF core 204. In some embodiments, controller 256 may be implemented in a similar or identical manner as controller 206. In some embodiments, device 252 may be implemented in a similar or identical manner as device 202.

In some embodiments, devices 202 and 252 may be instances of a same design. As such, in some embodiments, devices 202 and 252 may operate using similar or identical configurations. In some embodiments, although the design of devices 202 and 252 may be similar or identical, devices 202 and 252 may operate with different configurations (e.g., which may be programmed into such devices in response to communications via network 210, by a manufacturer of devices 202 and/or 252, and/or by a user of the device 202 and/or 252, e.g., not via network 210).

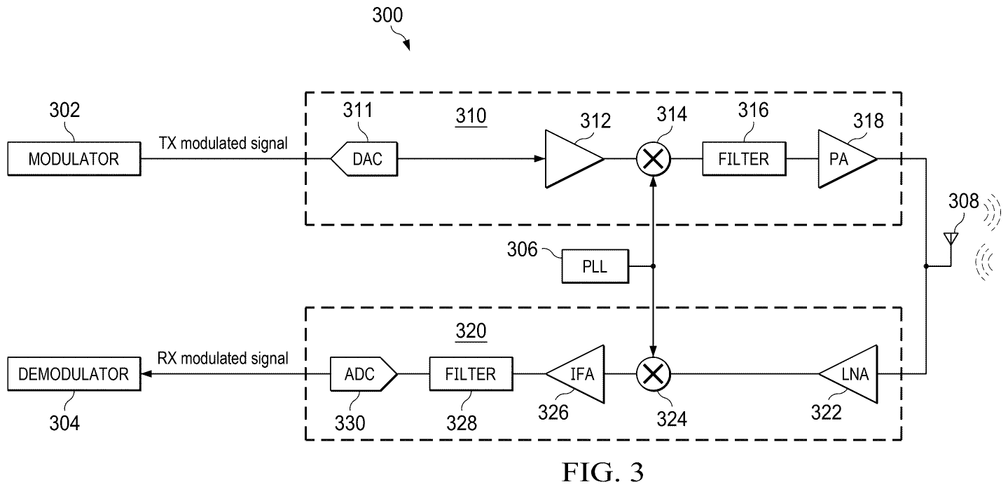

FIG. 3 shows a schematic diagram illustrating RF core 300, according to an embodiment of the present disclosure. RF core 204 and/or 254 may be implemented as RF core 300.

RF core 300 includes PLL 306, transmitter path 310, and receiver path 320. Transmitter path 310 includes DAC 311, pre-amplifier 312, mixer 314, analog filter 316, and power amplifier 318. Receiver path 320 includes low-noise amplifier (LNA) 322, mixer 324, intermediate frequency (IF) amplifier 326, analog filter 328, and ADC 330.

In some embodiments, during normal operation, when RF core 300 is in transmit mode, transmitter path 310 receives TX modulated signal from modulator 302 for wireless transmission via antenna 308. In some embodiments, when RF core 300 is in receive mode, receiver path 320 generates RX modulated signal based on signals received from antenna 308, and provides the RX modulated signal to demodulator 304 for further processing.

In some embodiments, antenna 308 is coupled to amplifiers 318 and 322 via a duplexer (not shown).

In some embodiments, RF core 300 also includes modulator 302 and/or demodulator 304. In some embodiments, modulator 302 and/or demodulator 304 includes, or may be implemented using, a generic or custom controller, processor, or processing core, e.g., coupled to a memory and configured to execute instructions in such memory. In some embodiments, modulator 302 and/or demodulator 304 includes, or may be implemented using, a field programmable gate array (FPGA). In some embodiments, modulator 302 and/or demodulator 304 includes a state machine. In some embodiments, modulator 302 and/or demodulator 304 includes or may be implemented as a hardware accelerator(s). Other implementations are also possible.

In some embodiments, modulator 302 and/or demodulator 304 are external to RF core 300 (e.g., are part of a controller (e.g., 206, 256) external to RF core 300).

In some embodiments, analog filter 276 and/or 288 include low pass or bandpass filters, and may have programmable gain. Elements 306, 312, 314, 316, 318, 322, 324, 326, 328, and 330 may be implemented in any way known in the art.

In some embodiments, modulator 302 generates a digital signal (TX modulated signal) to be transmitted by transmitter path 310 via antenna 308. In some embodiments, modulator 302 includes a DAC to convert such digital signal into a corresponding modulated analog signal provided to the input of pre-amplifier 312. In some embodiments, such DAC is external to modulator 302 and may be part of transmitter path 310 (such as shown in FIG. 3).

In some embodiments, demodulator 304 processes received digital signals (RX modulated signal) provided by ADC 330 from receiver path 320.

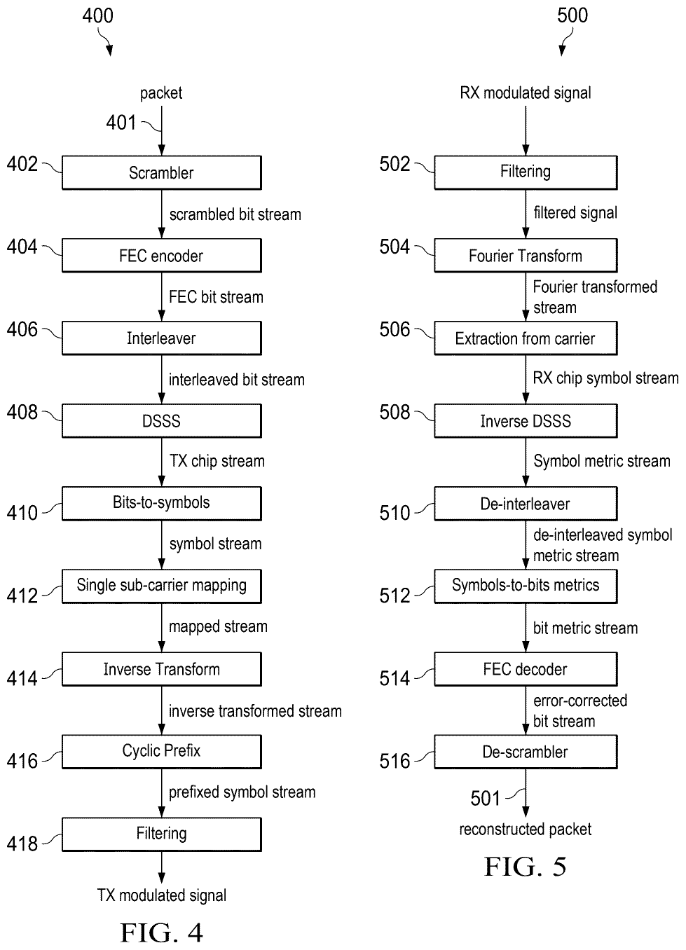

FIG. 4 shows a block diagram of processing pipeline 400 for generating TX modulated signal for wireless transmission, according to an embodiment of the present disclosure. Processing pipeline 400 may be implemented by modulator 302 (e.g., partially or entirely using dedicated circuits, such as hardware accelerators; and/or partially or entirely by executing instructions stored in a memory).

Processing pipeline 400 includes scrambler block 402, FEC block 404, interleaver block 406, DSSS block 408, bits-to-symbols block 410, single sub-carrier mapper block 412, inverse transform 414, cyclic prefix block 416, and digital filter block 418. In some embodiments, one or more of the blocks of processing pipeline 400 may be omitted or additional blocks (not shown) may be performed. In some embodiments, different portions of the packet are processed by different blocks (e.g., some portions of the packet may be scrambled while other portions may not be scrambled). Other implementations are also possible.

During normal operation, a packet 401 to be wirelessly transmitted via antenna 308 (e.g., using wireless protocol 212) may be received by processing pipeline 400. For example, in some embodiments, a payload is received (e.g., from the data link layer), and packet 401 is created (e.g., by the PHY layer), e.g., by adding a header and/or other fields to the payload.

In some embodiments, processing pipeline 400 receives (e.g., sequentially), a plurality of packets 401 to be transmitted. Processing pipeline 401 may processor each of the plurality of packets 401 sequentially, in parallel, and/or in a pipelined manner.

In some embodiments, scrambler 402 scrambles bits of the packet 401 to generate a scrambled bit stream. By scrambling the bits of the packet, some embodiments may advantageously improve signal quality (e.g., by preventing long sequences of 0s or 1s, and increase security for the transmission.

In some embodiments, FEC encoder 404 modifies the scrambled bit stream to generated an FEC bit stream that allows for error detection and correction. The use of FEC may advantageously allow for the recovery of data affected by horizontal or vertical interference.

In some embodiments, interleaver block 406 interleaves bits of the FEC bit stream across time to generate an interleaved bit stream. By interleaving the bits to be transmitted, some embodiments advantageously improve robustness of data transmission over vertical interference by spreading the data over time.

In some embodiments, DSSS block 408 encodes, e.g., each bit of the interleaved bit stream, into multiple bits (also referred to as chips). By adding redundancy using DSSS, some embodiments advantageously increase resistance to horizontal and vertical interference and jamming, and improve signal reliability. For example, in some embodiments, RF core 300 (e.g., demodulator 304, e.g., processing pipelines 500 or 600) or an associated controller (e.g., 206, 256) may be able to identify a bit in a received signal (e.g., RX modulated signal) even if one of the chips associated with such bit is corrupted by interference. For example, a short burst of interference may corrupt a chip, but the receiver can evaluate adjacent chips to identify the true value of the corrupted bit.

In some embodiments, DSSS block 408 may implement other spread spectrum techniques, in addition to or as an alternative to DSSS. Additional example details of DSSS in a communication system can be found in commonly assigned U.S. Patent Application Publication No. 2022/0255580, entitled “Frequency-Division Multiplexing,” filed on Dec. 17, 2021, commonly assigned U.S. Pat. No. 9,935,681, entitled “Preamble Sequence Detection of Direct Sequence Spread Spectrum (DSSS) Signals,” issued on Apr. 3, 2018, and commonly assigned U.S. U.S. Pat. No. 9,831,909, entitled “DSSS Inverted Spreading for Smart Utility Networks,” issued on Nov. 28, 2017, each of which is incorporated by reference in its entirety.

In some embodiments, bits-to-symbols block 410 converts each chip of the TX chip stream into a (e.g., OFDM) symbol to generate a symbol stream. In some embodiments, each symbol may be represented as a complex number with a real value and an imaginary value.

In some embodiments, bits-to-symbols block 410 may use a modulation process such as quadrature amplitude modulation (QAM) (e.g., 16-QAM) or phase shift keying (PSK) (e.g., binary PSK or quadrature PSK). In some embodiments, the ratio of chips representing each bits to symbols may be one-to-one, one-to-two, two-to-one, four-to-one, or any other ratio. For example, in some embodiments using BPSK, bits-to-symbols block 410 may convert each chip from DSSS block 408 to a respective symbol. Additional example details of PSK and QAM can be found in commonly assigned U.S. Pat. No. 9,001,948, entitled “Pulse Shaping in a Communication System,” issued on Apr. 7, 2015, which is incorporated by reference.

In some embodiments, single sub-carrier mapping block 412 generates a mapped stream in which each symbol of the symbol stream is mapped into a single sub-carrier signal (using only a single sub-channel of the available sub-channels). For example, in some embodiments, the mapped stream maps each symbol to a single input of inverse transform block 414, setting all other inputs of inverse transform block 414 to zero. Using a single sub-carrier signal at a time may advantageously result in lower PAPR and produce an RF signal that is easier for a receiver to demodulate.

Although a single sub-carrier may be used at a time, some embodiments change the sub-carrier periodically, e.g., according to a hopping sequence, which may advantageously spread the signal in frequency, which may advantageously improve robustness over horizontal interference.

In some embodiments, inverse transform block 414 computes an inverse Fast Fourier Transform (IFFT) on the symbols of the mapped stream to generate an inverse transformed stream that includes time-domain samples of the mapped symbols.

In some embodiments, cyclic prefix block 416 appends or prepends all or a portion of each symbol of the mapped stream to generate a prefixed symbol stream. Such cyclic prefix addition may advantageously act as a guard interval that may help reduce intersymbol interference, which may be an important consideration in multipath environments.

In some embodiments, digital filtering block 418 filters the samples of prefixed symbol stream to produce TX modulated signal, which may be provided to transmit path 310 for wireless transmission via antenna 308.

In some embodiments, digital filtering block 418 is not implemented and the samples generated by cyclic prefix block 416 constitute the TX modulated signal to be transmitted by antenna 308. In some embodiments, blocks 416 and 418 are not implemented and the output of inverse transform block 414 constitute the TX modulated signal to be transmitted by antenna 308. In some embodiments cyclic prefix block 416 is not implemented but digital filtering block 418 is implemented.

In some embodiments, one or more (or all) of blocks 402, 404, 406, 408, 410, 412, 414, 416, and 418 is configurable. For example, in some embodiments, one or more (or all) of blocks 402, 404, 406, 408, 410, 412, 414, 416, and 418 is configurable based on data received during a prior communication between devices 202 and 252.

In some embodiments, the TX modulated signal is wirelessly transmitted by transmitter path 310 of device 202, and is received by receiver path 320 of device 252 as RX modulated signal.

FIG. 5 shows a block diagram of processing pipeline 500 for processing RX modulated signal, according to an embodiment of the present disclosure. Processing pipeline 500 may be implemented by demodulator 304 (e.g., partially or entirely using dedicated circuits, such as hardware accelerators; and/or partially or entirely by executing instructions stored in a memory).

Processing pipeline 500 includes digital filtering block 502, Fourier transform block 504, extraction from carrier block 506, inverse DSSS block 508, de-interleaver block 510, symbols-to-bits metrics block 512, FEC decoder 514, and de-scrambler block 516. In some embodiments, one or more of the blocks of processing pipeline 500 may be omitted or additional blocks (not shown) may be performed. In some embodiments, different portions of the RX modulated signal are processed by different blocks (e.g., some portions of the signal may be processed by inverse DSSS block 508 while other portions may not be processed by inverse DSSS block 508). Other implementations are also possible.

During normal operation, an RX modulated signal wirelessly may be received via antenna 308 may be received by processing pipeline 500. In some embodiments, digital filtering block 502 filters the RX modulated signal (e.g., using low pass filtering) to generate a filtered signal.

In some embodiments, Fourier transform block 504 performs, e.g., after cyclic prefix removal, a Fourier transform (e.g., DFT, such as FFT), e.g., in an inverse manner than inverse transform block 414 so as to recover the symbols generated by single sub-carrier mapping block 412.

In some embodiments, extraction from carrier block 506 processes the Fourier transformed stream generated by Fourier transform block 504 to determine the single carrier frequency containing the symbols and generates an RX chip symbol stream with symbols based, e.g., on the phase, frequency, and/or modulation detected on the carrier signal, e.g., in accordance with a hopping sequence associated with the RX modulated signal.

In some embodiments, inverse DSSS block 508 uses the redundancy introduced by DSSS block 408 to generate a symbol metric stream, where each symbol metric of the symbol metric stream is indicative of the likelihood of a symbol corresponding to the associated multiple chips.

In some embodiments, de-interleaver block 510 de-interleaves the symbol metric stream (e.g., in an inverse manner as interleaver block 406) to produce a de-interleaved symbol metric stream.

In some embodiments, the symbols-to-bits metrics block 512 converts the de-interleaved symbol metric stream to a bit metric stream, (e.g., in an inverse manner as bits-to-symbols block 410), where each bit metric of the metric stream is indicative of the likelihood of a bit received.

In some embodiments, FEC decoder block 514 performs error correction on the bit metric stream so as to identify errors and correct any correctable errors, to generate an error-corrected bit stream.

In some embodiments, de-scrambler block 516 descrambles the error-correct bit stream (e.g., in an inverse manner as scrambler block 402) to generate a reconstructed packet 501.

In some embodiments, the reconstructed packet 501, when reconstructed successfully, may be identical to the packet 401. In some embodiments, the reconstructed packet 501, may include some, but not all fields of packet 401. For example, in some embodiments, a synchronization field (e.g., a short training field) that may be part of packet 401 may not be part of reconstructed packet 501. In some embodiments, the reconstructed packet 501 may include only a payload (e.g., identical to the payload of packet 401), while omitting all other fields.

In some embodiments, processing pipeline 500 processes RX modulated signal (e.g., continuously, e.g., for a predetermined period of time) so that when X packets 401 are transmitted (e.g., by device 202), X reconstructed packets are produced by processing pipeline 500 (e.g., of device 252).

In some embodiments, one or more (or all) of blocks 502, 504, 506, 508, 510, 512, 514, and 516 is configurable. For example, in some embodiments, one or more (or all) of blocks 502, 504, 506, 508, 510, 512, 514, and 516 is configurable based on data received during a prior communication between devices 202 and 252.

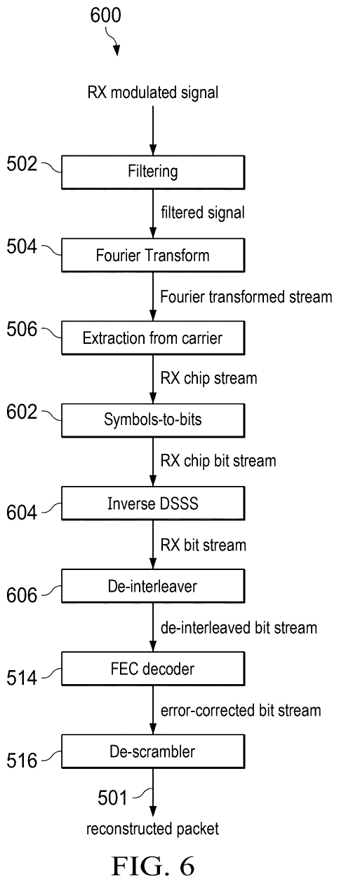

Some embodiments, such as shown in FIG. 5, may perform the inverse DSSS and de-interleaving steps on metrics, which may advantageously allow for improved error rate, which may be due to the RX chip symbol stream exhibiting noise and other artifacts (e.g., symbols may have crossed boundaries of other symbols). Other implementations are also possible. For example, FIG. 6 shows a block diagram of processing pipeline 600 for processing RX modulated signal, according to an embodiment of the present disclosure. Processing pipeline 600 may be implemented by demodulator 304 (e.g., partially or entirely using dedicated circuits, such as hardware accelerators; and/or partially or entirely by executing instructions stored in a memory).

Processing pipeline 600 operates in a similar manner as processing pipeline 500, and may generate a reconstructed packet 501 that may be identical to the reconstructed packet 501 generated by processing pipeline 500. Processing pipeline 600, however, performs a symbols-to-bits conversion (block 602 prior to performing the inverse DSSS (block 604) and de-interleaving steps (block 606). Other implementations are also possible.

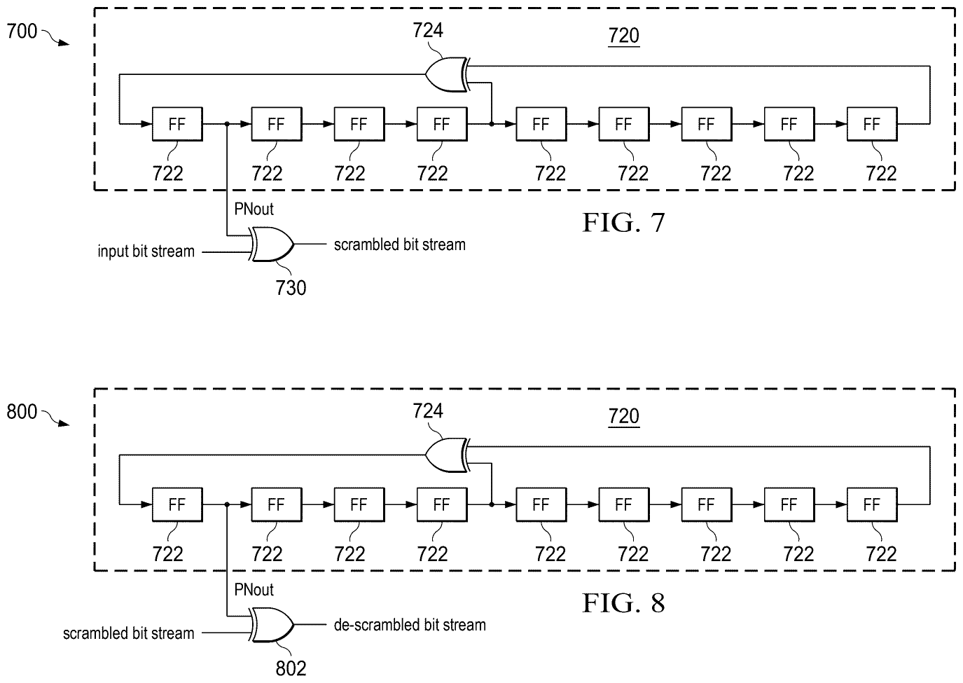

FIG. 7 shows a schematic diagram of scrambler 700, according to an embodiment of the present disclosure. Scrambler block 402 may be implemented as scrambler 700. Scrambler 700 includes pseudo-noise (PN) generator 720, and XOR gate 730. PN generator 720 includes a plurality of flip-flops (FFs) 722, and XOR gate 724. In some embodiments, PN generator is 720 is loaded/initialized with a seed (e.g., all ones—111111111), and is clocked using the seed as the starting point and enabled after the first clock cycle.

During normal operation, XOR gate 730 receives an input bit stream (e.g., of bits from packet 401), and an output PNₒᵤₜ from PN generator 720 to generate a scrambled bit stream.

As can be seen in FIG. 7, In some embodiments, the scrambled bits are found using XOR operation of each of the input bits with the output (PNout) of the PN generator, e.g., as follows:

$${bit}_{n} = ( input {bit}_{n} ) XOR ( PNout ) \qquad ( 1 )$$

FIG. 8 shows a schematic diagram of de-scrambler 800, according to an embodiment of the present disclosure. De-scrambler block 516 may be implemented as de-scrambler 800.

In some embodiments, de-scrambler 800 may be implemented in an inverse manner as scrambler 700. For example, as shown in FIG. 8, in some embodiments, de-scrambler 800 includes the same PN generator 720 (initialized in the same manner) as scrambler 700, and provides the PNout of such generator 720 to XOR gate 802, where the other input of XOR gate receives the scrambled bit stream, and the output of XOR gate 802 produces the de-scrambled bit stream.

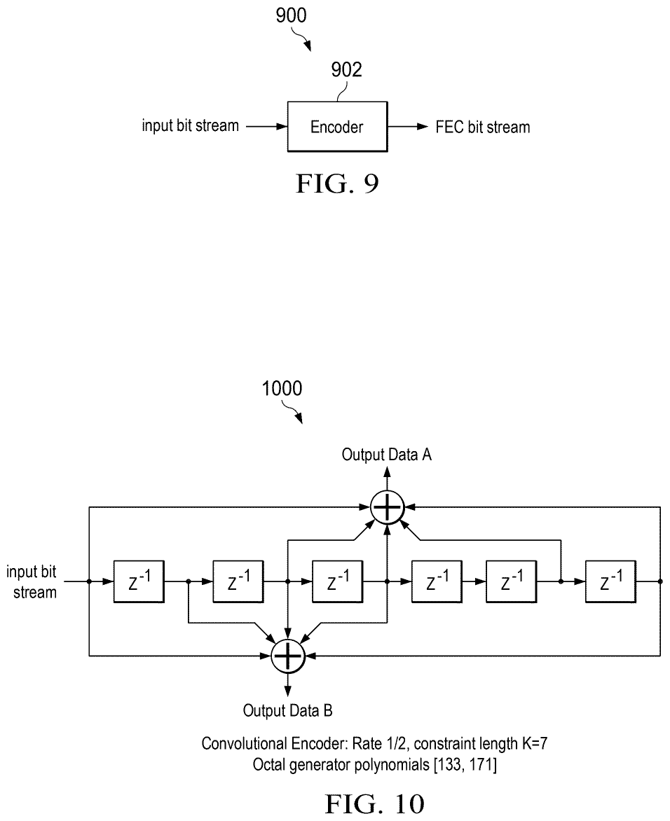

FIG. 9 shows a block diagram of FEC encoder 900, according to an embodiment of the present disclosure. FEC encoder block 404 may be implemented as FEC encoder 900. FEC encoder 900 includes encoder 902.

During normal operation, encoder 902 performs forward error correction by performing convolutional coding, channel coding, and/or polar coding on an input bit stream (e.g., from XOR gate 730) to generate the FEC bit stream. In some embodiments, encoder 902 uses a concatenated code including a Reed-Solomon block code and an inner half-rate convolutional code.

In some embodiments, FEC encoder 900 receives the input bits stream as a sequence of M bits, where M is a multiple of 8. In some embodiments, M may have a different value, such as higher than 8, e.g., 16, 32, or higher, or lower than 8, e.g., 4 or lower.

FIG. 10 shows a block diagram of convolutional encoder 1000, according to an embodiment of the present disclosure. Encoder 902 may be implemented as convolutional encoder 1000.

As shown in FIG. 10, convolutional encoder 1000 may include two outputs (Output Data A and Output Data B). In some embodiments, the two outputs are subsequently serialized to form a single FEC bit stream, which may be provided to a subsequent processing block (e.g., interleaver 406).

In some embodiments (e.g., as shown in FIG. 10), the input bits received by convolutional encoder 1000 are coded with a convolutional encoder of coding rate R=1/2. In some embodiments, the convolutional encoder uses the generator polynomials expressed in octal representation g₀=133₈ and g₁=171₈. Other implementations are also possible. For example, in some embodiments, the coding rate R may be different than 1/2, such as 3/4 or different, and/or may use different polynomials.

In some embodiments, convolutional encoder 1000 is initialized to the all zeros state before encoding the input bits and then reset to the all zeros states.

In some embodiments, FEC decoder 514 may be implemented in any way known in the art, so as to perform error correction on a bit stream generated using FEC encoder 900 (e.g., implementing encoder 1000).

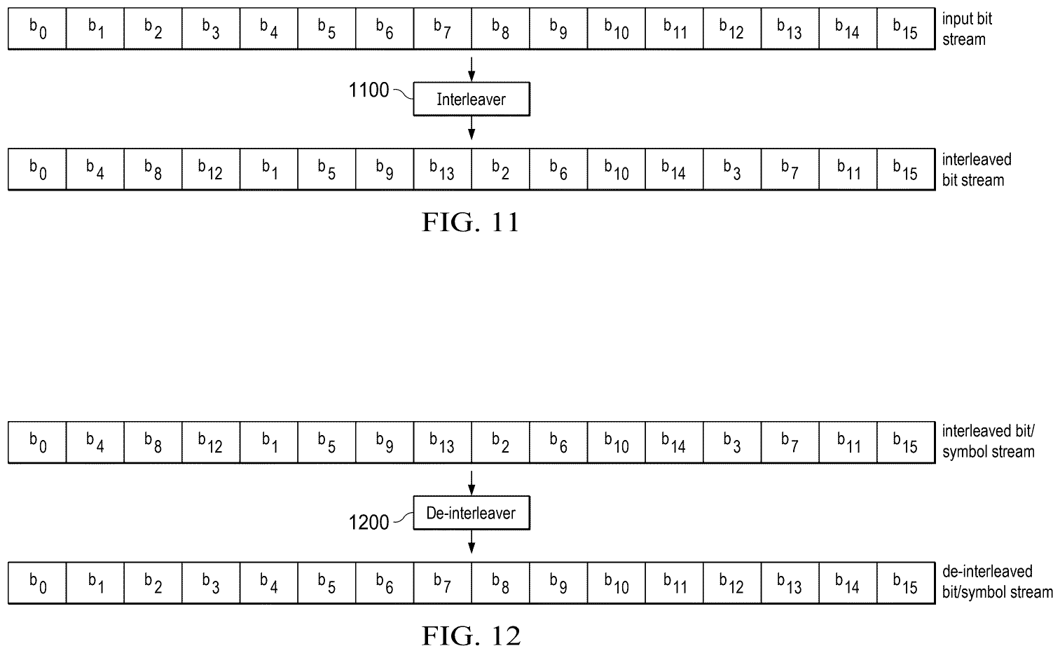

FIG. 11 shows a block diagram illustrating the operation of interleaver 1100, according to an embodiment of the present disclosure. Interleaver block 406 may be implemented as interleaver 1100.

As can be seen in FIG. 11, in some embodiments, interleaver 1100 receives an input bit stream and produces an interleaved bit stream. In the example of FIG. 11, the input bit stream and interleaved bit stream each contain 16 bits (b₀ to b₁₅), where interleaver 1100 rearranges the bits (e.g., b₀ to b₁₅) so that the interleaved bit stream contains the same bits as input bit stream, but in a different order.

In some embodiments, interleaver 1100 operates in a similar manner on symbols instead of bits. Thus, in some embodiments, interleaver 1100 receives an input symbol stream and produces an interleaved symbol stream, e.g., in a similar manner as described with respect to bits.

In some embodiments, interleaver 1100 takes as input a sequence of Q coded bits (e.g., coded by FEC encoder 900) and produces a second sequence of Q interleaved bits, where Q is a positive integer, such as a positive integer multiple of M. In some embodiments (as can be seen in FIG. 11), Q is equal to 16. In some such embodiments, M is equal to 8.

In some embodiments, the complete sequence of coded bits of length N produced by interleaver 1100 is defined as C={c(i)}, 0≤i≤N−1. In some embodiments, N is a multiple of 16 when M is equal to 8.

In some embodiments, a collection of consecutive subsequences of N bits produced by FEC encoder 900 may be processed by interleaver 1100 as first come first serve. In some embodiments, the collection of consecutive subsequences may be processed in a different order.

In some embodiments, interleaver 1100 performs the interleaving processes by performing 1 permutation. For example, in some embodiments, such as shown in FIG. 11, the index of the coded bit after the first permutation may be given by:

$$index = 4 \times [ k mod F ] + floor ( \frac{k}{F} ) \qquad ( 2 )$$

where k represents the coded bit before the first permutation and F represents a factor, mod represents the modulus operand, and floor( ) represents the floor function. In some embodiments, F is lower than M. In some embodiments, (such as shown in FIG. 11) F is equal to 4. In some embodiments, the interleaving process may be performed in a different manner, such as by performing more than 1 permutation, or according to a different formula.

In some embodiments, interleaver 1100 (e.g., continuously) processes the output of a preceding block (FEC encoder 404) in groups of Q bits, e.g., as the groups of Q bits are generated.

FIG. 12 shows a block diagram illustrating the operation of interleaver 1200, according to an embodiment of the present disclosure. De-interleaver blocks 510 or 606 may be implemented as de-interleaver 1200.

As shown in FIG. 12, in some embodiments, de-interleaver 1200 operates in an inverse manner as interleaver 1100, so as to remove the interleaving effect (de-interleave) introduced by interleaver 1100.

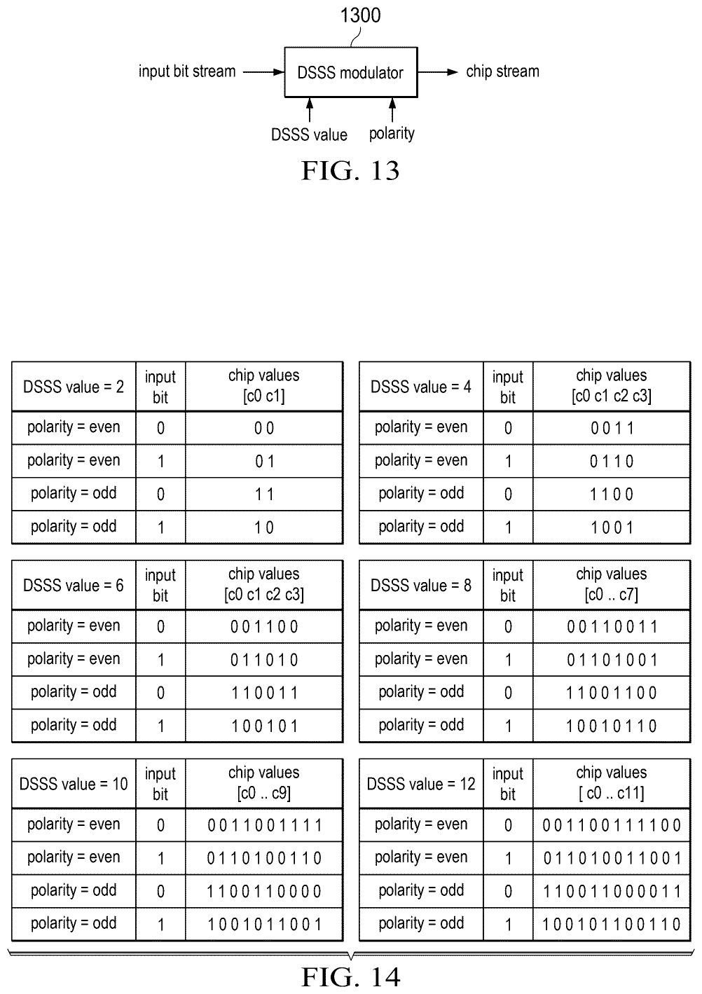

FIG. 13 shows a block diagram of DSSS modulator 1300, according to an embodiment of the present disclosure. DSSS block 408 may be implemented as DSSS modulator 1300.

In some embodiments, DSSS modulator 1300 receives an input bit stream, and generates a sequence of bits based on each bit of the input bit stream. Each of the bits of the generated sequence of bits may be referred to as a chip.

The number of chips generated for each input bit may be controlled by a DSSS value. For example, a DSSS value of 2 may cause the generation of 2 chips per input bit. Similarly, a DSSS value of 4 may cause the generation of 4 chips per input bit.

In some embodiments, the DSSS value may be a power of 2 (e.g., 2, 4, 8, 16, 32, 64, etc.). In some embodiments, the DSSS value may not be a power of 2 (e.g., 6, 10, 24, etc.). In some embodiments, the DSSS value may be an even number.

In some embodiments, the DSSS value of DSSS modulator 1300 is programmable, and may dynamically change, e.g., based on the portion of a packet (e.g., 401) being processed.

In some embodiments, the DSSS value is selectable from a set of DSSS values that are a power of 2 (e.g., 2, 4, 8, 16). In some embodiments, the DSSS value is selectable from a set of DSSS value that may include values that are, and are not a power of 2 (e.g., 2, 4, 6, 8, 12; 2, 4, and 6; or 2, 4, 8, 12, for example). In some embodiments, the DSSS value is selectable from a set of DSSS value that only include values that are not a power of 2 (e.g., 6, 12).

In some embodiments, the DSSS value of DSSS modulator 1300 is fixed. For example, in some embodiments, the DSSS value may be a predetermined value that is built into a communication device (e.g., 202 or 252). In some embodiments, a user may be able to set the DSSS value, such that the communication device selects a (e.g., fixed) DSSS value on user input.

The sequence of chips generated for each bit may be associated with a particular polarity. For example, when DSSS modulator 1300 operates with a DSSS value of 2 and an even polarity, an input bit of 1 may be represented by the sequence of chips [0 0], and an input bit of 0 may be represented by the sequence of chips [0 1]. When DSSS modulator 1300 operates with a DSSS value of 2 and an odd polarity, an input bit of 1 may be represented by the sequence of chips [1 1], and an input bit of 0 may be represented by the sequence of chips [1 0].

In some embodiments, the polarity of the sequence of chips is programmable, and may dynamically change, e.g., based on the portion of a packet (e.g., 401) being processed, may toggle every predetermined number of input bits being processed (e.g., every input bit, every 2 input bits, etc.), and/or every packet (e.g., a first packet starts with an even polarity, and a subsequence packet starts with another polarity), or every predetermined number of packets. For example, DSSS modulator 1300 may alternate between even and odd spreads, may use only an even spread, or may use only an odd spread, e.g., based on which portion of packet 401 is being processed.

In some embodiments, DSSS modulator 1300 may toggle between even an odd spread, e.g., to avoid multiple repetitions of the same sequence. For example, DSSS modulator 1300 may switch between even and odd spreads after each input bit or after a particular number of input bits. For example, in some embodiments, DSSS modulator 1300 may generate a first even spread of chips representing a first input bit and then generate a second odd spread of chips representing the next input bit. Thus, in some embodiments using DSSS value equal to 2, if three consecutive input bits have a logical value of one, the transmitter can generate an even spread of 00 representing the first input bit, an odd spread of 11 representing the second input bit, and an even spread of 00 representing the third input bit. Therefore, even though the three consecutive input bits may have the same logical value, the logical values of the chips representing the first input bit may be opposite of the logical values of the chips representing the second input bit. The logical values of the chips representing the first input bit are identical to logical values of the chips representing the third input bit but different from the logical values of the chips representing the second input bit.

In some embodiments, the polarity of the sequence of chips is fixed. For example, in some embodiments, the polarity may be a predetermined value that is built into a communication device (e.g., 202 or 252). In some embodiments, a user may be able to set the polarity, such that the communication device selects a (e.g., fixed) polarity on user input.

In some embodiments, transmitting multiple chips or symbols for each bit may advantageously improve robustness and redundancy, e.g., by spreading each bit across time and possibly across frequencies (e.g., in embodiments using frequency hopping). For example, if one chip becomes corrupted, a receiver with low sensitivity may still be able extract the value of the bit by evaluating the remaining chips in the sequence that represents the bit.

FIG. 14 shows chip sequences for different DSSS values and polarities, according to an embodiment of the present disclosure. DSSS modulator 1300 may convert input bits to chips in accordance to one or more of the tables shown in FIG. 14. In some embodiments, DSSS modulator 1300 may implement two or more of the tables shown in FIG. 14 as a selectable set (e.g., based on a selected DSSS value and/or polarity).

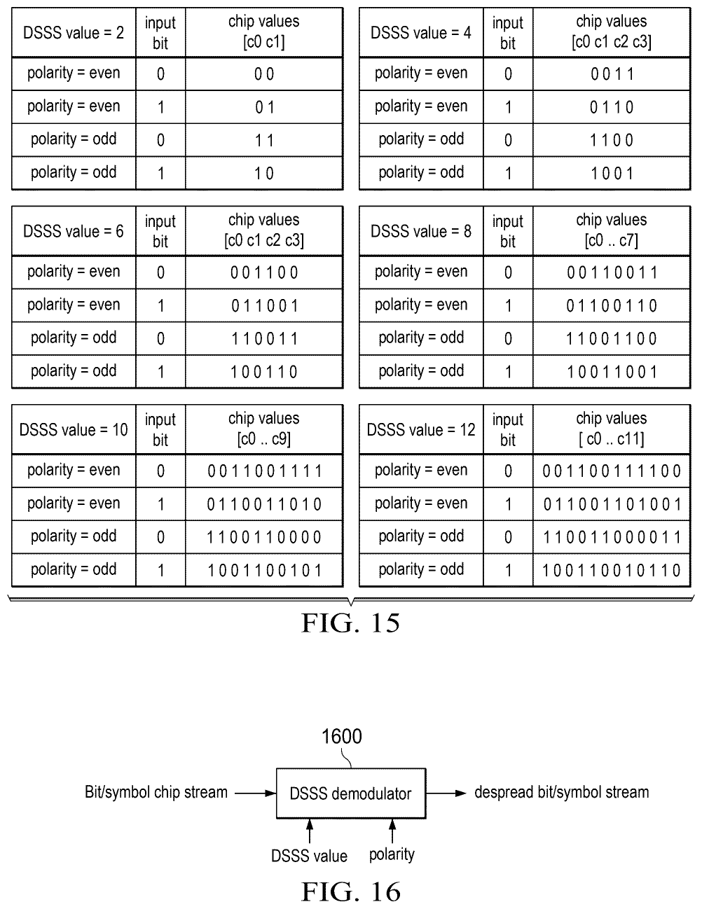

FIG. 14 shows a possible way of spreading input bits into sequences of chips. Other implementations are also possible. For example, FIG. 15 shows chip sequences for different DSSS values and polarities, according to an embodiment of the present disclosure. DSSS modulator 1300 may convert input bits to chips in accordance to one or more of the tables shown in FIG. 15. In some embodiments, DSSS modulator 1300 may implement two or more of the tables shown in FIG. 15 as a selectable set (e.g., based on a selected DSSS value and/or polarity).

As can be seen in FIGS. 14 and 15, a particular DSSS value and polarity may correspond to a different sequence of chips, e.g., depending on the particular implementation. For example, in some embodiments, for an input bit equal to 1, each of the corresponding pair(s) of chips should have the same chip value, and for an input bit equal to 0, each of the corresponding pair(s) of chips should have different chip values (although the order of the chip values may be implemented in different manners, e.g., as shown in FIGS. 14 and 15. Other implementations are also possible.

As shown in FIGS. 14 and 15, in some embodiments, each input bit is converted into a sequence of chips. In some embodiments, multiple input bits may be converted to a sequence of chips, where the input sequence has a length r (r being greater than 1), and the corresponding sequence of chips has a length s (s being greater than r). For example, some embodiments implement a two-to-eight DSSS, which converts two bits into a sequence of eight chips. In some such embodiments, each set of two input bits may have four possible values, where each of the four values is associated with at least one unique sequence of eight chips. As other examples, some embodiments may implement a two-to-sixteen DSSS and/or a four-to-sixteen DSSS for communication devices implementing DSSS. Other implementations are also possible.

In some embodiments, an N-bit input sequence input to DSSS modulator 1300 is converted to a sequence of N× (DSSS value) binary valued chips.

FIG. 16 shows a block diagram of DSSS demodulator 1600, according to an embodiment of the present disclosure. Inverse DSSS blocks 508 and 604 may be implemented as DSSS demodulator 1600.

As shown in FIG. 16, DSSS demodulator 1600 may operate with symbols (e.g., as in inverse DSSS block 508) or with bits (e.g., as in inverse DSSS block 604).

In some embodiments, DSSS demodulator 1600 operates in an inverse manner as the DSSS modulator used for modulating packet 401 (e.g., with the same DSSS value, polarity, and chip conversion table(s)) so as to recover the original sequence of input bits. For example, in an embodiment using DSSS equal to 2 and an even polarity, an input sequence 0 1 1 0 may be converted by DSSS modulator 1300 into the sequence of chips: 0 0 0 1 0 1 0 0. DSSS block 508 implementing DSSS demodulator 1600 receiving such sequence of bits, and configured with DSSS equal to 2 and an even polarity, generates the despread bit sequence 0 1 1 0 (e.g., by comparing each pair of bits to determine if a bit is corrupted). As another example, DSSS block 604 implementing DSSS demodulator 1600 receiving sequence of symbols S₀ S₀ S₀ S₁ S₀ S₁ S₀ S₀, and similarly configured, generates the despread symbol sequence S₀ S₁ S₁ S₀, where S₀ and S₁ represent the (e.g., OFDM) modulated symbol corresponding to a bit of 0 and 1, respectively.

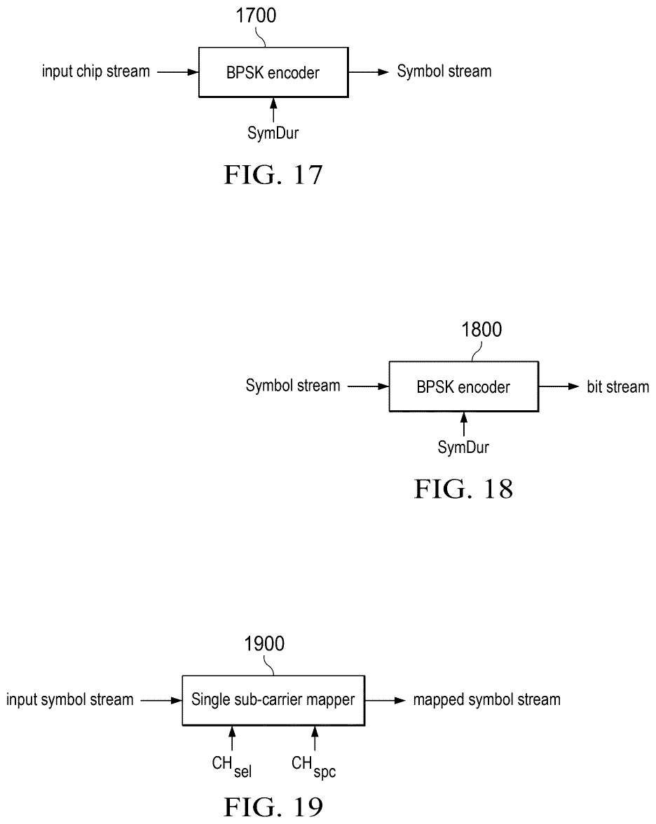

FIG. 17 shows a block diagram of BPSK encoder 1700, according to an embodiment of the present disclosure. Bits-to-symbols block 410 may be implemented as BPSK encoder 1700.

In some embodiments, BPSK encoder 1700 uses BPSK to map each input bit (e.g., each chip of input chip stream) into a symbol, e.g., according to the following BPSK encoding:

| Input | |
|---|---|
| chip | BPSK symbol |
| 0 | −1 + (0 × j) |
| 1 | 1 + (0 × j) |

Other implementations are also possible.

In some embodiments, the symbol duration SymDur of each symbol produced by BPSK encoder 1700 is fixed. In some embodiments, the symbol duration may be selectable from a set that includes: 120 μs, 60 μs, 30 μs, and 15 μs. Other symbol durations are also possible.

FIG. 18 shows a block diagram of BPSK decoder 1800, according to an embodiment of the present disclosure. Symbols-to-bits metrics block 512 and symbols-to-bits block 602 may be implemented as BPSK decoder 1800.

BPSK decoder 1800 may be implemented in an inverse manner as BPSK decoder 1700 so as to recover the bit that was used to generate the symbol by BPSK encoder 1700.

FIG. 19 shows a block diagram of single sub-carrier mapper 1900, according to an embodiment of the present disclosure. Single sub-carrier mapping block 412 may be implemented as single sub-carrier mapper 1900.

In some embodiments, single sub-carrier mapper 1900 maps each symbol of the input symbol stream to a single sub-carrier channel of the available set of (e.g., OFDM) channels. For example, when sub-channel select signal CHₛₑₗ indicates sub-channel 0, the next symbol of the input symbol stream is mapped to the sub-channel 0. More generally, if a set of available channels has L, when channel select signal CHₛₑₗ indicates sub-channel i (0<i<L), the next symbol of the input symbol stream is mapped to sub-channel i.

In some embodiments, for each time slot, single sub-carrier mapper 1900 maps a single symbol to a single sub-carrier by modulating a sine or cosine wave or switching between sine or cosine waves. In some embodiments, the total communication bandwidth of RF core 300 may be divided into multiple (e.g., P) frequency bands/channels (also referred to as active tones), and RF core 300 transmits via antenna 308 on one of the frequency bands at a time. In some embodiments, single sub-carrier mapper 1900 may select the same sub-channel for each pair of symbols, such that differentially encoded symbols (e.g., DBPSK) share the same sub-carrier. In some embodiments, P may be greater than L. In some embodiments, P may be equal to L.

In some embodiments, the spacing between channels CH_{spc} is fixed. In some embodiments, the spacing between channels CH_{spc} is selectable from a set that includes: 200 kHz, 400 KHz, 800 kHz, and/or 1200 kHz. In some embodiments, different sub-channel spacings may be used.

In some embodiments, P may configurable and may depend based on a particular setting of RF core 300. For example, in some embodiments, P is selectable from a set that includes: 12 channels, 26 channels, 52 channels, and/or 104 channels.

In some embodiments, the frequency band used for transmitting one or more symbols is predetermined (and may be fixed, e.g., CHₛₑₗ may be fixed, e.g., for an entire packet or groups of packets). In some embodiments, single sub-carrier mapper 1900 selects which frequency band to transmit one or more symbols based on a predetermined set of frequency bands, e.g., according to a (e.g., predetermined) hopping sequence. In some embodiments, single sub-carrier mapping block 310 selects which frequency band to send the symbols based on which portion of PPDU 400 is being transmitted.

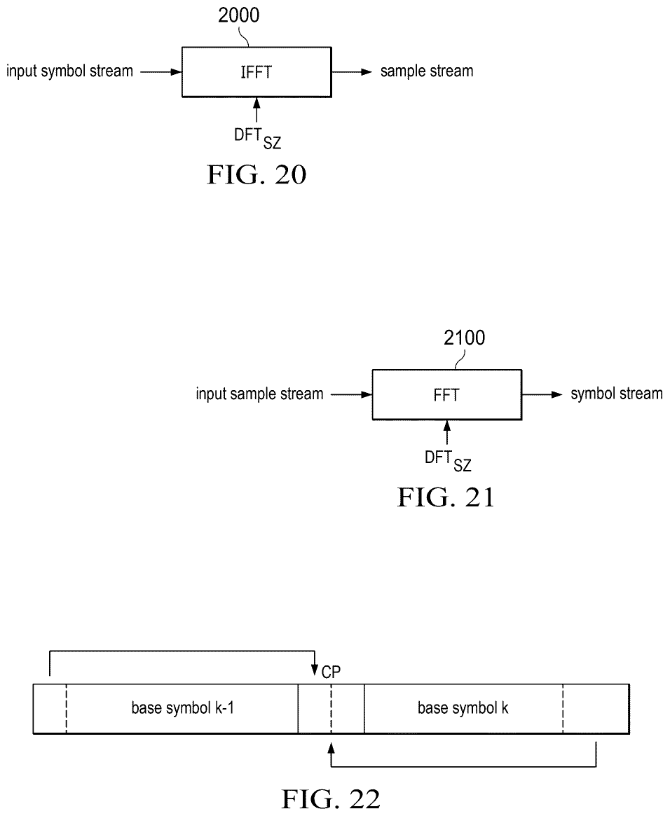

FIG. 20 shows a block diagram of IFFT block 2000, according to an embodiment of the present disclosure. Inverse transform block 414 may be implemented as IFFT block 2000.

In some embodiments, IFFT block 2000 computes an IFFT on the symbols of input symbol stream to generate a sequence of (e.g., time-domain) samples corresponding to the input symbols. In some embodiments, the number of samples per symbol DFT_{SZ} is fixed. In some embodiments, the number of samples per symbol DFTSZ is selectable from a set that includes: 16, 32, 64, and/or 128 samples per symbol. Other numbers of sample per symbol (e.g., powers of 2) may also be used.

FIG. 21 shows a block diagram of FFT block 2100, according to an embodiment of the present disclosure. Fourier Transform block 504 may be implemented as FFT block 2100.

In some embodiments, FFT block 2100 performs a Fourier transform on the input sample stream in an inverse manner as IFFT block 2000 (e.g., with the same DFT_{SZ} setting) so as to reconstruct the transmitted symbols used by IFFT block 2000 to generate the time-domain signal with the generated sequence of samples.

FIG. 22 illustrates the operation of cyclic prefix with windowing function, according to an embodiment of the present disclosure. Cyclic prefix block 416 may implement a cyclic prefix with windowing function as shown in FIG. 22.

In some embodiments, cyclic prefix block 416 repeats all or a portion of each symbol before and/or after such symbol. For example, in some embodiments, each of the symbols is prepended and/or appended with a cyclic prefix (CP), e.g., as shown in FIG. 22.

In some embodiments, the duration of the CP may be 1/4 of the base symbol duration, but other durations, such as 1/2 or different may also be used.

In some embodiments, the sum of the duration of the CP and the base symbol duration results into the overall symbol duration. For example, in some embodiments in which the duration of the CP is 1/4, of the base symbol, the overall number of samples for each symbol may be given by:

$$SZ = {DFT}_{SZ} + \frac{{DFT}_{SZ}}{4} \qquad ( 3 )$$

where DFT_{sz} represents the number of samples of the base symbol (e.g., generated by IFFT 2000). The overall symbol duration may be given by SZ times the base symbol duration. This is illustrated, e.g., in Table 1, according to an embodiment of the present disclosure.

TABLE 1
Cyclic prefix duration

| Base Symbol | CP | Symbol |
|---|---|---|
| Duration | Duration | Duration |
| 96 us | 24 us | 120 us |
| 48 us | 12 us | 60 us |
| 24 us | 6 us | 30 us |
| 12 us | 3 us | 15 us |

In some embodiments, to minimize the sidelobes of each of the subcarriers, a windowing filter may be applied during the first half of the Cyclic Prefix duration. For example, in some embodiments in which the symbol duration is ¼ of the base symbol, the windowing function may be applied to the first

$$\frac{{DFT}_{SZ}}{8}$$

samples of the CP).

In some embodiments, a windowing filter is not be applied during the cyclic prefix duration.

In some embodiments, for each current symbol k, the linear windowing function may combine samples of OFDM symbol k−1 together with samples of CP of symbol k. For example, in some embodiments in which the symbol duration is ¼ of the base symbol, the first

$$\frac{{DFT}_{SZ}}{8}$$

samples of OFDM symbol k−1 together with first

$$\frac{{DFT}_{SZ}}{8}$$

samples of the Cyclic Prefix of symbol k. In some embodiments, this combination may be linear, so that the samples from OFDM symbol k−1 are multiplied with a linear function that starts at 1 at sample 0 and stops at 0 at sample

$$\frac{{DFT}_{SZ}}{8}$$

and samples from the Cyclic Prefix and multiplied with a linear function that starts at 0 at sample 0 and stops at 1 at sample

$$\frac{{DFT}_{SZ}}{8} .$$

The result of the two multiplications may be added to produce the new Cyclic Prefix samples. Portions of this process are illustrated in FIG. 22.

In some embodiments, the base symbol duration is predetermined. In some embodiments the base symbol duration may dynamically change, e.g., based on a data received (e.g., via a previous transmission between devices 202 and 252). For example, in some embodiments, the base symbol duration may be selected dynamically from a set of base symbol durations, such as shown in Table 1.

In some embodiments, RF core 300 supports multiple options for spreading rates and multiple symbol rates. In some embodiments, the selected option determines the overall signal bandwidth (BW). In some embodiments, the bandwidth of each of the sub-carriers is based on the selected symbol duration. In some embodiments, the spreading rate (e.g., the DSSS value) provides an additional coding mechanism to increase redundancy and improve link budget.

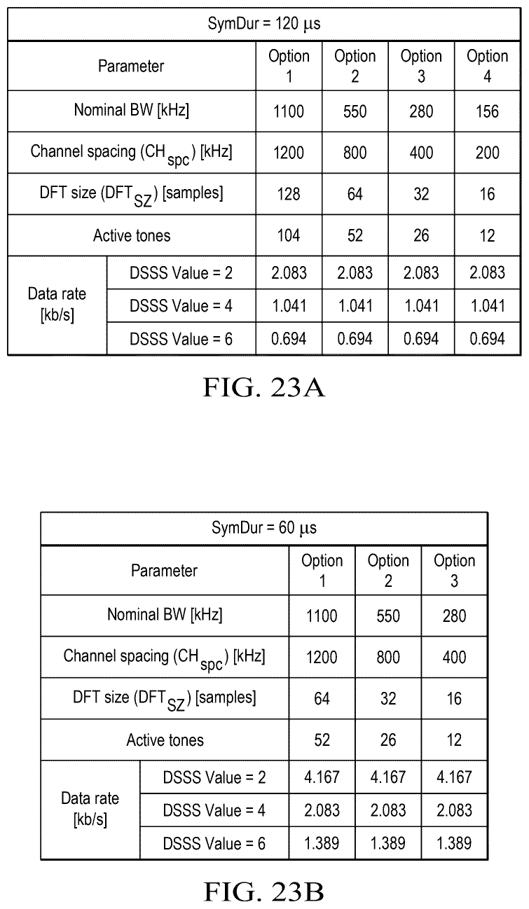

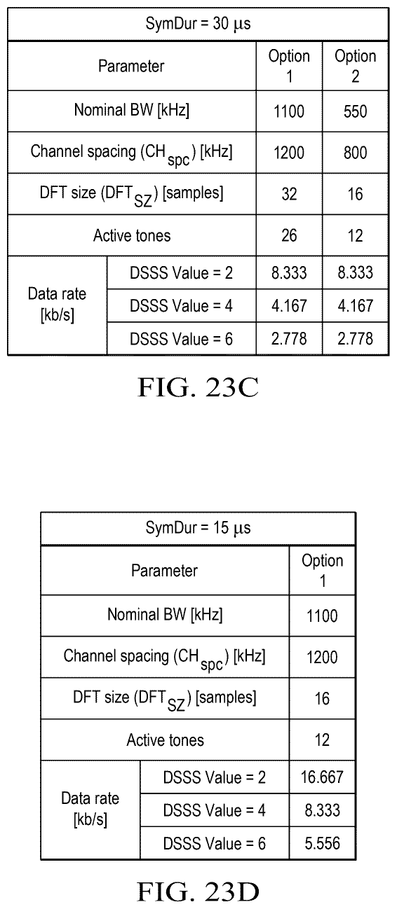

FIGS. 23A-23D show data rates for various possible settings of RF core 300, according to an embodiment of the present disclosure.

In some embodiments, the overall bandwidth of all frequency bands in which data can be encoded for transmission (e.g., under any of the settings shown in FIGS. 23A-23D) is 500 kHz (or greater), which may advantageously enable the use of asynchronous protocols in FCC regions. In some embodiments, the overall bandwidth may be lower than 500 kHz.

As shown in FIGS. 23A-23D, in some embodiments, RF core 300 may have multiple configurable parameters. For example, in an embodiment in which RF core 300 supports all of the parameter options shown in FIGS. 23A-23D, the symbol duration SymDur may be selectable from a set that includes 120 μs, 60 μs, 30 μs, and 15 μs. In some such embodiments, when symbol duration SymDur of 120 μs is selected, RF core 300 may be configured as option 1, option 2, option 3, or option 4, e.g., as shown in FIG. 23A. In some such embodiments, if option 1 is selected, the nominal bandwidth for communication is 1.1 MHz, with a channel spacing (e.g., overall channel spacing, e.g., referring to the collection of all sub-carriers, where the sub-channel spacing may be given by (5/4)*SymDur) of 1.2 MHz, with a DFT size DFT_{SZ} of 128 samples, with 104 sub-carrier channels (also referred to as active tones), and with a DSSS value that is selectable between 2, 4, and 6, selection of which affects the data rate (with higher DSSS values resulting in lower data rates).

As can be seen in FIGS. 23A-23D, for some symbol durations SymDur, some options may be unavailable. For example, as shown in FIG. 23D, for a symbol duration SymDur of 15 μs, options 2, 3, and 4 may be unavailable.

In some embodiments, the general relationship between the data rate, as a function of the symbol duration SymDur and DSSS value may be given by:

$$Data rate = \frac{1}{2 \times DSSS Value \times Sym Dur} \qquad ( 4 )$$

In some embodiments, selecting an option and symbol duration may be negotiated (e.g., in advance) by upper protocol layers (e.g., above the PHY layer, such as by the MAC layer, or above) of the devices (e.g., 202 and 252). In some embodiments, the spreading rate (the DSSS value) may be dynamically expressed per packet (e.g., including for specific portions within a packet), such as in a header of the packet.

In some embodiments, RF core may not use any pilot tones (e.g., may not use any channels for transmission of pilot signals, e.g., for synchronization.

In some embodiments, RF core 300 may support all of the settings shown in FIGS. 23A-23D. In some embodiments, RF core 300 may support other settings (not shown in FIGS. 23A-23D). In some embodiments, RF core 300 may some, but more than 1, of the settings shown in FIGS. 23A-23D. In some embodiments, RF core 300 may support only a single setting (e.g., any of the settings) of the settings shown in FIGS. 23A-23D.

As an example, in some embodiments, RF core 300 may support all of the option 2 settings listed in FIGS. 23A-23C (e.g., having DSSS values selectable between 2, 4, and 6; having symbol duration selectable between 120 μs, 60 μs, and 30 μs; and having the DFT size DFT_{SZ} selectable depending from a set that depends on the symbol duration SymDur, e.g., as shown in FIGS. 23A-23C).

In some embodiments, communication between device 202 and 252 use sub 1-GHz bands, such as bands between 470 MHz and 925 MHz. For example, some embodiments use one of the following bands for transmitting and/or receiving packets:
470-510 MHz;
779-787 MHz;
863-870 MHz;
865-867 MHz;
866-869 MHz;
870-876 MHz;
902-928 MHz;
902-928 (alternate) MHz;
902-907.5 MHz and 915-928 MHz;
915-928 MHz;
915-921 MHz;
915-918 MHz;
917-923.5 MHz;
919-923 MHz;
920-928 MHz;
920.5-924.5 MHz; and
920-925 MHz.

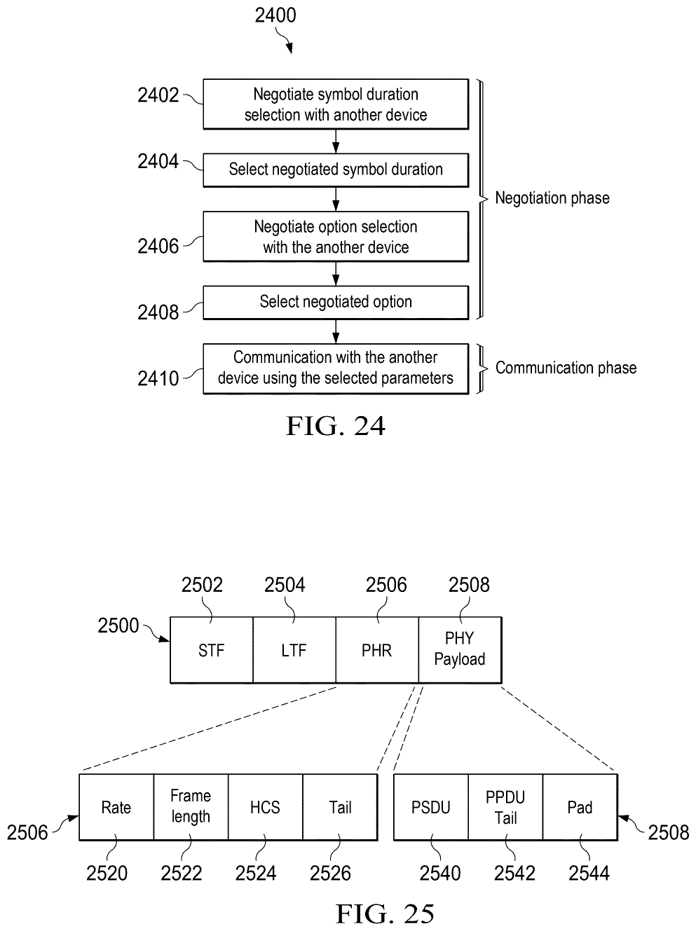

FIG. 24 shows a flow chart of embodiment method 2400, for selecting communication parameters, according to an embodiment of the present disclosure. In some embodiments, RF core 300, or an associated controller (e.g., 206, 256) may implemented method 2400.

During step 2402, a first device (e.g., 202), negotiates with a second device (e.g., 252) to select a symbol duration to be used during a communication phase between the first and second devices. In some embodiments, the first device negotiates with the second device by communicating with the second device using a default setting (e.g., SymDur=60 μs; option 2, according to FIG. 23B).

In some embodiments, both the first and second devices support various symbol durations (e.g., such as shown in FIG. 23A-23D). In some such embodiments, the symbol duration may be selected during step 2404 from a set of commonly supported symbol durations, e.g., based on the nature of the devices, environmental conditions, the nature of the particular application, etc. In some embodiments, if the set of commonly supported symbol durations only has one symbol duration, such symbol duration is selected during step 2404.

During step 2406, the first and second devices negotiate to select an option associated with the selected symbol duration, where selection of an option may imply selection of a DFT size DFT_{SZ}, number of active tones, etc., e.g., as shown in FIGS. 23A-23D. In some embodiments, both the first and second devices support various options (e.g., such as shown in FIG. 23A-23C). In some such embodiments, the option may be selected during step 2408 from a set of commonly supported options, e.g., based on the nature of the devices, environmental conditions, the nature of the particular application, etc. In some embodiments, if the set of commonly supported options only has one symbol duration (e.g., as shown in FIG. 23D, or if a device only supports option 2 of FIG. 23B), such option is selected during step 2408.

During step 2410, the first and second devices communicate using the parameters selected during steps 2404 and 2408.

FIG. 25 illustrates a packet structure of PPDU 2500, according to an embodiment of the present invention. Packet 401 may be implemented as PPDU 2500.

PPDU 2500 includes short training field (STF) 2502, long training field (LTF) 2504, physical header (PHR) field 2506, and PHY payload field 2508. PHR field 2506 includes rate field 2520, frame length field 2522, header check sequence (HCS) field 2526, and tail field 2526. PHY payload field 2508 includes PHY service data unit (PSDU) field 2540, PPDU tail field 2542, and pad field 2544.

In some embodiments, STF field 2502 may be used by RF core 300 (e.g., demodulator 304, e.g., processing pipelines 500 or 600) or an associated controller (e.g., 206, 256) for packet detection and/or for (e.g., coarse) frequency offset determination. In some embodiments, a portion of STF field 2502 may be configurable. For example, in some embodiments, that last bit of STF field 2502 may be configurable. In some such embodiment, the portion of the STF field 2502 used for packet detection and/or frequency offset determination may be a fixed (non-configurable) portion of STF field 2502, while the configurable portion of STF field 2502 may not be used for packet detection and/or for frequency offset determination.

In some embodiments, STF field 2502 includes 160 symbols. In some embodiments, STF field 2502 may include fewer than 160 symbols (e.g., 120, 64, or lower), or more than 160 symbols (e.g., 200, 320, or more).

In some embodiments, the symbols of STF field 2502 are transmitted in an uninterrupted manner via antenna 308 in a single sub-carrier.

In some embodiments, the content of STF field 2502 is processed by some, but not all of the blocks of processing pipeline 400. For example, in some embodiments, blocks 402, 404, and 406 do not process the content of STF field 2502. In some such embodiments, the content of STF field 2502 is processed by DSSS block 408 (e.g., with a predetermined DSSS value, such as 2), bits-to-symbols block 410 (e.g., using BPSK), single sub-carrier mapping block 412 (e.g., with CHₛₑₗ fixed), and inverse transform block 414. In some such embodiments, cyclic prefix block 416, and filtering block 418 also process the content of STF field 2502.

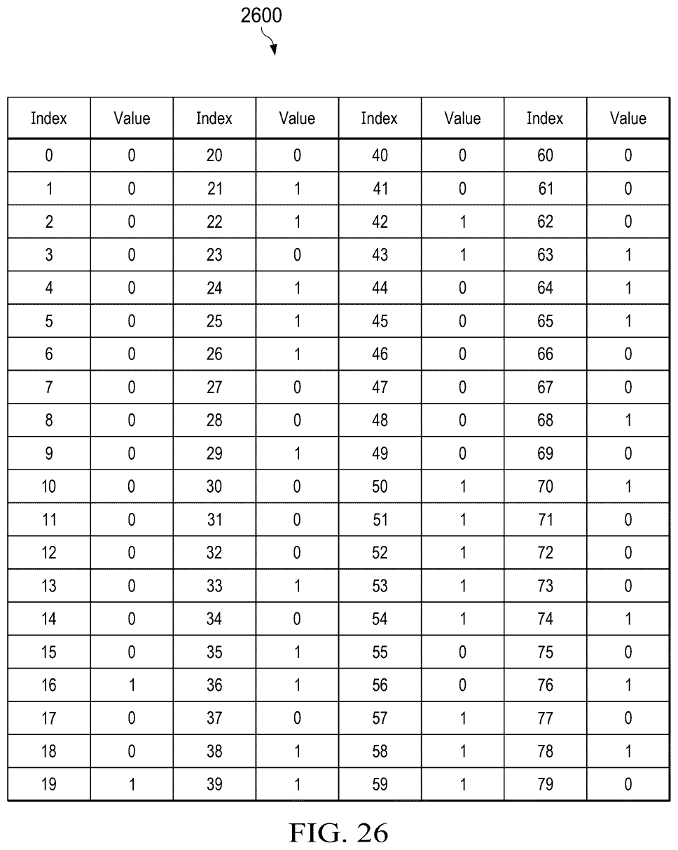

In some embodiments, the content of STF field 2502 is fixed. For example, FIG. 26, shows STF bit sequence 2600, according to an embodiment of the present disclosure. Other STF bit sequences may also be used.

As shown in FIG. 26, in some embodiments, the STF bit sequence may have 80 bits. Such STF bit sequence may expanded by the DSSS (e.g., the STF sequence may be doubled when using a DSSS value of 2) so that the sequence transmitted by antenna 308 may include a multiple of the number of bits of the original STF sequence (e.g., 160 chips, when using DSSS equal to 2).

In some embodiments, STF field 2502 includes one or more configurable bits.

In some embodiments, some or all (e.g., BPSK) symbols of STF field 2502 may be used to generate a series of vectors

$${X}_{k} = \{ {x}_{k} ( n ) \} , - \frac{{DFT}_{SZ}}{2} \leq n \leq \frac{{DFT}_{SZ}}{2} - 1 ,$$

with k between 0 and e.g., the total number of symbols of STF field 2502-1 (e.g., from 0 to 159 when STF field 2502 has 160 symbols), where DFT_{SZ} is defined based on the option selected (e.g., using method 2400), and where xₖ(STFsubcarrier)=b(k) and xₖ(n≠STFsubcarrier)=0, where STFsubcarrier is the (e.g., single) CHₛₑₗ used by single sub-carrier mapper 1900 when processing (e.g., all content of) STF field 2502.

In some embodiments, LTF field 2504 may be used by RF core 300 (e.g., demodulator 304, e.g., processing pipelines 500 or 600) or an associated controller (e.g., 206, 256) for finer frequency offset detection, for time synchronization, and/or for channel equalization.

In some embodiments, LTF field 2504 includes fewer number of symbols than STF field 2502. In some embodiments, LTF field 2504 includes 26 symbols. Some embodiments may include more than 26 symbols (e.g., 32, 40, or more) or less than 26 symbols (e.g., 20, 16, or less).

In some embodiments, the symbols of LTF field 2504 are transmitted sequentially via antenna 308 in multiple sub-carriers (only using a single sub-carrier at a time) in accordance with a hopping sequence.

In some embodiments, the content of LTF field 2504 is processed by some, but not all, of the blocks of processing pipeline 400. For example, in some embodiments, blocks 402, 404, and 406 do not process the content of LTF field 2504. In some such embodiments, the content of LTF field 2504 is processed by DSSS block 408 (e.g., with a predetermined DSSS value, such as 2), bits-to-symbols block 410 (e.g., using BPSK), single sub-carrier mapping block 412 (e.g., with CHₛₑₗ fixed or changing in accordance with a hopping sequence), and inverse transform block 414. In some such embodiments, cyclic prefix block 416, and filtering block 418 also process the content of LTF field 2504.

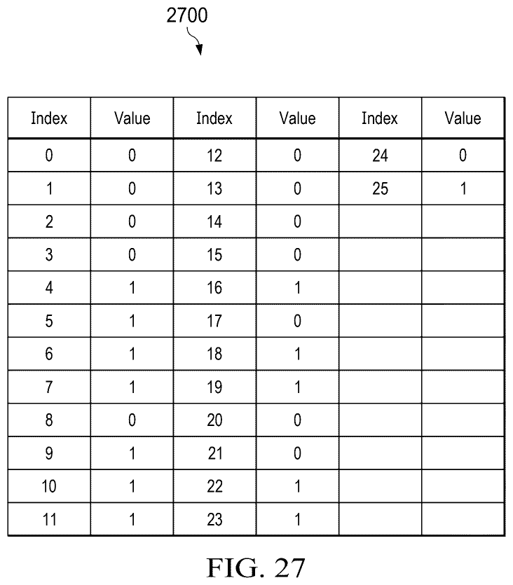

In some embodiments, the content of LTF field 2504 is fixed. For example, FIG. 27, shows LTF bit sequence 2700, according to an embodiment of the present disclosure. Other LTF bit sequences may also be used.

In some embodiments, LTF field 2504 includes one or more configurable bits.

In some embodiments, PHR field 2506 may be used by RF core 300 (e.g., demodulator 304, e.g., processing pipelines 500 or 600) or an associated controller (e.g., 206, 256) for determining the format, modulation, and/or content of PHY payload field 2508.

In some embodiments, the symbols of PHR field 2506 are transmitted sequentially via antenna 308 in multiple sub-carriers (only using a single sub-carrier at a time) in accordance with a hopping sequence.

In some embodiments, the content of PHR field 2506 is processed by some, but not all, of the blocks of processing pipeline 400. For example, in some embodiments, blocks 402 does not process the content of LTF field 2504. In some such embodiments, the content of PHR field 2506 is processed by FEC encoder block 404, interleaver block 406, DSSS block 408 (e.g., with a predetermined DSSS value, such as 6), bits-to-symbols block 410 (e.g., using BPSK), single sub-carrier mapping block 412 (e.g., with CHₛₑₗ fixed or changing in accordance with a hopping sequence), and inverse transform block 414. In some such embodiments, cyclic prefix block 416, and filtering block 418 also process the content of PHR field 2506.

In some embodiments, the input of scrambler block 402 include (e.g., some or all of) the data octets of PHR field 2506.

In some embodiments, PHR field 2506 includes 24 bits. In some embodiments, PHR field includes a different number of bits, such as more than 24 bits, or less than 24 bits.

In some embodiments, some of the bits of PHR field 2506 are fixed and some are configurable. In some embodiments, all bits of PHR field 2506 are configurable.

In some embodiments, interleaver block 406 performs interleaving to (e.g., some or all bits of) PHR field 2506.

In some embodiments, PHY payload field 2508 includes data bits.

In some embodiments, PHY payload field 2508 has a variable length (e.g., as indicated by frame length field 2522), so each packet may have a different length of PHY payload field. In some embodiments, PHY payload field 2508 has a fixed (e.g., predetermined) length.

In some embodiments, some or all of the bits of PHY payload field 2508 are transmitted at a data rate specified by PHR 2506. In some embodiments, a data rate used for transmission of PHY payload field 2508 is the same as the data rate used for transmission of PHR field 406. In some embodiments, the data rate used for transmission of PHY payload field 2508 is different from the data rate used for transmission of PHR field 2506.

In some embodiments, convolutional encoder 1000 is initialized to the all zeros state before encoding the bits associated with PHR field 2506 and then reset to the all zeros states before encoding bits of PHY payload field 2508.

In some embodiments, rate field 2520 indicates the DSSS value used for encoding PHY payload field 2508 (and, thus, may impact the data rate in which bits of PHY payload field 2508 are transmitted). In some embodiments, the DSSS value indicated by rate field 2520 is a DSSS value from a predetermined set of DSSS values. In some embodiments, the predetermined set of DSSS values include DSSS values of 2, 4, and/or 6. In some embodiments, the predetermined set of DSSS value may include other DSSS values (e.g., 0 (DSSS not used), 8, 10, 12, etc.).

In some embodiments, rate field 2520 is a 2-bit field. In some embodiments, rate field may include more than 2 bits (e.g., 3, 4, or more), or 1 bit. In some embodiments, the content of rate field 2520 may be fixed. In some embodiments, some or all bits of frame length field 2520 are configurable. In some embodiments, rate field 2520 is not implemented (omitted). In some such embodiments, the DSSS value used for PHY payload 2508 may be fixed.

In some embodiments, frame length field 2522 is indicative of the total length of PPDU 2500, and/or of a portion of PPDU 2500, such as a length of PHY payload field 2508 and/or the length of portions of PHY payload field 2508, such as PSDU field 2540, PPDU tail field 2542, and/or pad field 2544.

In some embodiments, the content of frame length field 2522 is an unsigned integer that indicates a (e.g., total) number of octets (bytes) contained in PSDU field 2540 (e.g., prior to encoding by FEC encoder block 404).

In some embodiments, frame length field 2522 is an 8 bits field. In some embodiments, length field 2522 may be a field having more than 8 bits (e.g., 9, 10, 20, or more), or less than 8 bits (e.g., 6, 4, 3, 2, or 1). In some embodiments, the content of frame length field 2522 may be fixed. In some embodiments, some or all bits of frame length field 2522 are configurable. In some embodiments, frame length field 2522 is not implemented (omitted). In some such embodiments, the length of PHY payload field 2508 (and possible of PPDU 2500) may be fixed.

In some embodiments, frame length field 2522 is transmitted with a most significant bit (MSB) first. In some embodiments, frame length field 2522 is transmitted with a least significant bit (LSB) first.

In some embodiments, HCS field 2524 is a cyclic redundancy check (CRC) field. In some embodiments, such CRC is for checking the transmission of PHR field 2506 (e.g., for detecting/correcting errors of PHR field 406). In some embodiments, such CRC is computed based on content of rate field 2520 and frame length field 2522. In some embodiments, HCS field 2524 is computed using the first 10 bits of PHR field 2506.

In some embodiments, RF core 300 (e.g., demodulator 304, e.g., processing pipelines 500 or 600) or an associated controller (e.g., 206, 256) may compare the value received in HCS field 2524 with a CRC value computed based on content of rate field 2520 and frame length field 2522 to determine whether PHR field 2506 is corrupted.

In some embodiments, HCS field 2524 may be computed using the following polynomial:

$${G}_{8} ( x ) = {x}^{8} + {x}^{2} + x + 1. \qquad ( 5 )$$

In some embodiments, HCS field 2524 is the one's complement of the modulo-2 sum of the two remainders in a) and b):
a) the remainder resulting from [x^{k}(x⁷+x⁶+ . . . +1)] divided (modulo 2) by G₈(x), where the value k is the number of bits in the calculated field;
b) the remainder resulting from the calculation field content, treated as a polynomial, multiplied by x⁸ and then divided (modulo 2) by G₈(x).

In some embodiments, HCS field 2524 is an 8 or 10 bit field. In some embodiments, HCS field 2524 may be a field having more than 8 bits (e.g., 9, 12, 16, or more), or less than 8 bits (e.g., 7, 6, or less). In some embodiments, HCS field 2524 is not implemented (omitted).

In some embodiments, tail field 2526 is intended to facilitate decoding, e.g., by FEC decoder 514, to reduce error probability, e.g., of a convolutional encoder (e.g., 1000). For example, in some embodiments, tail field 2526 includes all zeros to facilitate Viterbi decoded flushing.

In some embodiments, tail field 2526 is a 6 bit field. In some embodiments, tail field 2526 may include more than 6 bits (e.g., 7, 9, 10, or more), or less than 6 bits (e.g., 5, 4, or less). In some embodiments, tail field 2526 may be omitted.

In some embodiments, PHR field 2506 includes a scrambler field (not shown) to specify a scrambler seed used for scrambling (e.g., by blocks 402, 516) content of PHY payload field 2508. In some embodiments, the scrambler field 2506 may be omitted. In some such embodiments, scrambling of content of PHY payload field 2508 may be based on a predetermined scrambling seed (e.g., all ones) or may be omitted.

In some embodiments, PSDU field 2540 includes data bits. In some embodiments, such data bits of PSDU field 2540 are data bits received from a MAC layer of the device (e.g., 202, 252) performing the transmitting (e.g., using processing pipeline 400).

In some embodiments, the input of scrambler block 402 include (e.g., some or all of) the data octets of PSDU field 2540.

In some embodiments, PSDU field 2540 has a variable length (e.g., as indicated by frame length field 2522). In some embodiments, the length of PSDU field 2540 is based on the number of data bits received from the MAC layer.

In some embodiments, content of PSDU field 2540 is transmitted at a data rate specified by PHR 2506 (e.g., data rate 2520). In some embodiments, a data rate used for transmission of PSDU field 2540 is the same as the data rate used for transmission of the rest of PHR payload field 2508, and/or the PHR field 2506. In some embodiments, the data rate used for transmission of PSDU field 2540 is different from the data rate used for transmission of the rest of PHR payload field 2508, and/or the PHR field 2506.

In some embodiments, PPDU tail field 2542 is intended to facilitate decoding, e.g., by FEC decoder 514, to reduce error probability, e.g., of a convolutional encoder (e.g., 1000). For example, in some embodiments, PPDU tail field 2542 includes all zeros to facilitate Viterbi decoded flushing.

In some embodiments, PPDU tail field 2542 is a 6 bit field. In some embodiments, tail field 2542 may include more than 6 bits (e.g., 7, 8, 10, or more), or less than 6 bits (e.g., 5, 4, or less). In some embodiments, PPDU tail field 2542 may be omitted.

In some embodiments, a processing pipeline (e.g., 500 or 600) of a demodulator (e.g., 304) places (e.g., some or all) fields of reconstructed packet 401 (e.g., fields 2502, 2504, 2506, and/or 2508) into a receiver (RX) first-in-first-out (FIFO) buffer for further processing/use (e.g., by demodulator 304 and/or an associated controller (e.g., 206, 256)).

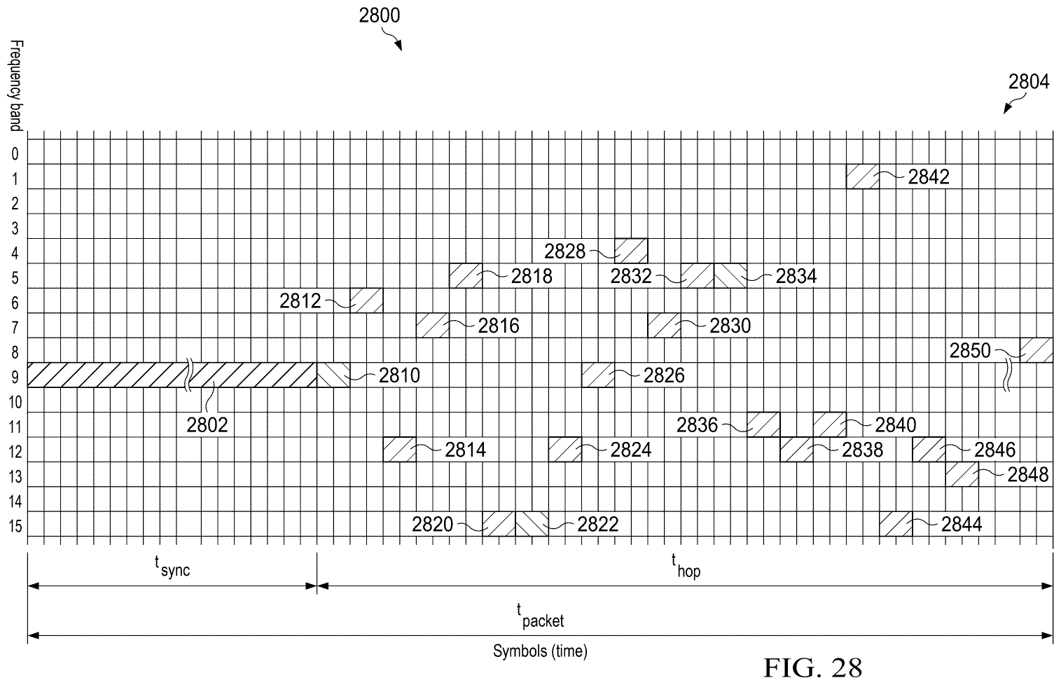

FIG. 28 illustrates transmission of packet 2800 encoded across multiple sub-carrier frequencies, according to an embodiment of the present disclosure. In some embodiments, packet 401 may be transmitted as packet 2800, e.g., by RF core 300, e.g., after processing by processing pipeline 300.

In the embodiment of FIG. 28, 16 sub-carrier frequencies are used. Some embodiments may use less than 16 sub-carrier frequencies for packet transmission (e.g., 12) or more than 16 sub-carrier frequencies, e.g., 26, 52, or 104. In some embodiments, the number sub-carrier frequencies used is determined by the option used for communication, e.g., as determined by method 2400.

In some embodiments, packet 2800 has the packet structure of PPDU 2500.

As shown in FIG. 28, packet 2800 may be transmitted by first transmitting synchronization sequence 2802 (e.g., corresponding to STF field 2502), immediately followed by the rest of the fields of packet 2800 (e.g., fields 2504, 2506, 2508), e.g., in accordance with hopping sequence 2804.

As shown in FIG. 28, transmission of packet 2800 may take t_{packet} time, which includes t_{sync} time (time for transmission synchronization sequence 2802) and tₕₒₚ time (time for transmitting data according to hopping sequence 2804).

In FIG. 28, pairs of symbols 2810-2850 are illustrated as two horizontally adjacent boxes. The horizontal axis in FIG. 28 represents the time slots for transmitting data. The vertical axis in FIG. 28 represents the sixteen frequency bands in which data can be encoded for transmission. Although FIG. 28 illustrates transmission using 16 frequency bands, some embodiments may use more than 16 frequency bands (e.g., 20, 26, 32, 37, 40, 52, 104, or more, or less than 16 frequency bands, e.g., 14, 12, 9, 8, 4, or less). In some embodiments, the set of frequency bands available for transmission may be dynamically selected.

In some embodiments, the frequency bands used for hopping sequence 2804 is a subset of frequency bands (e.g., with fewer frequency bands) of all frequency bands available for communication (e.g., the number of active tones, e.g., according to the communication option selected, e.g., from FIGS. 23A-23D). For example, in some embodiments, there may be a total of 16 frequency bands available for communication (e.g., 16 active tones) but the hopping sequence uses only 10 of the 16 frequency bands. Other implementations are also possible.

As shown in FIG. 28, some embodiments use a single sub-carrier signal for each time slot. This technique may advantageously result in lower PAPR and produce an RF signal that may be easier for a demodulator (e.g., 304) to demodulate.

As shown in FIG. 28, some embodiments select keep the same sub-carrier frequency for the entirety of synchronization sequence 2802, and select a new sub-carrier frequency after every two time slots (every two symbols—every pair of symbols) so that the symbols in each pair share the same frequency band (which may be advantageous for differential modulations, such as differential BPSK (DBPSK)). Some embodiments may use FDM to divide up the total bandwidth into channels that can be selected for each pair of time slots. Additionally or alternatively, some embodiments may implement other forms of division multiplexing, such as time division multiplexing or code division multiplexing, for modulating RF signals.

In the embodiment of FIG. 28, pair of symbols 2810 is assigned to the ninth frequency band, pair of symbols 2812 to the sixth frequency band, and so on. Each pair of symbols is assigned to a frequency band (e.g., fixed or according to a hopping sequence).

In some embodiments (such as shown in FIG. 28), the first frequency channel of the hopping sequence 2804 is the same as STFsubcarrier (the frequency channel used for transmission of the synchronization sequence 2802). In some embodiments, the first frequency channel of the hopping sequence 2804 may be different than STFsubcarrier.

In some embodiments, more than 1 pair of symbols (e.g., 2, 3, 4, or more) may be transmitted before hopping to the next channel, which may advantageously result in less frequent channel switching than in the embodiment of FIG. 28. In some embodiments, hopping sequence 2804 is random, pseudo-random, quasi-random, or deterministic.

In some embodiments, hopping sequence 2804 may switch frequencies for each hop (e.g., after each pair of symbols). However, in some embodiments, the hopping sequence 2804 may occasionally select the same frequency band for two consecutive transmissions (e.g., as illustrated by pairs of symbols 2820 and 2822). For example, in some embodiments using random, pseudo-random, or quasi-random hopping sequences, the same sub-channel may be selected for consecutive transmissions. In some embodiments, hopping sequence 2804 is designed to prevent consecutive transmissions using the same frequency band. In some embodiments, hopping sequence 2804 is designed to hop through all channels before revising a particular sub-channel (and such sequence may be repeated until all symbols of packet 2800 are transmitted).

In some embodiments, a demodulator (e.g., 304) determines the bits represented by each pair of symbols (e.g., inverse DSSS blocks 508, 604) by comparing the two symbol values in each pair. For example, in some embodiments using a DSSS value of 2, a logical value of one is represented by two identical symbols values, and a logical value of zero is represented by two non-identical symbol values. Thus, in some embodiments, the demodulator (e.g., inverse DSSS blocks 508, 604) can compare the second symbol value in the pair to the previous symbol value to determine the value of the bit represented by that pair of symbols. In some such embodiments, the demodulator can advantageously demodulate the RF signal using local information without any additional information, which may advantageously reduce the interference caused by frequency drift over time and multi-path environments.

In some embodiments, such as embodiments using BPSK, reusing the same frequency band for each symbol of a pair of symbols advantageously allows for differential encoding (e.g., DBPSK), which may advantageously allow for determining the phase of the symbol without precise synchronization, since the phase is relative and the frequency band is the same for both symbols of a pair of symbols.

In some embodiments, each symbol of packet 2800 transmitted corresponds to a chip. Thus, in some embodiments, each pair of symbols corresponds to a pair of chips. Thus, in some embodiments (e.g., using DSSS=2), each pair of symbols (e.g., 602, 604, etc.) corresponds to a bit of PPDU 2500.

In some embodiments using DSSS values higher than 2 (e.g., 4 or higher), chips representing each bit are sent over multiple frequencies (e.g., according to a hopping sequence 2804). Thus, some such embodiments may be advantageously more robust and resilient over horizontal and vertical interference, as bits of PPDU 2800 are spread over time (e.g., multiple pairs of chips), and multiple frequency bands (e.g., due to hopping sequence 2804). For example, assuming the embodiment of FIG. 28 implements a DSSS value of 4, pairs of symbols 2810 and 2812 represent a single bit of data (e.g., of PPDU 2800). Such bit of data is sent over 4 time slots (4 symbols) and over multiple frequency bands (channels 9 and 6).

In some embodiments, the higher the DSSS value, the more robust the communication is. In some embodiments, the lower the DSSS value, the higher the data throughput.

In some embodiments, the hopping sequence 2804 may be selected based on synchronization sequence 2802. For example, in some embodiments, the seed for determining the hopping sequence 2804 may be based on which sub-channel is used for transmitting synchronization sequence 2802 (STFsubcarrier) and/or one or more bits of synchronization sequence 2802 (e.g., the last 2 bits of STF field 2502).

In some embodiments, synchronization sequence 2802 is used for packet detection (e.g., detection of PPDU 2800, such as detection of the start of LTF field 2504 for the beginning of hopping sequence 2804), frequency offset determination, and/or for timing synchronization. In some embodiments, synchronization sequence 2802 is the only synchronization sequence sent for a packet. In some embodiments, a subsequent synchronization sequence (e.g., LTF field 2504) is transmitted after synchronization sequence 2802 to allow for finer synchronization, timing synchronization, and/or channel equalization. For example, in some embodiments, such subsequent synchronization sequence may be sent following the hopping sequence (e.g., packets 2810, 2812, etc., may be part of LTF field 2504), with the actual header (e.g., 2506) and payload (e.g., 2508) being transmitted after such subsequent synchronization sequence).

In some embodiments, synchronization sequence 2802 may include a preamble field, and a synchronization sequence field.

As shown in FIG. 28, in some embodiments, synchronization sequence 2802 is transmitted in a single frequency band. In some embodiments that include a subsequent synchronization sequence, the subsequent synchronization sequence is transmitted according to a hopping sequence 2804. For example, in some embodiments, hopping sequence 2804 includes the subsequent synchronization sequence (LTF field 2504). In some such embodiments, synchronization sequence 2802 (STF field 2502) may be used for packet detection and coarse frequency offset determination, and the subsequent synchronization sequence (LTF field 2504) may be used for finer offset determination, timing synchronization, and channel equalization.

In some embodiments, synchronization sequence 2502 includes a plurality of symbols, such as 10, 20, 32, 64, 80, 96, 160, or more.

In some embodiments, synchronization sequence 2802 has a time duration t_{sync} that is longer than a maximum sleep time duration (time spent in low power mode, e.g., with paths 310 and/or 320 disabled) of a receiver device (e.g., 252). In some embodiments, the duration of synchronization sequence may change dynamically, e.g., by changing the duration of each symbol, and/or by changing the number of symbols transmitted as part of synchronization sequence 2802.

In some embodiments, the receiver and/or transmitter device (e.g., 252, 202) periodically enters sleep mode, which may advantageously allow for lower power consumption. In some such embodiments, transmission/reception of packets (e.g., 401) may occur when the devices are in active node, e.g., with paths 310 and 320 enabled.

In some embodiments, the duration of symbols for synchronization sequence 2802 (and/or of hopping sequence 2804) is fixed. In some embodiments, the duration of symbols for synchronization sequence 2802 (and/or of hopping sequence 2804) may change, e.g., periodically and/or in response to a trigger, such as an input from an upper layer (e.g., link layer, MAC layer, and/or transport layer).

In some embodiments, the subcarrier channel STFsubcarrier selected by single sub-carrier mapping block 412 for synchronization sequence 2802 may be selected by a link layer/MAC layer/network layer and may be fixed for multiple (or all packets). In some embodiments, the subcarrier channel STFsubcarrier may change after each packet or after a plurality of packet (e.g., in response to a trigger, such as a trigger from a link layer/MAC layer/network layer or after a predetermined number of packets have been sent).

In some embodiments (such as illustrated in FIG. 28), data transmission according to hopping sequence 2804 begins immediately after synchronization sequence 2802. In some embodiments, there may be a delay (e.g., 1 or 2 symbols in duration or more) between synchronization sequence 2802 and the first transmission (e.g., 2610) of the hopping sequence 2804.

In some embodiments, a demodulator (e.g., 304) may detect only a portion of synchronization sequence 2802 (e.g., the last portion) and may still be able to detect the packet (2800), perform synchronization, and receive data (e.g., fields 2504, 2506, and 2508) during hopping sequence 2804.

In some embodiments, the hopping sequence 2804 is selected based on which sub-channel the synchronization sequence 2802 is transmitted. For example, in the embodiment of FIG. 28, a seed for selecting hopping sequence may be based on sub-channel 9, which is the sub-channel in which synchronization sequence 2802 is transmitted. Thus, in the embodiment of FIG. 28, a demodulator (e.g., 304) may derive the hopping sequence used for data transmission by using (e.g., solely, or in combination with other parameters) sub-channel 9 as a seed for selecting the hopping sequence.

In some embodiments, the hopping sequence 2804 is selected based on one or more (e.g., of the last) symbols of the synchronization sequence 2802. For example, in some embodiments, synchronization sequence 2802 may include one or more symbols, the state of which is indicative of a value used for determining a seed value for determining hopping sequence 2804. Thus, in some embodiments, a demodulator (e.g., 304) may derive the hopping sequence used for data transmission by using (e.g., solely, or in combination with other parameters) from the state of one or more symbols of synchronization sequence 2802.

In some embodiments, the hopping sequence 2804 may be determined based on the state of one or more symbols of synchronization sequence 2802 in combination with the sub-channel used for transmitting synchronization sequence 2802.

In some embodiments, the hopping sequence 2804 is not based on content of synchronization sequence 2802 or the sub-channel in which synchronization sequence 2802 is transmitted. For example, in some embodiments, the hopping sequence 2804 is based on a seed transmitted out-of-band, a predefined seed, a current time, etc.

In some embodiments, the seed value for determining hopping sequence 2804 is partially determined by the frequency band in which synchronization sequence 2802 is transmitted in. In some embodiments, the seed value is fully determined by the frequency band in which synchronization sequence 2802 is transmitted in. In some embodiments, the seed value is not determined by the frequency band in which synchronization sequence 2802 is transmitted in.

In some embodiments, hopping sequence 2804 is selected based on a seed value in combination with one or more coefficients. In some embodiments, the seed value together with the one or more coefficients fully determine hopping sequence 2804.

In some embodiments, the seed value and the one or more coefficients are predetermined, known to both devices (e.g., 202 and 256) and fixed. In some embodiments, the seed value and/or one or more (or all) of the one or more coefficients may dynamically change (e.g., periodically, in response to an input received by RF core 300 and/or associated controller, after a predetermined number of transmission/packets, and/or other factors).

In some embodiments, one or more (or all) of the seed value and the one or more coefficients are received by the PHY layer (e.g., implemented by RF core 300) from an upper layer (e.g., link layer, medium access control (MAC) layer, and/or network layer), which may be implemented, e.g., by an associated controller (e.g., 206) or by another controller of the device (e.g., 202).

In some embodiments, the one or more coefficients for determining the hopping sequence are determined using linear congruential generator (LCG) subcarrier mapping.

In some embodiments, sub-carrier mapping block 412 (e.g., single sub-carrier mapper 1900) receives as input the one or more coefficients from a link layer/MAC layer/network layer. In some embodiments, the one or more coefficients are fixed and do not change. In some embodiments, one or more (or all) of the one or more coefficients change after each packet, after a predetermined number of packets transmitted, and/or in response to a trigger (e.g., received from a link layer/MAC layer/network layer).

Some embodiments include a seed value for determining hopping sequence 2804 based on STFsubcarrier and two coefficients, namely LCGa and LCGc. For example, if S={s(k)}, 0≤k≤M−1, where s(k)∈(0,255) is a vector that contains all the seed values for corresponding hopping sequences, a second vector J={j(k)}, 0≤k≤M−1, where

$$j ( k ) ∈ ( - \frac{{N}_{a}}{2} , \frac{{N}_{a}}{2} ) ,$$

Na is the number of active tones (e.g., channels used for transmission) that contains the channel index to be used in that specific symbol, and the starting seed for generating the hopping sequence (e.g., 2804) be s(0)=s(1)=DFT_{SZ}+STFsubcarrier, the starting seed for the algorithm, with j(0)=j(1)=STFsubarrier.

In some embodiments, for all values of k above or equal to 2, a temporary (e.g., 8-bit) value sₜₘₚ is initialized to be the seed value from the previous iteration s(k−1). Then, a linear congruential random generator may be used to update the temporary seed value by

$${s}_{tmp} = ( ( {s}_{tmp} \times L C {G}_{a} ) + L C {G}_{c} ) mod 256. \qquad ( 6 )$$

The P LSBs of sₜₘₚ may then be extracted, where P may be given by:

$$P = 1 + {log}_{2} {DFT}_{SZ} , \qquad ( 7 )$$

where DFT_{sz} is the number of samples of a symbol, to create a second temporary seed value by

$${r}_{tmp} = {s}_{tmp} mod P \qquad ( 8 )$$

rₜₘₚ is then compared against three conditions: rₜₘₚ greater than or equal to

$${DFT}_{SZ} - \frac{{N}_{a}}{2} ;$$

rₜₘₚ less than or equal to

$${DFT}_{SZ} + \frac{{N}_{a}}{2} ;$$

and rₜₘₚ not equal to DFT_{SZ}, where Nₐ is the number of data tones in a symbol. In some embodiments, when all 3 conditions are true, then j(k)=rₜₘₚ−DFT_{SZ} and s(k)=sₜₘₚ, otherwise, a new iteration is performed until the three conditions are satisfied.

In some embodiments, for each odd value of k, s(k)=s(k−1) and j(k)=j(k−1).

In some embodiments, for each (e.g., BPSK) symbol transmitted as part of hopping sequence 2804 (e.g., fields 2504, 2506, and 2508), B={b(k)}, 0≤k≤M−1, a vector

$${X}_{k} = \{ {x}_{k} ( n ) \} , - \frac{{DFT}_{SZ}}{2} \leq n \leq \frac{{DFT}_{SZ}}{2} - 1$$

is created, where xₖ(j(k))=b(k) and xₖ(n≠j(k))=0.

As an example, for 26 subcarriers (e.g., option 3 when SymDur=120 μs (FIG. 23A); option 2 when SymDur=60 μs (FIG. 23B); or option 1 SymDur=30 μs (FIG. 23C), when STFsubarrier=2, LCGa=17, LCGc=83, when DFTsz is 32 (e.g., since 32 is the minimum number that is a power of 2 that fits the number of subcarriers (26)), the sequence generation outlined above provides the following Qa numbers:

$$\begin{matrix}18 & 5 & 20 & 29 & 19 & 22 & 9 & 24 & 4 & 23 & 26 & 13 & 3 \\ 6 & 28 & 8 & 27 & 17 & 7 & 10 & 12 & 21 & 11 & 14 & 25 & 15\end{matrix} .$$

As shown by numbers Qa, in some embodiments, the hopping sequence generated using sequence generation outlined above results in no numbers being repeated. The sequence Qa may be repeated as more symbols are transmitted (e.g., after 26 pairs of symbols have been transmitted, the next pair of symbols may use sub-channel 18 again.

As shown by numbers Qa, in some embodiments, the first number corresponds to STFsubcarrier=2+DFTsz/2.

As another example, for 26 subcarriers, when STFsubarrier=2, LCGa=17, LCGc=83, when DFTsz is 32, the sequence generation outlined above provides the following Qb numbers:

$$\begin{matrix}19 & 22 & 9 & 24 & 4 & 23 & 26 & 13 & 3 & 6 & 28 & 8 & 27 \\ 17 & 7 & 10 & 12 & 21 & 11 & 14 & 25 & 15 & 18 & 5 & 20 & 29\end{matrix} .$$

As can be seen by comparing sequences Qa and Qb, sequence Qb is a rotated version of sequence Qa, where the last 4 numbers of sequence Qb are the first 4 numbers of sequence Qa.

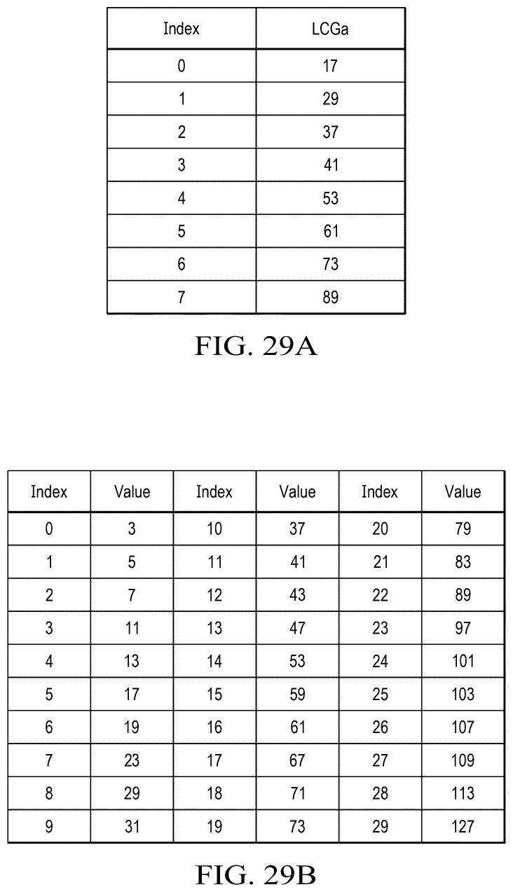

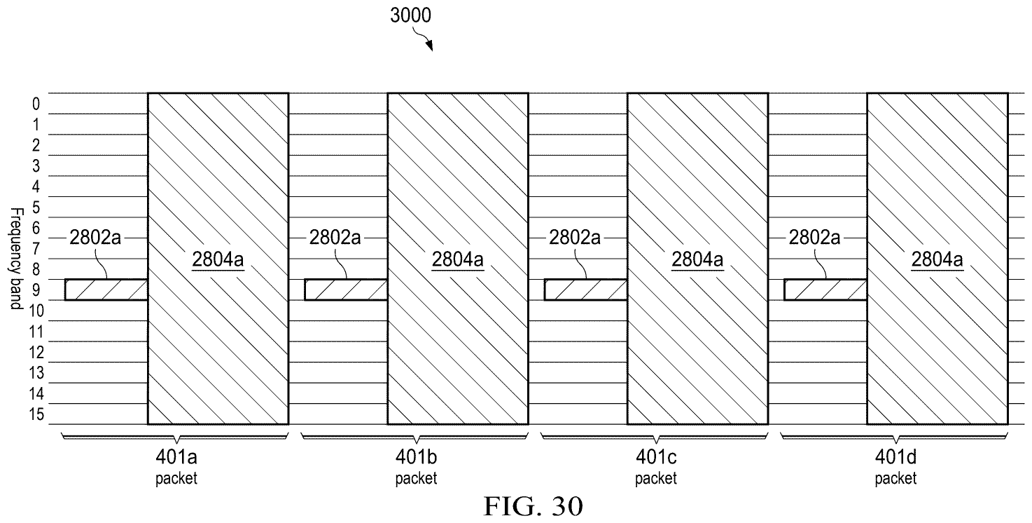

In some embodiments, the values of LCGa and LCGc come from respective predetermined sets of possible values. For example, FIGS. 29A and 29B show sets of possible values of LCGa and LCGc, respectively, according to an embodiment of the present disclosure.

In some embodiments, synchronization sequence 2802 is transmitted periodically.

In some embodiments, synchronization sequence 2802 is transmitted per packet 2800. For example, in some embodiments, the first field to be transmitted for each packet 2800 is the STF field 2502.

In some embodiments, the modulation scheme used for transmitting symbols of synchronization sequence 2802 is the same as the modulation scheme used for transmitting symbols hopping sequence 2804. For example, all symbols of synchronization sequence 2802 and hopping sequence 2804 may be transmitted using BPSK (e.g., DBPSK). In some embodiments, the modulation scheme used for transmitting symbols of synchronization sequence 2802 may be different from the modulation scheme used for transmitting symbols of hopping sequence 2804. For example, in some embodiments, symbols hopping sequence 2804 may be transmitted using BPSK (e.g., DBPSK) while symbols of synchronization sequence 2802 may be transmitted PSK, GFSK, BPSK, FSK, ASK, CSS, QAM, APSK, CPS, MSK or OOK.

In some embodiments, regardless of the modulation scheme used for symbol transmission, only a single sub-channel of the available sub-channels is used at a time for transmitting symbols, as illustrated in FIG. 28.

FIG. 30 shows transmission 3000 of a plurality of packets 401, according to an embodiment of the present disclosure. Processing pipeline 300 may process packet each of the plurality of packets 401 of transmission 3000.

As shown in FIG. 30, in some embodiments, each of the transmitted packets 401 has the same (e.g., fixed) synchronization sequence 2802a (e.g., STF sequence shown in FIG. 2600) transmitted in the same sub-channel (e.g., sub-channel 9). As also shown in FIG. 30, in some embodiments, the hopping sequence 2804 for each of the 401 packets is the same (although the transmitted data may be different).

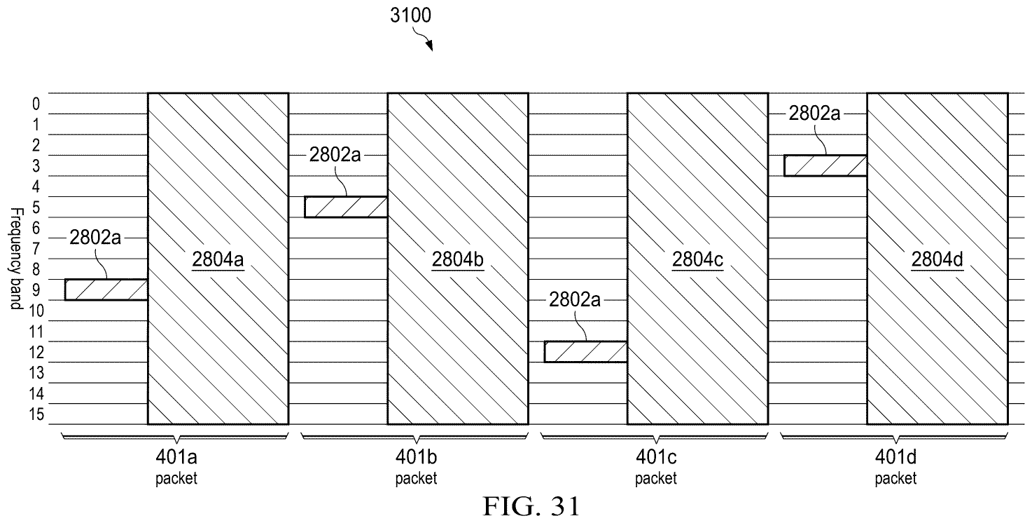

FIG. 31 shows transmission 3100 of a plurality of packets 401, according to an embodiment of the present disclosure. Processing pipeline 300 may process packet each of the plurality of packets 401 of transmission 3100.

As shown in FIG. 31, in some embodiments, each of the transmitted packets 401 has the same (e.g., fixed) synchronization sequence 2802a (e.g., STF sequence shown in FIG. 2600) transmitted in different sub-channel for each packet. As also shown in FIG. 31, in some embodiments, the hopping sequence 2804 for each of the 401 packets may be different. In some embodiments, each of hopping sequences 2804b, 2804c, and 2804d is a rotated version of hopping sequence 2804a. In some embodiments, each of hopping sequences 2804a, 2804b, 2804c, and 2804d are different and are not rotated versions of each other.

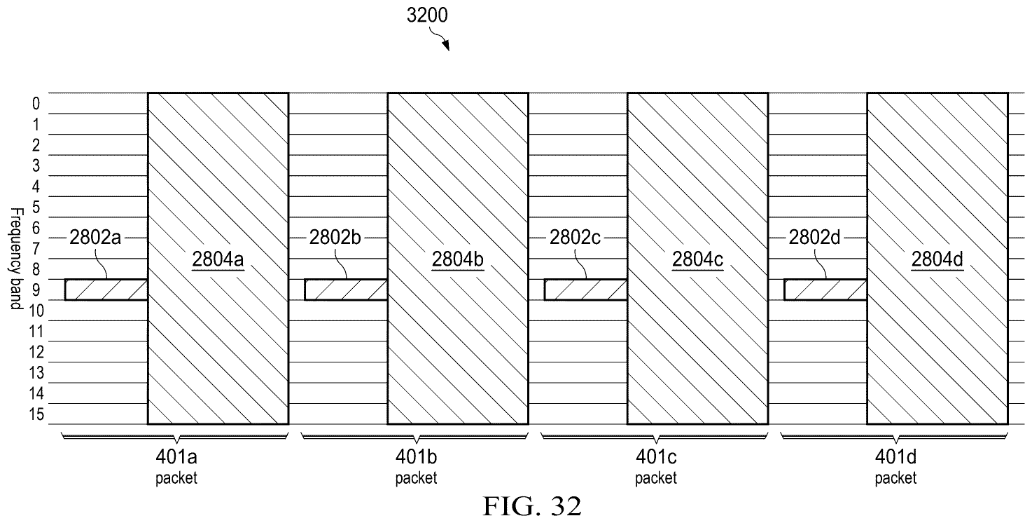

FIG. 32 shows transmission 3200 of a plurality of packets 401, according to an embodiment of the present disclosure. Processing pipeline 300 may process packet each of the plurality of packets 401 of transmission 3200.

As shown in FIG. 32, in some embodiments, each of the transmitted packets 401 has a different (e.g., fixed or configurable) synchronization sequence 2802 transmitted the same sub-channel for each packet. As also shown in FIG. 32, in some embodiments, the hopping sequence 2804 for each of the 401 packets changes depending on content of synchronization sequence 2802.

In some embodiments, each of synchronization sequence 2802a, 2802b, 2802c, and 2802d, include one or more bits causing a selection of different coefficients (e.g., LCGa and LCGc, e.g., according FIGS. 29A and 29B) which causes a different hopping sequence 2804 to be used for associated packet 401.

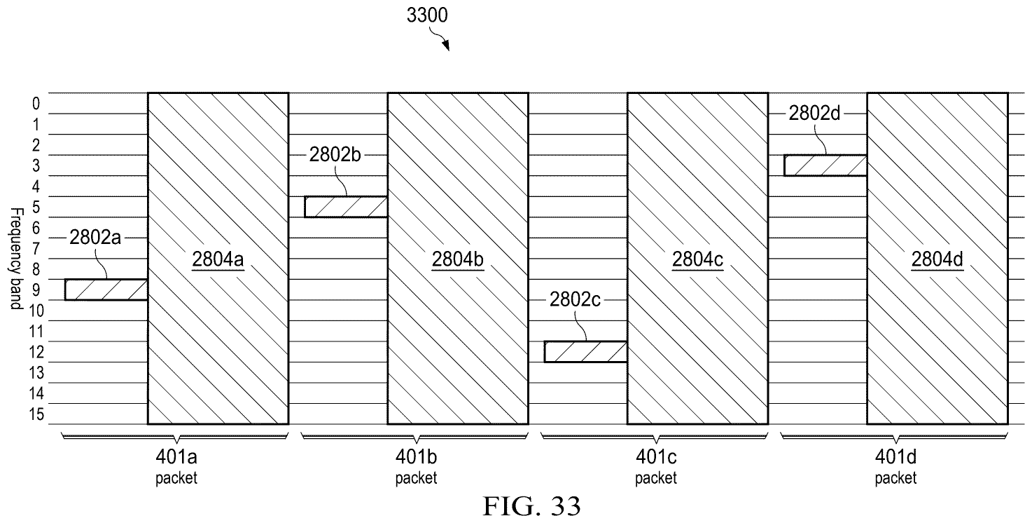

FIG. 33 shows transmission 3300 of a plurality of packets 401, according to an embodiment of the present disclosure. Processing pipeline 300 may process packet each of the plurality of packets 401 of transmission 3300.

As shown in FIG. 33, in some embodiments, each of the transmitted packets 401 has a different (e.g., fixed or configurable) synchronization sequence 2802 transmitted in different sub-channel for each packet. As also shown in FIG. 33, in some embodiments, the hopping sequence 2804 for each of the 401 packets may be different and may be determined based on STFsubcarrier and/or content of synchronization sequence 2802.

In some embodiments, device 202 may use a first (e.g., fixed or configurable) STFsubcarrier (e.g., as shown in FIGS. 30-33) to transmit data to device 252 and may listen for a synchronization sequence from device 252 in a second (e.g., fixed of configurable, e.g., as shown in FIGS. 30-33). In some embodiments, the first and second STFsubcarriers may be the same.

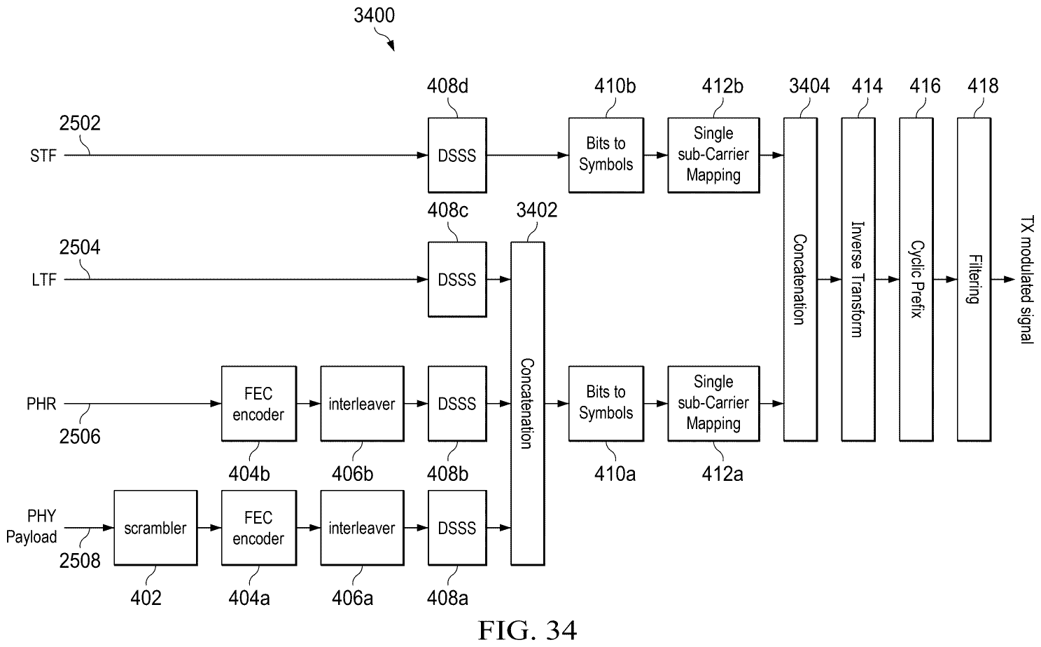

FIG. 34 shows a block diagram of modulator 3400, according to an embodiment of the present disclosure. Modulator 302 may be implemented as modulator 3400. Modulator 3400 illustrates a possible implementation of processing pipeline 400.

As shown in FIG. 34, modulator 3400 includes scrambler block 402, FEC encoder block 404a and 404b, interleaver blocks 406a and 406b, DSSS blocks 408a, 408b, 408c, and 408d, bits to symbol blocks 410a and 410b, single sub-carrier mapping blocks 412a and 412b, inverse transform block 414, cyclic prefix block 416 and filtering block 418.

As shown in FIG. 34, in some embodiments, some of the processing blocks may be implemented with multiple instances (e.g., DSSS block 408 may have 4 instances, which may advantageously allow for parallel processing). In some embodiments, a single instance of block (e.g., a single DSSS block 408) may be implemented, which may process data sequentially, e.g., by multiplexing among the different inputs, and possibly switching configuration of the block, e.g., based on the data being processed (e.g., using DSSS value of 2 for processing LTF field 2504, DSSS value of 6 for PHR Field 2506, and a DSSS value selected based on content of PHR field 2506 to process PHY payload field 2508).

As shown in FIG. 34, modulator 3400 may process different portions of packet 401 (e.g., in the form of PPDU 2500) in different manners.

For example, in some embodiments (as shown in FIG. 34), all content of STF field 2502 and LTF field 2504 is processed using DSSS block 408d and 408c, respectively (e.g., without scrambling, FEC encoding, or interleaving) to generate respective streams of chips. All content of PHR field 2506 is processed using FEC encoder block 404b, follows by interleaver block 406b, followed by DSSS block 408b (e.g., without scrambling) to generate a respective stream of chips. PHY payload field 2508 is processed by scrambler block 402, follows FEC encoder block 404a, interleaver block 406a, and DSSS block 408a to generate a respective stream of chips.

The outputs of DSSS blocks 408a, 408b, and 408c is concatenated by concatenation block 3402, and the concatenated stream of chips is processed by bits-to-symbols block 410a to generate a stream of symbols that are then mapped to a single carrier (e.g., according to a hopping sequence 2804). The stream of chips generated by DSSS 408d is processed by bits-to-symbols block 410b to generate a stream of symbols that are then mapped to a single carrier (e.g., to a fixed sub-channel STFsubcarrier).

The outputs of single sub-carrier mapping blocks 412a and 412b is concatenated by concatenation block 3404 to generate a concatenated sequence of symbols that is then processed by inverse transform 414, cyclic prefix block 416 and filtering block 418 to generate TX modulated signal.

In some embodiments, modulator 2400 may implement additional blocks (not shown), may omit one or more of the blocks shown in FIG. 34, and/or processes different portions of PPDU 2500 in a different manner than shown in FIG. 34. For example, in some embodiments, one or more of blocks 402, 404a, 404b, 406a, 406b, 416, 418, 3402 and 3404 may be omitted from modulator 3400. As another example, some embodiments may include a scrambler block (not shown) to process PHR field 2506 prior to FEC encoder block 404b. Other implementations are also possible.

In some embodiments, FEC encoder blocks 404a and 404b have the same configuration (e.g., same coding rate and polynomial, such as convolutional encoder 1000). In some embodiments, FEC encoder blocks 404a and 404 each have a different configuration (e.g., may use different coding rate and/or polynomial).

In some embodiments, interleaver blocks 406a and 406b have the same configuration (e.g., interleave according to the same algorithm, such as implemented as interleaver 1100 according to Equation 2). In some embodiments, interleaver blocks 406a and 406b each have a different configuration (e.g., may interleave according to different equations).

In some embodiments, DSSS blocks 408a, 408b, 408c, and 408d have the same configuration (e.g., same DSSS value and polarity). In some embodiments, one or more of DSSS blocks 408a, 408b, 408c, and 408d may have a different configuration e.g., may use a different DSSS value and/or polarity) than another of DSSS blocks 408a, 408b, 408c, and 408d. For example, in some embodiments, DSSS blocks 408d and 408c may use a fixed DSSS value of 2, DSSS block 408b may use a fixed DSSS value of 6, and DSSS block 408a may use a DSSS value selected from a set (e.g., that includes DSSS values of 2, 4, and 6) depending on content of PHR field 2506. In some such embodiments, the polarity used by each of DSSS blocks 408a, 408b, 408c, and 408d may be equal to each other, may be different, or may change (e.g., in a deterministic manner) based on one or more factors.

In some embodiments, bits-to-symbols blocks 410a, and 410b, have the same configuration (e.g., use the same modulation scheme, such as BPSK, and the same symbol duration SymDur). In some embodiments, bits-to-symbols blocks 410a, and 410b each have a different configuration (e.g., bits-to-symbols blocks 410a may use BPSK as the modulation scheme, while bits-to-symbols blocks 410b may use a modulation scheme different from BPSK, such as PSK, GFSK, FSK, ASK, CSS, QAM, APSK, CPS, MSK or OOK, and/or may use different symbol durations SymDur).

In some embodiments, single sub-carrier mapping blocks 412a and 412b may have different configurations. For example, in some embodiments, single sub-carrier mapping blocks 412a may have a CHₛₑₗ that changes according to a hopping sequence (e.g., based on STFsubcarrier, LCGa, and LCGc) while single sub-carrier mapping blocks 412a may have a CHₛₑₗ that is fixed for the entire PPDU 2500.

In some embodiments, modulator 3400 may receive, e.g., from an upper layer (e.g., MAC layer), e.g., some or all content of PHY payload field 2508. For example, in some embodiments, modulator 3400 may receive from a MAC layer all content of PSDU field 2540 and may generate all content of PPDU tail field 2542 and PAD field 2544. In some embodiments, modulator 3400 may generate all content of PHY payload field 2508. For example, in some embodiments, modulator 3400 may generate all content of PHY payload field 2508 during a test mode. Other implementations are also possible.

In some embodiments, modulator 3400 may receive, e.g., from an upper layer (e.g., MAC layer), e.g., some or all content of PHR field 2506. For example, in some embodiments, modulator 3400 may receive from a MAC layer, e.g., all content of data rate field 2520 and frame length field 2522, and may generate all content for HCS field 2524 and tail field 2526. In some embodiments, modulator 3400 may generate all content of PHR field 2506. Other implementations are also possible.

In some embodiments, modulator 3400 may receive, e.g., from an upper layer (e.g., MAC layer), e.g., some or all content of STF field 2502 and/or LTF field 2504. For example, in some embodiments, modulator 3400 may receive from a MAC layer one or more (e.g., of the last) bits of STF field 2502, e.g., for selecting hopping sequence 2804, and may determine content of LTF field 2504 based on such bits. In some embodiments, modulator 3400 may generate all content of STF field 2502 and/or LTF field 2504. Other implementations are also possible.

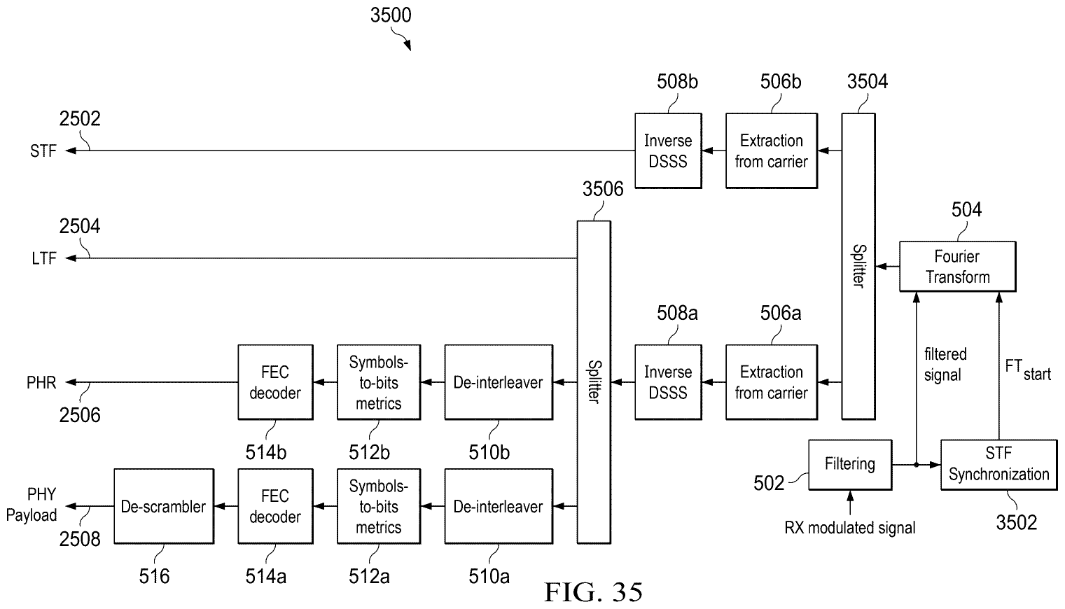

FIG. 35 shows a block diagram of demodulator 3500, according to an embodiment of the present disclosure. Demodulator 304 may be implemented as demodulator 3500. Demodulator 3500 illustrates a possible implementation of processing pipeline 500.

In some embodiments, demodulator 3500 is configured to demodulate a modulated signal generated using modulator 3400, e.g., processing different portions of the modulated signal in a different manner, e.g., so as to recover the PPDU (e.g., 2500), e.g., as shown in FIG. 35.

As shown in FIG. 35, demodulator 3500 includes filtering block 502, STF synchronization block 3502, Fourier Transform block 504, extraction-from-carrier blocks 506a and 506b, inverse DSSS blocks 508a and 508b, de-interleaver blocks 510a and 510b, symbols-to-metrics blocks 512a and 512b, FEC decoder blocks 514a and 514b, and de-scrambler block 516, and splitters 3504 and 3506.

As shown in FIG. 35, in some embodiments, some of the processing blocks may be implemented with multiple instances (e.g., inverse DSSS block 508 may have 2 instances, which may advantageously allow for parallel processing). In some embodiments, a single instance of block (e.g., a single inverse DSSS block 508) may be implemented, which may process data sequentially, e.g., by multiplexing among the different inputs, and possibly switching configuration of the block, e.g., based on the data being processed (e.g., using DSSS value of 2 for processing LTF field 2504, DSSS value of 6 for PHR Field 2506, and a DSSS value selected based on content of PHR field 2506 to process PHY payload field 2508).

As shown in FIG. 35, demodulator 3500 may process different portions of packet 401 (e.g., in the form of PPDU 2500) in different manners.

In some embodiments, STF synchronization block 3502 receives a signal from antenna 308 (e.g., after filtering (e.g., 502) or directly from an ADC (e.g., 330)). STF synchronization block 3502 monitors the received signal (e.g., after filtering by filtering block 502) for detection of an STF field (e.g., 2502) of a PPDU (e.g., 2500) in a particular subcarrier channel STFsubcarrier (e.g., which may be fixed, or may vary dynamically, e.g., for each packet, or according to a hopping sequence, for example).

Once synchronization block 3502 determines that a received sequence matches a predetermined STF value (e.g., such as according to FIG. 26), Fourier Transform block 504 may begin processing of the received packet. For example, in some embodiments, STF synchronization block 3502 may signal, upon an STF match, a time/sample location for Fourier Transform block 504 to begin performing an FFT on the received sampled (e.g., on the output of filtering block 502).

As shown in FIG. 35, demodulator 3500 may process different portions of PPDU 2500 in a different manner (e.g., in a reverse/inverse manner as modulator 3400). For example, splitter 3502 may direct symbols associated with STF field 2502 to be processed by extraction-from-carrier block 506b (e.g., using CHₛₑₗ equal to the same STFsubcarrier used by single sub-carrier mapping block 412b), followed by inverse DSSS block 508b (e.g., using the same DSSS value and polarity used by DSSS block 408d), while directing the rest of the symbols to be processed by extraction-from-carrier block 506a (e.g., using CHₛₑₗ based on the same hopping sequence as single sub-carrier mapping block 412a) followed by inverse DSSS block 508a (e.g., using the same DSSS value and polarity used by DSSS blocks 408a, 408b, and 408c, depending on which of fields 2504, 2506, and 208 is being processed).

Splitter 3506 may direct symbols associated with PHY payload field 2508 to be processed by de-interleaver block 510a, followed by symbols-to-bits metrics block 512a, followed by FEC decoder block 514a, followed by de-scrambler block 516; while directing symbols associated with PHR field 2506 to be processed by de-interleaver block 510b, followed by symbols-to-bits metrics block 512b, followed by FEC decoder block 514b.

In some embodiments, demodulator 3500 places the demodulated data bits (e.g., of STF field 2502 from the output of inverse DSSS block 508b, LTF field 2504 from the output of splitter 3506, PHR field 2506 from the output of FEC decoder 514b, and/or PHY payload field 2508 from the output of de-scrambler block 516) into a receiver (RX) first-in-first-out (FIFO) buffer for further processing/use (e.g. by the same controller/demodulator performing the demodulation or by another controller). In some embodiments, some of the fields (e.g., STF field 2502 and/or LTF field 2506) may not be placed in the FIFO for further processing.

In some embodiments, such as in embodiments in which STF field 2502 is a fixed (e.g., predetermined) sequence (e.g., without any configurable bits), blocks 3504, 506b and 508b may be omitted and data associated with STF field 2502 may not be directly extracted/recovered. Instead, in some such embodiments, STF synchronization block 3502 may implement some such functionality to generate a match and an indication of the start location for beginning processing by Fourier Transform block 504 may be sufficient to indirectly determine the value of STF field 2502.

In some embodiments, the entire contents of STF field 2502 (including the sub-carrier used for transmission of STF field 2502) is predetermined and known to STF synchronization block 2502 to be able to generate a match (performed packet detection) and/or frequency offset determination. In some embodiments, STF field 2502 may include additional bits (not used for packet detection and/or frequency offset determination), which may be used for other purposes, such as for selecting a hopping sequence (e.g., to be followed to receive the rest of packet 401).

In some embodiments, only some of the bits (e.g., the last 2 bits) of STF field 2502 may be processed by blocks 506b and 508b (e.g., while ignoring the rest of the bits of STF field 2502).

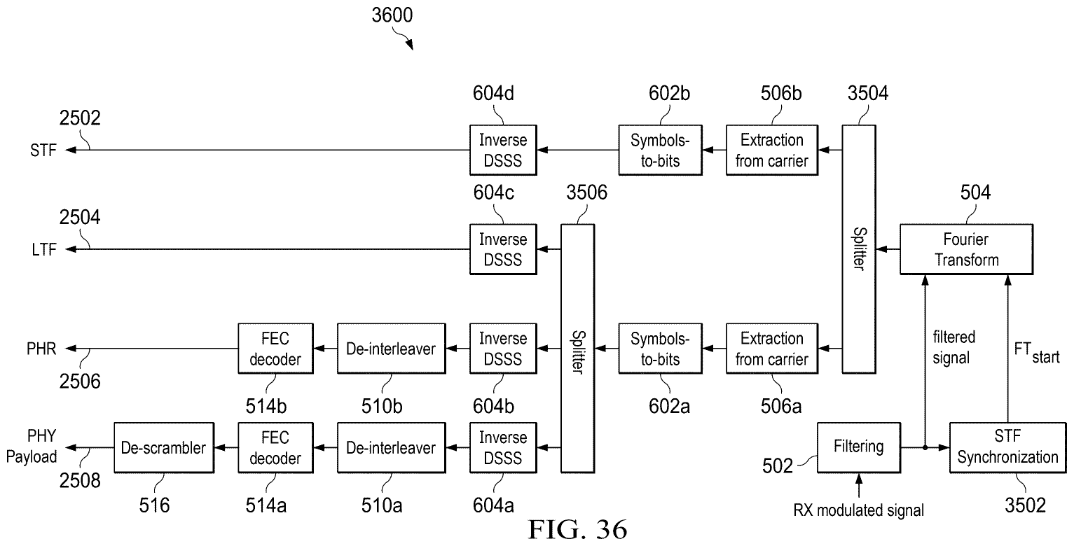

FIG. 36 shows a block diagram of demodulator 3600, according to an embodiment of the present disclosure. Demodulator 304 may be implemented as demodulator 3600.

Demodulator 3600 operates in a similar manner as demodulator 3400. Demodulator 3600 illustrates a possible implementation of processing pipeline 600.

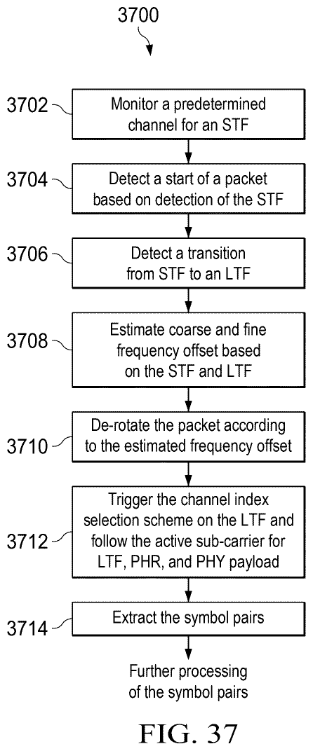

FIG. 37 shows a flow chart of embodiment method 3700 for receiving a packet (e.g., 401), according to an embodiment of the present disclosure. Method 3700 may be performed, e.g., by demodulator 304, such as by demodulators 3500 or 3600.

During step 3702, a demodulator (e.g., 304, 3500, 3600) monitors a predetermined sub-channel for detecting, e.g., a predetermined and fixed, STF sequence (e.g., using STF synchronization block 3502).

During step 3704, in response to detecting a match of the STF sequence, a start of the packet is detected (e.g., using STF synchronization block 3502).

During step 3706, a transition from the STF sequence to an LTF sequence is detected or determined (e.g., using STF synchronization block 3502).

During step 3708, coarse and fine frequency offset are determined based on the STF and LTF sequences (e.g., using STF synchronization block 3502).

During step 3710, the packet (e.g., the symbols of the packet) are de-rotated according to the estimated frequency offset (e.g., using STF synchronization block 3502). For example, in some embodiments, the symbols of the packet are mixed in frequency so as to cancel the estimated frequency offset performed during the STF. The resulting symbols may have no significant frequency offset (e.g., are effectively baseband symbols).

During step 3712, the channel index selection scheme for selecting CHₛₑₗ (e.g., according to hopping sequence 2804) is triggered, and is used for selecting the sub-channel for symbol extraction. For example, in some embodiments, the index selection scheme uses LCGa and LCGc, as well as the STFsubcarrier for determining the hopping sequence.

During step 3714, the symbol pairs are extracted from the channels selected during step 3712 (e.g., by using the selected CHₛₑₗ for blocks 506a and 506b), and are then further processed (e.g., as shown in FIGS. 35 and 36).

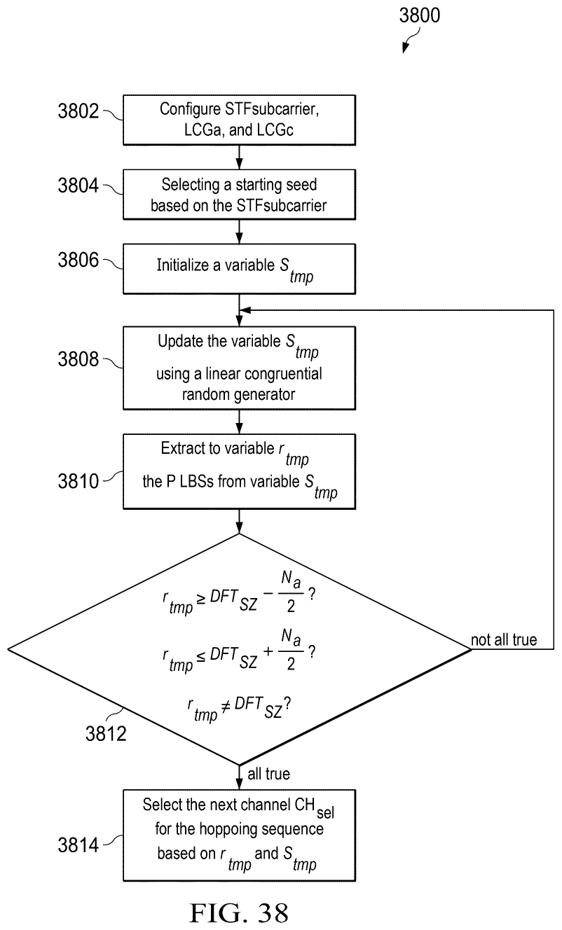

FIG. 38 shows a flow chart of embodiment method 3800 for generating a hopping sequence (e.g., 2804), according to an embodiment of the present disclosure. Method 3800 may be performed, e.g., by modulator 304 (e.g., by single sub-carrier mapping block 412), such as by demodulators 3500 or 3600.

During step 3802, a demodulator (e.g., 304, 3400, such as by block 412) configures a subcarrier channel (e.g., STFsubcarrier) for transmission of a synchronization sequence (e.g., 3802), and one or more coefficients (e.g., LCGa and LCGc). In some embodiments, the STFsubcarrier and/or the one or more coefficients are known a priori, such as received out-of-band, programmed by a semiconductor manufacturer or a user of the device (e.g., 202, 252), etc.

During step 3804, a starting seed for determining the hopping sequence (e.g., 2804) is selected based on the STFsubcarrier received during step 3802. For example, if S={s(k)}, 0≤k≤M−1, where s(k)∈(0,255) is a vector that contains all the seed values for corresponding hopping sequences, a second vector J={j(k)}, 0≤k≤M−1, where

$$j ( k ) ∈ ( - \frac{{N}_{a}}{2} , \frac{{N}_{a}}{2} ) ,$$

Na is the number of active tones (e.g., sub-channels used for transmission) that contains the sub-channel index to be used in that specific symbol, and the starting seed for generating the hopping sequence (e.g., 2804) be s(0)=s(1)=DFT_{SZ}+STFsubcarrier, the starting seed for the algorithm, with j(0)=j(1)=STFsubarrier.

During step 3806, a variable Sₜₘₚ is initialized. In some embodiments, Sₜₘₚ is initialized to be the seed value from the previous iteration s(k−1).

During step 3808, the variable Sₜₘₚ is updated using a linear congruential random generation based on the one or more coefficients received during step 3802. For example, in some embodiments, the variable Sₜₘₚ is updated according to Equation 6.

During step 3810, the P LSBs from the variable Sₜₘₚ are extracted and stored in variable rₜₘₚ. In some embodiments, P may be given by Equation 7. In some embodiments, extraction of the P LSBs may be performed according to Equation 8.

During step 3812, rₜₘₚ is compared against three conditions:

$$1. {r}_{tmp} \geq {DFT}_{SZ} - \frac{{N}_{a}}{2} ;$$

$$2. {r}_{tmp} \leq {DFT}_{SZ} + \frac{{N}_{a}}{2} ; and$$

$$3. {r}_{tmp} \neq {DFT}_{SZ} ,$$

where Nₐ is the number of data tones in a symbol. In some embodiments, when all 3 conditions are true, then j(k)=rₜₘₚ−DFT_{SZ} and s(k)=sₜₘₚ are set during step 3814. Otherwise, a new iteration is performed until the three conditions are satisfied.

In some embodiments, vector J includes the sequence of sub-channels (e.g., j(k) represents the next channel), and vector S is the seed vector.

By selecting the seed using a linear congruential random generated, e.g., as in method 3800, some embodiments advantageously generate a hopping sequence that does not visit any channels before repeating. In some embodiments, once the sequence has hopped through all channels in the set, the sequence repeats.

By using the STFsubcarrier as a seed for generating the hopping sequence, e.g., as in method 3800, some embodiments advantageously generate different sequences when using different channels for transmission of the synchronization sequence, where the different sequences may advantageously be orthogonal to each other, or that do not substantially interfere that with each other. By generating such different hopping sequences, some embodiments may advantageously allow for geographical coexistence of multiple networks without substantially impacting the transmission error rate. In some embodiments, such different hopping sequences are rotated versions of each other.

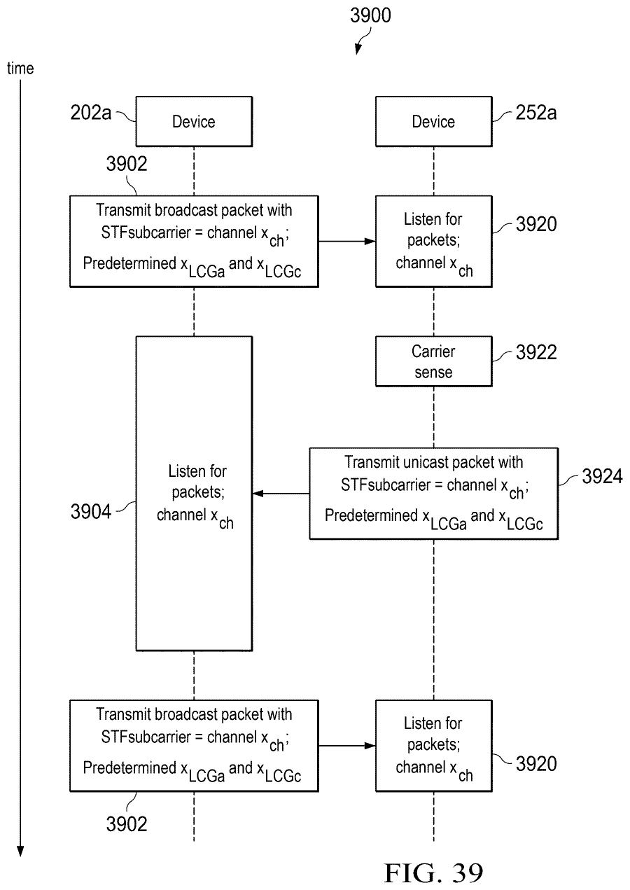

In some embodiments (e.g., as illustrated in FIG. 2), data may be transmitted between two devices (e.g., between devices 202 and 252). For example, FIG. 39 shows a flow chart of embodiment method 3900 for packet exchange, according to an embodiment of the present disclosure.

During step 3902, device 202a transmit a (e.g., broadcast) packet (e.g., 401, such as 2500) using a predetermined sub-channel x_{ch} for transmitting STF field 2502, and using a predetermined hopping sequence (e.g., based on predetermined x_{LCGa}, x_{LCGc} and x_{ch}, e.g., using 3800). In some embodiments, PHY payload 2508 of the broadcast packet may include a command/request for data.

During steps 3920, device 252a monitor the predetermined sub-channel x_{ch} for packet detection (e.g., using respective STF synchronization blocks 3502). Upon detection of the broadcast packet (e.g., and responsive to the command/request for data), device 252a performs carrier sense (e.g., listen before talk) to transmit a packet (e.g., 401, such as 2500), which may be an acknowledgement (ACK) packet or a data packet, and may include data (e.g., such as sensed data).

Once device 252a detects that sub-channel x_{ch} is idle, device 252a begins transmission of a (e.g., unicast) packet during step 3924, using the same sub-channel x_{ch} and the same hopping sequence during step 4002.

During step 3904, device 202a listen for packets from device 252a (e.g., monitoring sub-channel x_{ch} for STF detection).

This process may repeat periodically, as shown in FIG. 39.

In some embodiments, method 3900 may be synchronous. In some embodiments, method 3900 may be asynchronous. For example, in some embodiments, step 3902, and 3920 may be omitted, and device 252a may asynchronously transmit packets (e.g., as data becomes available) while device 202a is (e.g., continuously) listening during step 3904.

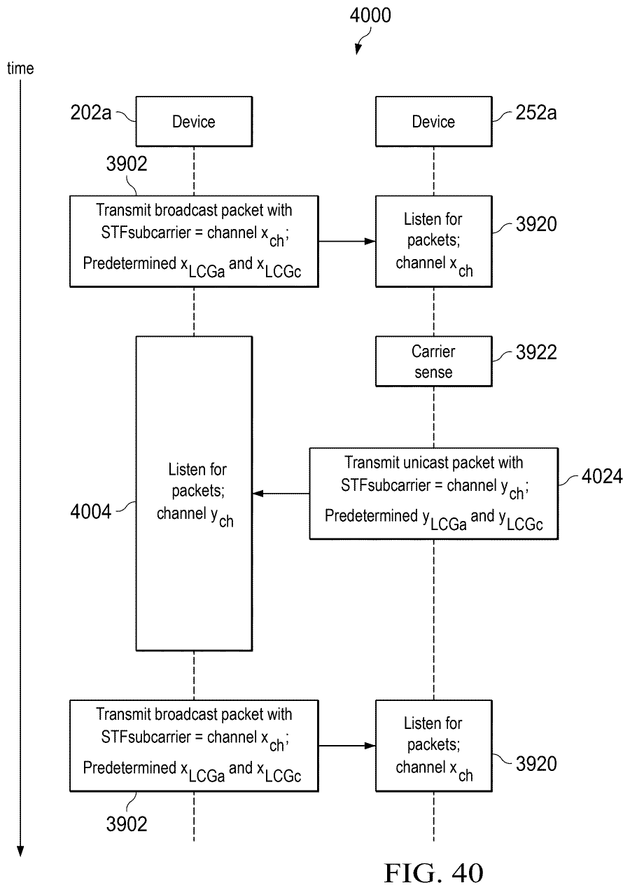

In the embodiment of FIG. 39, devices 202a and 252 each use the same STFsubcarrier and same hopping sequence. In some embodiments, devices 202a and 252 may transmit using different STFsubcarriers and/or hopping sequences. For example, FIG. 40 shows a flow chart of embodiment method 4000 for packet exchange, according to an embodiment of the present disclosure. Method 4000 is similar to method 3900. In method 4000, however, device 252a transmit the packet during step 4024 using an STFsubcarrier equal to y_{ch}, which is different from the STFsubcarrier used by device 202a during step 3902. Device 252a may also use a different hopping sequence (e.g., y_{LCGa} and y_{LCGc} may be different than x_{LCGa} and x_{LCGc}). As such, device 202a listens for packets during step 4004 monitoring sub-channel y_{ch} and using the hopping sequence corresponding to step 4024.

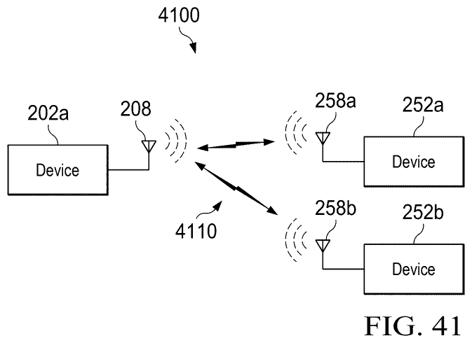

Some embodiments may transmit data from one device to multiple devices, from multiple devices to one device, or from multiple devices to multiple devices, e.g., within the same geographical area. For example, FIG. 41 illustrates communication system 4100, according to an embodiment of the present disclosure. As shown in FIG. 41, communication system 4100, includes multiple devices 252 (only 2 shown in FIG. 41) and a single device 202 as part of network 4110.

In the embodiment of FIG. 41, all devices 252 communicate with device 202 but may not communicate with each other.

In some embodiments, all packet exchanges (e.g., 401) between device 202 and devices 252a and 252b use the same fixed sub-channel (e.g., STFsubcarrier) for transmitting the synchronization sequence (e.g., 2802). Thus, in some embodiments, device 202a may transmit (e.g., broadcast) a synchronization sequence (e.g., 2802), e.g., periodically (e.g., for each packet, as STF field 2502) using a predetermined STFsubcarrier (e.g., sub-channel 9), e.g., to all devices 252; and each of devices 252 (e.g., 252a and 252b) may transmit (e.g., unicast) data (e.g., synchronously or asynchronously, sequentially, or simultaneously) to device 202a using the same fixed sub-channel (e.g., sub-channel 9) for transmitting synchronization sequence 2802 (e.g., for transmitting STF field 2502). In some such embodiments, hopping sequences 2804 transmitted by each of the devices (e.g., 202a, 252a, and 252b) may be the same for packet (e.g., 401, 2800) transmissions. In some such embodiments, carrier sense or other listen-before-talk mechanism may be performed before attempting to transmit a packet (e.g., to avoid collisions).

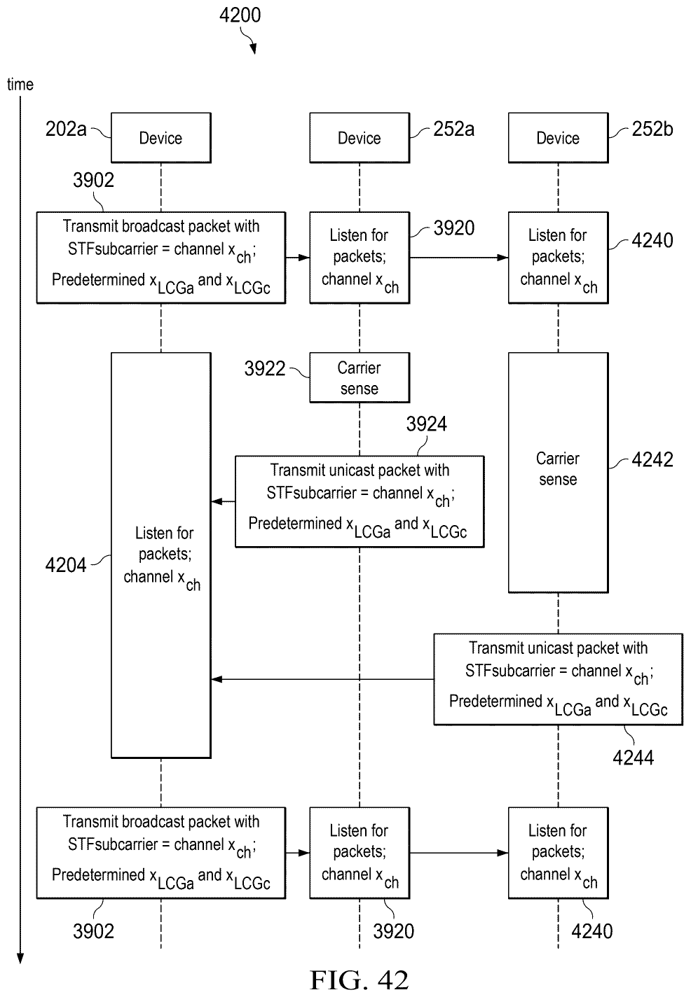

FIG. 42 shows a flow chart of embodiment method 4200 for packet exchange, according to an embodiment of the present disclosure. Method 4200 is similar to method 3900. Method 4200, however, includes multiple devices 252a (e.g., as in network 4110).

Steps 3902, 3920, 3922, and 3924 may be performed in a similar or identical manner as described with respect to FIG. 39. In method 4200, however, device 252b also monitors during step 4240 the predetermined sub-channel x_{ch} for packet detection (e.g., using respective STF synchronization blocks 3502). Upon detection of the broadcast packet (e.g., and responsive to the command/request for data), each of devices 252a and 252b perform carrier sense (e.g., listen before talk) to transmit respective packets (e.g., 401, such as 2500) during steps 3922 and 4242, respectively.

In the example of FIG. 42, device 252a begins transmission of the unicast packet before device 252b during step 3924, using the same sub-channel x_{ch} and the same hopping sequence during step 3902. Since the sub-channel (x_{ch}) is busy for device 252b to transmit STF, device 252b waits until transmission during step 3924 is finalizes, and then begins transmission of a packet during step 4244 using the same sub-channel x_{ch} and the same hopping sequence during step 3902.

During step 4204, device 202a listen for packets from devices 252a and 252b. In some embodiments, device 202a may identify the origin/source of each packet based on an id field of each packet (e.g., in respective PHY payload fields 2508).

In some embodiments, method 4200 may be synchronous. In some embodiments, method 4200 may be asynchronous. For example, in some embodiments, step 3902, 3920, and 4240 may be omitted, and devices 252a and 252b may asynchronously transmit packets (e.g., as data becomes available) while device 202a is (e.g., continuously) listening during step 4204.

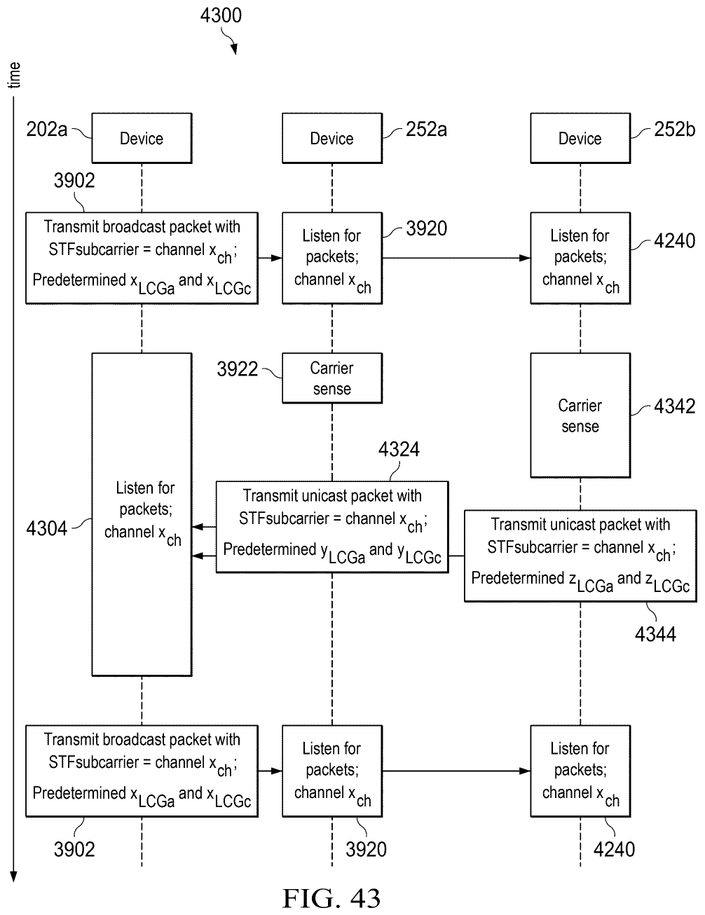

In some embodiments, the hopping sequences 2804 used by each of devices 252a and 252b may be different, e.g., when using the same fixed sub-channel for synchronization sequence 2802 (e.g., based on unique LCGa and/or LCGc values) or when using different channels for synchronization sequences 2802 (e.g., based on unique STFsubcarrier, with same or different coefficients LCGa and/or LCGc). For example, FIG. 43 shows a flow chart of embodiment method 4300 for packet exchange, according to an embodiment of the present disclosure. Method 4300 is similar to method 4200. Method 4300, however, includes multiple devices 252 (e.g., 252a and 252b) transmitting simultaneously.

Steps 3902, 3920, 4240, 3922, and 4242 may be performed in a similar or identical manner as described with respect to FIG. 42. In method 4200, however, device 252b begins transmission of a packet during step 4344 which at least partially overlaps with a packet transmission of device 252a during step 4324.

During step 4324, device 252a detects sub-channel x_{ch} as idle, and transmits synchronization sequence (e.g., 2802, e.g., STF field 2502) in sub-channel x_{ch}. Device 252b detects sub-channel x_{ch} as busy during step 4342 and continues to monitor sub-channel x_{ch} until sub-channel x_{ch} becomes idle (e.g., once transmission by device 252a of its synchronization sequence finishes). Once sub-channel x_{ch} becomes idle, device 252b begins transmission of a packet during step 4344 using a different hopping sequence than device 252a during step 4324 (e.g., (y_{LCGa}, y_{LCGc}) may be different than (z_{LCGa}, z_{LCGc})).

By using different hopping sequences, some embodiments advantageously allow for less wait time for a device to begin transmission (e.g., carrier sense step 4342 may be shorter than carrier sense step 4242).

In some embodiments, 4344 may be performed simultaneously with step 4324, e.g., when using different sub-channel for transmission of respective synchronization sequences.

In some embodiments, step 4344 may use the same hopping sequence as step 4324, e.g., by starting transmission a delay time after transmission during step 4324, which may result in a rotated hopping sequence (e.g., to the offset in start times).

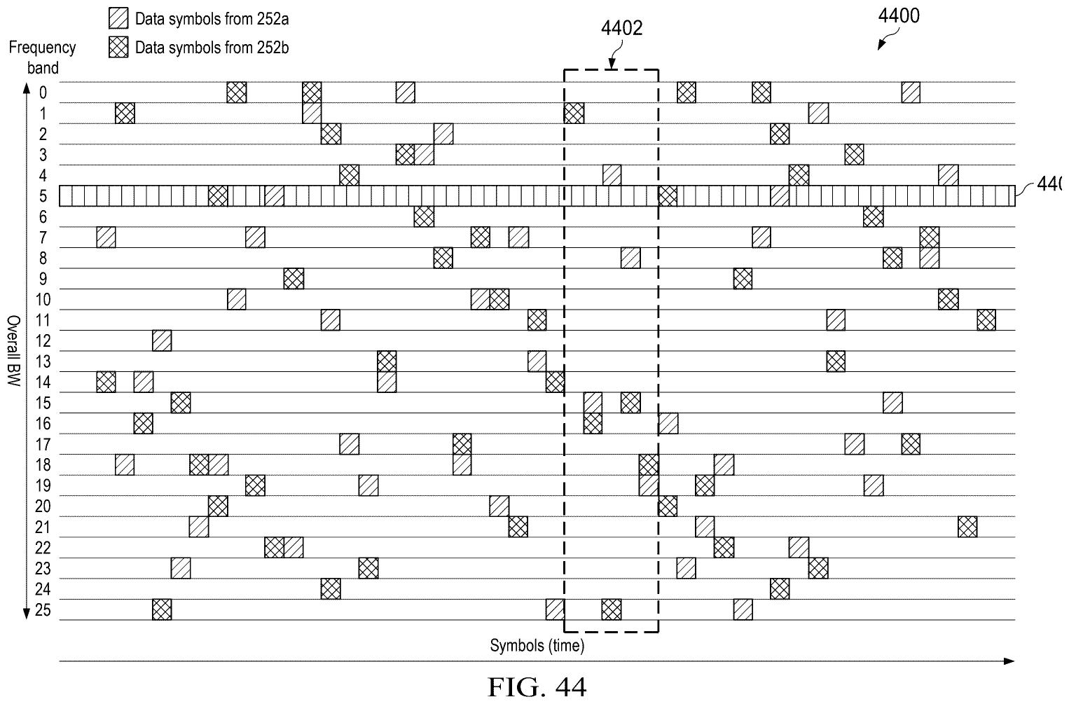

FIG. 44 illustrates symbol transmission of communication system 3900, according to an embodiment of the present disclosure. In particular, FIG. 44 illustrates data symbols transmitted from device 252a, data symbols transmitted from device 252b, wideband burst interference 4402, and narrowband interference 4404.

In some embodiments, device 202a may advantageously recover the data bits from the data symbols received from device 252a despite the presence of wideband burst interference 4402, narrowband interference 4404, and interferer symbols (e.g., symbols from device 252b, as well as possibly from other devices 252 (not shown)).

Similarly, in some embodiments (e.g., as in method 4300), device 202a may, in addition to recovering the data bits from the data symbols received from device 252a, may advantageously recover (e.g., in parallel) the data bits from the data symbols received from device 252b.

As can be seen in FIG. 44, narrowband interference 4404 may correspond to a transmission of a synchronization sequence 2804 (e.g., during step 4344), thereby illustrating coexistence of transmission from multiple devices without (e.g., substantially) degrading performance of data transmission.

As shown in FIG. 44, using different hopping sequences (e.g., due to rotation, or otherwise) may advantageously aid in avoiding collisions between simultaneous or partially overlapping in time transmissions (e.g., from multiple devices 252 to device 202).

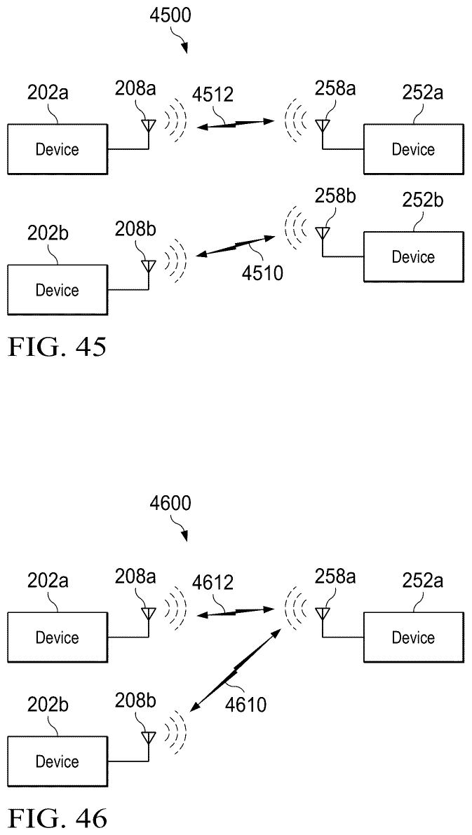

FIG. 45 illustrates communication system 4500, according to an embodiment of the present disclosure. Communication system 4500 operates in a similar manner as communication 200. Communication system 4500, however, includes multiple networks (4510, 4512) overlapping in the same geographical location. Although only 2 devices are shown in FIG. 45 for each of the networks, each network may include more than 2 devices. In some embodiments, a device (e.g., 202 or 252) may belong to more than 1 network. Other implementations are also possible.

As shown in FIG. 45, each device 252 may communicate with a respective device 202 in a respective network. In some such embodiments, devices may not communicate across network (e.g., device 202a does not communicate with device 252b, and device 202b does not communicate with device 202b).

Packet exchanges in each of networks 4510 and 4512 may be performed, e.g., in a similar manner as in methods 3900, 4000, 4200, or 4300.

As can be seen in FIG. 44, when networks overlap in the same geographical locations, (as illustrated in FIG. 45), devices (e.g., 202, 252) may still successfully transmit and receive packets, e.g., in the presence of other transmissions and/or interference. For example, in some embodiments, the communication between device 202a and device 252a (and similarly between device 202b and device 252b) enjoys the same capability of recovering the data bits from the received symbols despite the presence of burst interference, narrowband interference, and interferer symbols (e.g., in a similar manner as illustrated in FIG. 44).

In some embodiments, each communication between a device 202 and a respective device 252 in each of the networks (e.g., 4510, 4512) may use a different sub-channel for synchronization sequence 2802. Using a unique sub-channel for transmitting synchronization sequence 2802 may advantageously allow for multiple networks to coexist in the same geographical location with low risk of collision.

FIG. 46 illustrates communication system 4600, according to an embodiment of the present disclosure. Communication system 4600 operates in a similar manner as communication 4500. Communication system 4600, however, includes a device (e.g., 252a) that operates in multiple networks (e.g. 4610, 4612).

In some embodiments, each network may be configured in a different manner (may use same or different STFsubcarrier, same or different LCGa and LCGc coefficients, and/or same or different STF sequence, etc.).

In some embodiments, communications between device 252a and device 202a may use the same first fixed subchannel for synchronization sequence 2802, and communications between device 252a and device 202b may use the same second fixed subchannel for synchronization sequence 2802, where the second fixed subchannel is different from the first fixed subchannel. In some such embodiments, the actual synchronization sequence 2802 for each network (4610 and 4612) may be equal or different. In some such embodiments, hopping sequences 2804 for each network (4610 and 4612) may be different, even when using the same LCGa and LCGc values, as the STFsubcarrier is different for each network. For example, in some embodiments, a set of {LCGa, LCGc} may always give the same periodic hopping sequence, with the starting channel being determined by a seed, such as by the STFsubcarrier. Thus, in some such embodiments, two devices operating with different synchronization sequence may use the same hopping sequence with a timing offset between them.

In some embodiments, communications between device 252a and device 202a, and between device 252a and device 202b use the same first fixed subchannel for synchronization sequence 2802. In some such embodiments, the actual synchronization sequence 2802 for each network (4610 and 4612) may be different (e.g., to identify each network). In some such embodiments, hopping sequences 2804 may be different for each network (e.g., 4610 and 4612), even when using the same fixed sub-channel for synchronization sequence 2802 (e.g., based on unique LCGa and LCGc values).

Packet exchanges in each of networks 4610 and 4612 may be performed, e.g., in a similar manner as in methods 3900, 4000, 4200, or 4300.

In some embodiments, the communication between device 252a and device 202a (and similarly between devices 252a and 202b) enjoys the same capability of recovering the data bits from the received symbols despite the presence of burst interference, narrowband interference, and interferer symbols (e.g., in a similar manner as illustrated in FIG. 44).

In some embodiments, a device may operate according to different examples, e.g., at different times. For example, in an embodiment, a device (e.g., 252a) may operate using method 3900 or 4000 when in network 200, according to method 4200 or 4300. In some embodiments, a device (e.g., 252a) may simultaneously be part of different networks (e.g., 4110, 4610, 4612) while operating in the same geographical area of other networks (e.g., 4510). Other implementations are possible.

In some embodiments, device 252a may transmit data to device 202a during a first time using a first fixed subchannel for a first synchronization sequence 2802, and transmit data to device 202b during a second time using a second fixed subchannel for a second synchronization sequence 2802, where the first and second fixed subchannels are different. Using different fixed subchannels for each network allows for network separation even when there is geographical overlap between the networks. In some embodiments, the first and second synchronization sequences 2802 may be identical. In some embodiments, the first and second synchronization sequences 2802 may be different.

Although not shown in FIG. 46, device 202a may also communicate with (e.g., transmit to and/or receive data from) other devices 252. Similarly, device 202b may also communicate with other devices 252 (not shown in FIG. 46).

In some embodiments, settings for any network of communication systems 200, 3900, 4100, 4500, and 4600 may be negotiated, e.g., using method 2400.

In some communications between 2 or more devices (e.g., such as shown in FIGS. 2, 41, 45, and 46), the use of a fixed subchannel for synchronization sequence 702 may result in limits on capacity and limits of fading. For example, in the embodiment of FIG. 41, if device 202a is listening for packets from devices 252a and 252b, and each of devices 252a and 252b can asynchronously transmit packets at any time (e.g., according to a pure ALOHA protocol), using the same fixed subchannel for synchronization sequence 702 may result in collisions (e.g., collisions during transmission of STFs). In some such embodiments, devices 252a and 252b may be subject to static fading conditions to the specific fixed subchannel used for synchronization sequence 2802, which, in some cases, may disable the communication entirely.

In some embodiments, a plurality of subchannels are used for synchronization sequence 2802 (a plurality of synchronization subcarriers). In some such embodiments, N synchronization sub-carriers and hopping sequences combinations may be enabled for a specific network (e.g., 210, 4110, 4510, 4512, 4610, or 4612), e.g., at the time of network formation, out of all possible M combinations, such that N is higher than 1 and lower than or equal to M. In some such embodiments, transmitting devices (e.g., 252) are able to select any synchronization sub-carrier and hopping sequence from a valid set of combinations (e.g., defined at the network formation). In some such embodiments, transmitting devices may select any of the valid synchronization sub-carriers, e.g., randomly, in a round-robin manner, or in a different manner. In some such embodiments, a new synchronization subcarrier may be selected each time a new packet is transmitted, each time a group of packets is transmitted, at predetermined times (e.g., periodically), or in a different manner.

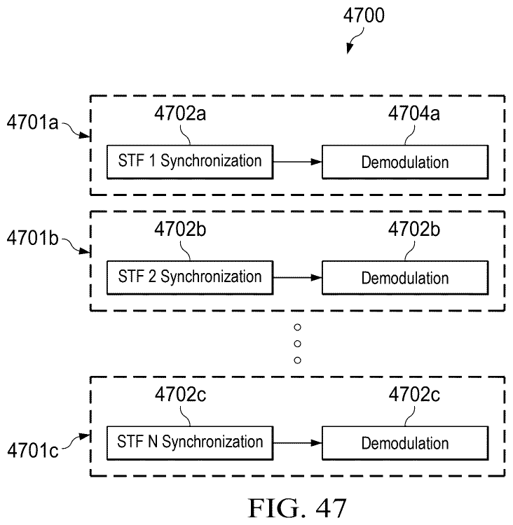

In some embodiments using a plurality of synchronization subcarriers, the device receiving the data (e.g., 202) may be implemented with N receivers (e.g., having N RF cores 204 and implementing N processing pipelines (e.g., 500, 600), e.g., in respective controllers 206 or in a single controller 206). Each of the N receivers may be configured to listen to specific but different synchronization carriers and hopping sequences from the valid set of combinations (e.g., determined at the network formation). For example, FIG. 47 illustrates device 4700 having N receivers 4701 for listening to N different synchronization carriers and hopping sequences, according to an embodiment of the present disclosure. Device 202 and/or device 252 may implement the N receivers 4701.

As shown in FIG. 47, in some embodiments, each receiver 4701 includes an STF synchronization block 4702 and a demodulation block 4704. For example, in some embodiments, each of the N receivers 4701 may be implemented or include a demodulator implemented as 3500 or 3600, each of which with the STF synchronization block 3502 implemented as the respective STF synchronization block 4704 and configured to listen for a respective synchronization sequence 2802 in a respective synchronization subcarrier.

In some embodiments, each STF synchronization block 4702 includes a correlation structure that determines when an associated expected STF 2502 is received. Upon receipt of the associated expected STF field 2502, an STF synchronization block 4702 signals to a subsequent block (e.g., 504, 506, 508, 510, 512, 514, or 516) to start processing data from the PPDU 2500). In some embodiments, such subsequent block is or includes an LTF synchronization block (not shown) used for finer synchronization.

In some embodiments, each STF synchronization block 4702 is configured to listen for the STF field 2502 of PPDU 2500 in a particular (e.g., predetermined at network formation) subcarrier channel (e.g., which may be fixed, or may vary dynamically). In some embodiments, each STF synchronization block 4702 includes blocks 506b and 508b of FIG. 35.

In some embodiments, once a particular STF synchronization block 4702 receives a valid STF field 2502, the associated demodulation block 4704 processes the rest of the fields associated with the same PPDU. For example, if STF synchronization block 4702b receives a valid STF filed 2502 during a first time, then (e.g., only) demodulation block 4704b processes the rest of the associated PPDU 2500, e.g., according to a specific hopping sequence associated with STF synchronization block 4702b.

In some embodiments, each demodulation block 4704 includes blocks 506a, 508a, 510a, 510b, 512a, 512b, 514a, 514b, and 516.

In some embodiments, the number of receiving devices (e.g., of device 202) may be the same as the number of different synchronization subcarriers.

In some embodiments, each of the receivers (e.g., of device 202) may independently receive the entire data payload encoded in the hopping sequence.

In some embodiments, the same controller (e.g., 206 or 256) may implement each of the N receivers.

In some embodiments, device 4700 includes N RF cores (e.g., 204, or 254), N antennas (e.g., 208 or 258), and N controllers (e.g., 206, or 256), each RF core coupled to a respective antenna and controller, where each of the N receivers 4701 with a (e.g., unique) RF core, controller and antenna. In some such embodiment, an additional controller (not shown) may be implemented to receive inputs from each of the N receivers.

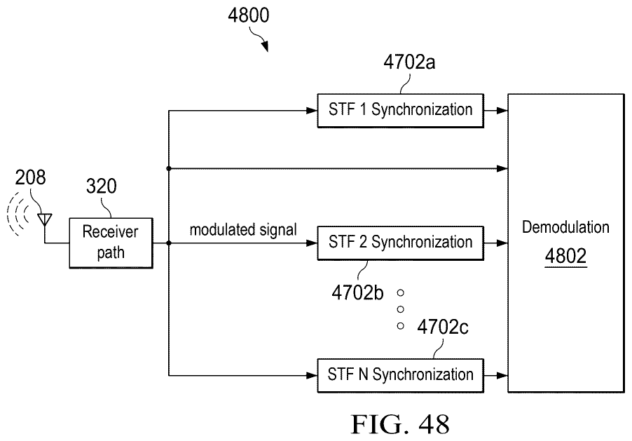

In some embodiments using a plurality of synchronization subcarriers, the device receiving the data (e.g., 202) may be implemented with a common analog front end (e.g., a common RF core 204), N synchronizer blocks (e.g., 4702), and a common demodulator. When one of the synchronizer blocks (e.g., 4702b) detects the associated STF field 2502, then such synchronizer block (e.g., 4702b) commands the demodulation stage to decode the information encoded in that specific STF field 2502 (if applicable) and hopping sequence 2804 (e.g., fields 2504, 2506, 2508). For example, FIG. 48 illustrates device 4800 having a common receiver path 320, N synchronizer blocks 4702 for listening to N different synchronization carriers, and common demodulator 4802, according to an embodiment of the present disclosure. In some embodiments, RF core 202 and/or 254 may implement the common receiver path 320, and controller 206 and/or 256 may implement the N synchronizer blocks 4702 and the common demodulator 4802.

In some embodiments, once a particular STF synchronization block 4702 (e.g., 4702b) receives a valid STF field 2502, the particular synchronization block 4702 commands the common demodulation block 4802 to process the fields associated with the same PPDU 2500, e.g., according to a specific hopping sequence (e.g., 2804) associated with STF synchronization block 4702b.

In some embodiments, demodulation block 4802 includes blocks 506a, 508a, 510a, 510b, 512a, 512b, 514a, 514b, and 516. Such blocks of demodulation block 4802 may be reconfigured based on which STF synchronization block 4702 triggers the processing, as processing may defer for PPDU 2500 associated with different STF synchronization blocks 4702 (e.g., may have different DSSS, etc.).

In some embodiments, the number of synchronization blocks 4702 may be the same as the number of different synchronization subcarriers.

In some embodiments, the number of synchronization blocks 4702 of device 4800 may be the same as the number of different synchronization subcarriers.

In some embodiments, each of synchronization blocks 4702 may receive the modulated signal, e.g., directly from an ADC (e.g., 330). In some embodiments, each synchronization block 4702 may receive an already (e.g., partially), e.g., digitally, processed version of the modulated signal, (e.g., from filtering block 502 or from Fourier transform block 504).

In some embodiments, the same controller (e.g., 206 or 256) may implement each of the N synchronization blocks 4702 and common demodulation block 4802.

In some embodiments, a transmitting device (e.g., 252) may transmit data to a receiving device (e.g., 202) while sequentially using a plurality of synchronization subcarriers and hopping sequences (e.g., after each packet). In some embodiments, the transmitting and receiving device may be part of a larger network, such as illustrated in FIGS. 41, 45 and 46.

Some embodiments using multiple synchronization subcarriers and hopping sequences (e.g., that can be dynamically (e.g., arbitrarily) changed) may advantageously solve or improve capacity and fading issues, e.g., associated with the use of a single fixed synchronization subcarrier.

In some embodiments, each of the combinations of synchronization subcarriers and hopping sequences is orthogonal to each other, which may advantageously allow multiple devices to listen to each of these without interference (e.g., as illustrated in FIG. 44).

Some embodiments using multiple synchronization subcarriers and hopping sequences may advantageously provide additional expanded network capacity compared to communication systems using a fixed synchronization subcarrier.

In some embodiments, a transmitter (e.g., 202, 252) may transmit, during a first time, a first packet that includes an STF transmitted using a first single subcarrier followed by a rest of the first packet using a first hopping sequence that uses a single subcarrier at a time, and transmit, during a second time, a second packet that includes an STF transmitted using a second single subcarrier followed by a rest of the second packet using a second hopping sequence that uses a single subcarrier at a time.

Some embodiments (as can be seen in FIGS. 28, and 34-36) receive the synchronization sequence 2802 in a single subcarrier, were the synchronization sequence 2802 corresponds to the STF field 2502 of PPDU 2500. As such, some embodiments monitor the single subcarrier on which the STF field 2502 is expected (either a fixed subcarrier, or a dynamically changing subcarrier) to receive the STF field 2502. Once the STF field 2502 is received, the LTF field 2504 (which may use all available subchannels, e.g., according to a hopping sequence, using one subcarrier at a time) is received and used for finer synchronization.

Conventional OFDM systems, such as the SUN OFDM PHY described in chapter 20 of IEEE Std 802.15.4-2020, use more than 1 subcarrier simultaneously to receive the STF for synchronization purposes. For example, the SUN OFDM PHY described in chapter 20 of IEEE Std 802.15.4-2020 uses N/4 subcarriers for receiving, in parallel, the STF, where N is the total number of available subcarriers.

In some embodiments, a device (e.g., 202, 252) includes a common analog front-end and filtering elements (e.g., 320), and a dual correlation structure, where one of the correlation structures is adapted to receive STF in accordance with a conventional OFDM waveforms, such as an STF in accordance with the SUN OFDM PHY, and the other of the correlation structures adapted to receive a single subcarrier STF, such as described in FIGS. 28, and 34-36.

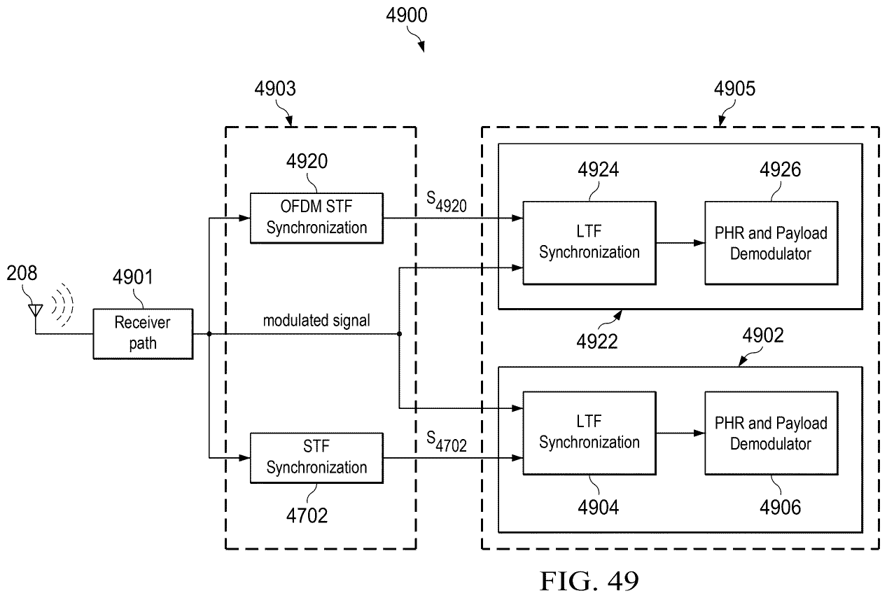

FIG. 49 illustrates device 4900 having common receiver path 4901, dual correlation structure 4903, and dual demodulator 4905, according to an embodiment of the present disclosure. Device 202 and/or 252 may be implemented as device 4900. Dual correlation structure 4903 includes STF synchronization block 4702, and OFDM STF synchronization block 4920. Dual demodulator 4905 includes demodulator 4902 and demodulator 4922. Demodulator 4902 includes LTF synchronization block 4904 and PHR and payload demodulator block 4906. Demodulator 4922 includes LTF synchronization block 4924 and PHR and payload demodulator block 4926. In some embodiments, receiver path 4901 may be implemented as receiver path 320.

During normal operation, each of synchronization blocks 4920 and 4702 receive modulated signal from receiver path 4901. In response to a successful correlation by one of the STF synchronization blocks (e.g., 4702 or 4920), the respective synchronization block asserts a signal (e.g., S₄₉₂₀ or S₄₇₀₂) so that the associated demodulator (e.g., 4922 or 4902) processes the modulated signal. For example, when OFDM STF synchronization block 4920 finds successful correlation of the modulated signal, signal S₄₉₂₀ is asserted (e.g., operating as a start or enable signal) so that demodulator 4922 processes the modulated signal. Similarly, when STF synchronization block 4702 finds successful correlation of the modulated signal, signal S₄₇₀₂ is asserted (e.g., operating as a start or enable signal) so that demodulator 4902 processes the modulated signal.

In some embodiments, blocks 4920 and 4922 may be implemented in accordance with the SUN OFDM PHY described in chapter 20 of IEEE Std 802.15.4-2020.

In some embodiments, demodulator 4902 may be implemented in a similar manner as demodulator 3500 or 3600.

In some embodiments, OFDM STF synchronization block 4920 simultaneously listens to multiple subcarriers to receive the STF, e.g., according to a conventional OFDM PHY, such as the SUN OFDM PHY, while STF synchronization block 4702 listens to a single subcarrier to receive the STF (e.g., 2802).

In some embodiments, OFDM STF synchronization block 4920 simultaneously listens to multiple subcarriers of a plurality of subcarriers, while STF synchronization block 4702 listens to a single subcarrier of the same plurality of subcarriers.

In some embodiments, the multiple subcarriers to which OFDM STF synchronization block 4920 listens to does not include the single subcarrier to which STF synchronization block 4702 listens to.

In some embodiments, the multiple subcarriers to which OFDM STF synchronization block 4920 listens to includes the single subcarrier to which STF synchronization block 4702 listens to.

In some embodiments, LTF synchronization block 4904 includes blocks 506a and 508a of FIG. 35.

In some embodiments, PHR and payload demodulator block 4906 includes blocks 510a, 510b, 512a, 512b, 514a, 514b, and 516 of FIG. 35.

In some embodiments, each of synchronization blocks 4702 and 4920 may receive the modulated signal, e.g., directly from an ADC (e.g., 330). In some embodiments, each of synchronization block of 4702 and 4920 may receive an already (e.g., partially), e.g., digitally, processed version of the modulated signal, (e.g., from filtering block 502 or from Fourier transform block 504).

By including a dual correlator (e.g., 4903) and a dual demodulator (e.g., 4905), some embodiments may advantageously reuse the same radio (e.g., 4900) to (e.g., simultaneously or sequentially) process signals of conventional OFDM protocols as well as OFDM signals in which a single subcarrier is used at a time. Additional advantages may include the capability of receiving both conventional OFDM signals and OFDM signal over a single subcarrier without a-priori knowledge on which signal is in the air. Such capability may advantageously allow for a device having a very large spread in link budget (e.g., smaller link budget in conventional OFDM, and a larger link budget when transmitting OFDM symbols using a single subcarrier at time, e.g., as shown in FIG. 28), advantageously covering wide areas with both technologies. Such architecture may also advantageously be used to deploy dual networks within the same time scheduling slots (both OFDM and OFDM over single subcarrier can coexist in each communication time slot).

In some embodiments, a transmitter (e.g., 202, 252) may transmit, during a first time, a first packet that includes an STF transmitted using a single subcarrier followed by a rest of the first packet using a first hopping sequence that uses a single subcarrier at a time, and transmit, during a second time, a second packet that includes an STF transmitted using multiple subcarriers.

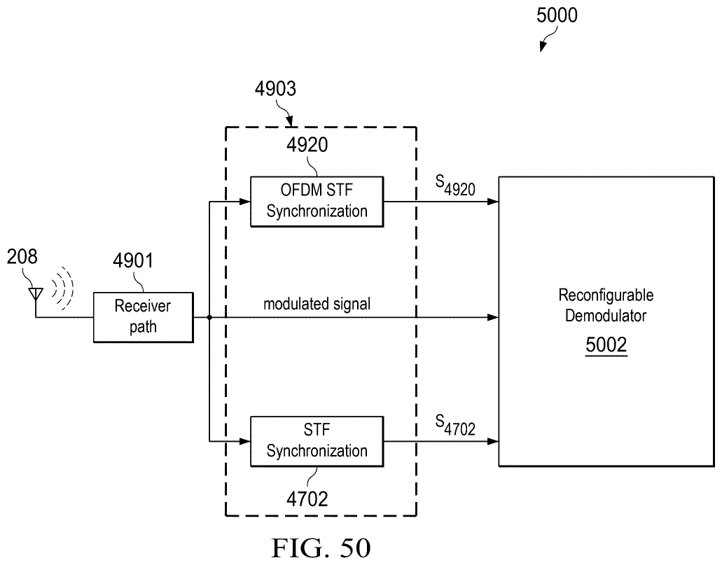

In some embodiments (as shown in FIG. 49), demodulators 4922 and 4902 may be implemented by two different demodulators. In some embodiments, the same demodulator may be used for processing (e.g., sequentially), packets associated with STF synchronization blocks 4920 and 4702. For example, FIG. 50 illustrates device 5000 having common receiver path 4901, dual correlation structure 4903, and reconfigurable demodulator 5002, according to an embodiment of the present disclosure. Device 202 and/or 252 may be implemented as device 5000. Device 5000 may operate in a similar manner as device 4900. Device 5000, however, implements a single reconfigurable demodulator 5002 as opposed to two distinct demodulators (e.g., 4902 and 4922).

During normal operation, in response to signal S₄₉₂₀ being asserted, reconfigurable demodulator 5002 is configured as demodulator 4922 to process the modulated signal. In response to signal S₄₉₀₂ being asserted, reconfigurable demodulator 5002 is configured as demodulator 4902 to process the modulated signal.

In some embodiments, receivers 4700, 4800, 4900, and 5000 may be used to receive data from a plurality of devices, e.g., as shown in FIGS. 41 and 46.

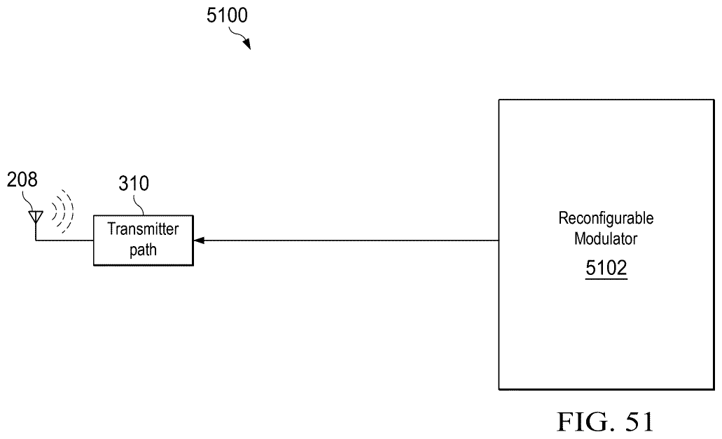

In some embodiments, receivers 4700, 4800, 4900, and 5000 may be used to receive data from a single transmitter device, where such transmitter device alternates between different modulation schemes corresponding to the demodulation schemes described, e.g., with respect to FIGS. 47-50. For example, FIG. 51 illustrates device 5100 having reconfigurable modulator 5102, according to an embodiment of the present disclosure.

In some embodiments, reconfigurable modulator 5102 operates in a similar manner as modulator 3400. For example, in some embodiments, modulator may be configurable and (e.g., dynamically) reconfigurable for generating and transmitting PPDUs 2500 according to various parameter. For example, reconfigurable modulator 5002 may generate and transmit packets in accordance with transmission 3000 during a first time, then transmit packets in accordance with transmission 3100 during a second time, then transmit packets in accordance with transmission 3200 during a third time, and then transmit packets in accordance with transmission 3300 during a fourth time. In some embodiments, some or all packets transmitted by transmitter 5100 are directed to the same device (e.g., including receiver 4700, 4800, 4900, or 5000). In some embodiments, some or all packets transmitted by transmitter 5100 are directed to different devices.

Parameters that may be reconfigured by reconfigurable modulator 5102 include subcarrier frequency for the STF field, hopping sequence (e.g., based on seeds) DSSS, the presence or absence of scrambling, FEC, interleaving, etc. Reconfigurable modulator 5102 may also be reconfigured to, at times, transmit in accordance with the SUN OFDM PHY described in chapter 20 of IEEE Std 802.15.4-2020.

In some embodiments, transmitter 5100 may dynamically change the transmission type (e.g., between SUN OFDM PHY, and using a single subcarrier at a time), e.g., based on whether short range or long range data transmission is desired.

In some embodiments, a device may include the transmitter and receiver (e.g., as shown in FIG. 3). For example, in some embodiments, a device may include a transmitter and receiver, where the transmitter is implemented as transmitter 5100, and the receiver is implemented as receiver 4700, 4800, 4900, or 5000.

In some embodiments, reconfigurable modulator 5102 may be implemented as a single modulator that may be reconfigured depending on the type of transmission desired. In some embodiments, the reconfigurable modulator 5102 may include more than one modulator, where a particular modulator is selected for transmission at a time, e.g., while the other modulators are idle, such as in low power mode.

Example embodiments of the present disclosure are summarized here. Other embodiments can also be understood from the entirety of the specification and the claims filed herein.

Example 1. A device including: a first receiver configured to: detect a first synchronization sequence of a first packet in a first subcarrier of a plurality of subcarriers, and in response to detecting the first synchronization sequence, receive, using a single subcarrier of the plurality of subcarriers at a time, a rest of the first packet using a first hopping sequence hopping through subcarriers of the plurality of subcarriers; and a second receiver configured to: detect a second synchronization sequence of a second packet in a second subcarrier of the plurality of subcarriers, and in response to detecting the second synchronization sequence, receive, using a single subcarrier at a time, a rest of the second packet using a second hopping sequence hopping through subcarriers of the plurality of subcarriers.

Example 2. The device of example 1, where the first and second packets are received from a same device.

Example 3. The device of one of examples 1 or 2, where the second hopping sequence is different from the first hopping sequence.

Example 4. The device of one of examples 1 to 3, where the first hopping sequence is based on a first coefficient, and where the second hopping sequence is based on a second coefficient that is different from the first coefficient.

Example 5. The device of one of examples 1 to 4, where the first synchronization sequence is different form the second synchronization sequence.

Example 6. The device of one of examples 1 to 5, where the first subcarrier is different from the second subcarrier.

Example 7. The device of one of examples 1 to 6, where the first and second packets are consecutive packets.

Example 8. The device of one of examples 1 to 7, where the first receiver includes a first short training field (STF) synchronization circuit, and where the second receiver includes a second STF synchronization circuit.

Example 9. The device of one of examples 1 to 8, where the first receiver includes a first demodulation circuit coupled to the first STF synchronization circuit, and where the second receiver includes a second demodulation circuit coupled to the second STF synchronization circuit.

Example 10. The device of one of examples 1 to 9, where the first demodulation circuit is configured to demodulate the first packet, and where the second demodulation circuit is configured to demodulate the second packet.

Example 11. The device of one of examples 1 to 10, further including a demodulator circuit coupled to the first and second STF synchronization circuits.

Example 12. The device of one of examples 1 to 11, where the demodulator circuit is configured to demodulate the first and second packets.

Example 13. The device of one of examples 1 to 12, further including a transmitter.

Example 14. The device of one of examples 1 to 13, where the transmitter is configured to: during a first time, transmit a third synchronization sequence of a third packet in a first subcarrier of the plurality of subcarriers, and transmit, using a single subcarrier at a time, a rest of the third packet using a third hopping sequence hopping through subcarriers of the plurality of subcarriers; and during a second time, transmit a fourth synchronization sequence of a fourth packet in a fourth subcarrier of the plurality of subcarrier, and transmit, using a single subcarrier at a time, a rest of the fourth packet using a fourth hopping sequence hopping through subcarriers of the plurality of subcarriers.

Example 15. The device of one of examples 1 to 14, where the third subcarrier is equal to the first subcarrier, and the fourth subcarrier is equal to the second subcarrier.

Example 16. The device of one of examples 1 to 15, where the third hopping sequence is equal to the first hopping sequence, and the fourth hopping sequence is equal to the second hopping sequence.

Example 17. The device of one of examples 1 to 16, further including an antenna coupled to the transmitter, and to the first and second receivers.

Example 42. The method of one of examples 1 to 41, further including, in response to detecting the second synchronization sequence, receiving a rest of the second packet using multiple subcarriers at a time.

Example 18. A device including: a transmitter; and a controller configured to: during a first time, transmit, via the transmitter, a first synchronization sequence of a first packet in a first subcarrier of a plurality of subcarriers, and transmit, via the transmitter using a single subcarrier at a time, a rest of the first packet using a first hopping sequence hopping through subcarriers of the plurality of subcarriers; and during a second time, transmit, via the transmitter, a second synchronization sequence of a second packet in a second subcarrier of a plurality of subcarrier, and transmit, via the transmitter using a single subcarrier at a time, a rest of the second packet using a second hopping sequence hopping through subcarriers of the plurality of subcarriers.

Example 19. The device of example 18, where the second hopping sequence is different from the first hopping sequence.

Example 20. The device of one of examples 18 or 19, where the first synchronization sequence is different form the second synchronization sequence.

Example 21. The device of one of examples 18 to 20, where the first subcarrier is different from the second subcarrier.

Example 22. The device of one of examples 18 to 21, where the first and second packets are consecutive packets.

Example 23. A method including: detecting a first synchronization sequence of a first packet in a first subcarrier of a plurality of subcarriers; in response to detecting the first synchronization sequence, receiving, using a single subcarrier of the plurality of subcarriers at a time, a rest of the first packet using a first hopping sequence hopping through subcarriers of the plurality of subcarriers; detecting a second synchronization sequence of a second packet in a second subcarrier of the plurality of subcarriers; and in response to detecting the second synchronization sequence, receiving, using a single subcarrier of the plurality of subcarriers at a time, a rest of the second packet using a second hopping sequence hopping through subcarriers of the plurality of subcarriers.

Example 24. A device including: a first receiver configured to: detect a first synchronization sequence of a first packet in a first subcarrier of a plurality of subcarriers, and in response to detecting the first synchronization sequence, receive, using a single subcarrier of the plurality of subcarriers at a time, a rest of the first packet using a first hopping sequence hopping through subcarriers of the plurality of subcarriers; and a second receiver configured to: detect a second synchronization sequence of a second packet in multiple subcarriers of the plurality of subcarriers, and in response to detecting the second synchronization sequence, receive a rest of the second packet using multiple subcarriers at a time.

Example 25. The device of example 24, further including a demodulator configured to process the first and second packets.

Example 26. The device of one of examples 24 or 25, where the demodulator is a reconfigurable demodulator, where, in response to detecting the first synchronization sequence, the first receiver is configured to reconfigure the demodulator as a single-carrier demodulator to process the first packet, and where in response to detecting the second synchronization sequence, the second receiver is configured to reconfigure the demodulator as a multiple-carrier demodulator to process the second packet.

Example 27. The device of one of examples 24 to 26, further including a single-carrier demodulator configured to process the first packet, and a multiple-carrier demodulator configured to process the second packet.

Example 28. The device of one of examples 24 to 27, where the first and second packets are received from a same device.

Example 29. The device of one of examples 24 to 28, where the first and second packets are consecutive packets.

Example 30. The device of one of examples 24 to 29, where the first receiver includes a single-carrier short training field (STF) synchronization circuit, and where the second receiver includes a multiple-carrier STF synchronization circuit.

Example 31. The device of one of examples 24 to 30, further including: a single-carrier long training field (LTF) synchronization circuit configured to process a portion of the first packet; and a multiple-carrier LTF synchronization circuit configured to process a portion of the second packet.

Example 32. The device of one of examples 24 to 31, where the second receiver is configured to receive and process the first synchronization sequence in parallel to the first receiver receiving and processing the first synchronization sequence, and where the first receiver is configured to receive and process the second synchronization sequence in parallel to the second receiver receiving and processing the second synchronization sequence.

Example 33. The device of one of examples 24 to 32, further including a transmitter configured to: during a first time, transmit a third synchronization sequence of a third packet in a first subcarrier of the plurality of subcarriers, and transmit, using a single subcarrier at a time, a rest of the first packet using a first hopping sequence hopping through subcarriers of the plurality of subcarriers; and during a second time, transmit a second synchronization sequence of a second packet using multiple subcarriers at a time.

Example 34. The device of one of examples 24 to 33, further including an antenna coupled to the transmitter and to the first and second receivers.

Example 35. The device of one of examples 24 to 34, where the first and second packets are consecutive packets.

Example 40. The device of one of examples 24 to 39, where transmitting the first synchronization sequence includes transmitting the first synchronization sequence using direct sequence spread spectrum (DSSS) with a first DSSS value, and where transmitting the rest of the first packet includes transmitting a portion of the rest of the first packet using DSSS with a second DSSS value different than the first DSSS value.

Example 36. A device including: a transmitter; and a controller configured to: during a first time, transmit, via the transmitter, a first synchronization sequence of a first packet in a first subcarrier of a plurality of subcarriers, and transmit, via the transmitter using a single subcarrier at a time, a rest of the first packet using a first hopping sequence hopping through subcarriers of the plurality of subcarriers; and during a second time, transmit a second synchronization sequence of a second packet using multiple subcarriers at a time.

Example 37. The device of example 36, where the controller is configured to transmit, via the transmitter and after transmission of the second synchronization sequence, a rest of the second packet using multiple subcarriers at a time.

Example 38. The device of one of examples 36 or 37, where the multiple subcarriers used for transmission of the second packet are subcarriers of the plurality of subcarriers.

Example 39. The device of one of examples 36 to 38, where the first and second packets are consecutive packets.

Example 41. A method including: detecting a first synchronization sequence of a first packet in a first subcarrier of a plurality of subcarriers; in response to detecting the first synchronization sequence, receiving, using a single subcarrier of the plurality of subcarriers at a time, a rest of the first packet using a first hopping sequence hopping through subcarriers of the plurality of subcarriers; and detecting a second synchronization sequence of a second packet in multiple subcarriers of the plurality of subcarriers.

Example 43. The method of one of examples 41 or 42, where the first and second packets are consecutive packets.

Example 44. The method of one of examples 41 to 43, where a rest of the first packet includes a long training field (LTF), a header field, and a payload field.

Example 45. A method including: during a first time, transmitting, by a device, a first synchronization sequence of a first packet in a first subcarrier of a plurality of subcarriers; and transmitting, by the device using a single subcarrier at a time, a rest of the first packet using a first hopping sequence hopping through subcarriers of the plurality of subcarriers; and during a second time, transmitting, by the device, a second synchronization sequence of a second packet using multiple subcarriers at a time.

Example 46. The method of example 45, further including: receiving first data from a MAC layer, where the first packet includes the first data; and receiving second data from the MAC layer, where the second packet includes the second data.

Example 47. The method of one of examples 45 or 46, where the first packet includes orthogonal frequency-division multiplexing (OFDM) symbols encoded using differential binary phase shift keying (DBPSK).

Example 48. The method of one of examples 45 to 47, where the second packet includes OFDM symbols.

Example 49. The method of one of examples 45 to 48, further including: waking up the device from a sleep mode, where transmitting the first synchronization sequence includes transmitting the first synchronization sequence after waking up the device from the sleep mode; and after transmitting the first synchronization sequence, transitioning the device into the sleep mode.

Example 50. A device including: a receiver path having an output configured to provide a modulated signal; and a demodulator having an input coupled to the output of receiver path; a first STF synchronization circuit coupled to the output of the receiver path and configure to: detect, in the modulated signal, a first synchronization sequence of a first packet in a first subcarrier of a plurality of subcarriers, and in response to detecting the first synchronization sequence, cause the demodulator to process a rest of the first packet, where the first packet is received by the receiver path using a single subcarrier at a time, using a first hopping sequence hopping through subcarriers of the plurality of subcarriers; and a second STF synchronization circuit coupled to the output of the receiver path and configure to: detect, in the modulated signal, a second synchronization sequence of a second packet in a second subcarrier of the plurality of subcarriers, and in response to detecting the second synchronization sequence, cause the demodulator to process a rest of the second packet, where the second packet is received using a single subcarrier at a time, using a second hopping sequence hopping through subcarriers of the plurality of subcarriers.

Example 51. The device of example 50, where the first STF synchronization circuit includes an output coupled to the demodulator, and where the second STF synchronization circuit includes an output coupled to the demodulator.

Example 52. The device of one of examples 50 or 51, where the demodulator is configured to process the rest of the first packet according to a first set of parameters, and where the demodulator is configured to process the rest of the second packet according to a second set of parameters that is different from the first set of parameters.

Example 53. The device of one of examples 50 to 52, where the first set of parameters include a first direct sequence spread spectrum (DSSS) value associate with a header of the first packet, and where the second set of parameters include a second DSSS value associated with a header of the second packet, where the first DSSS value is different from the second DSSS value.

Example 54. The device of one of examples 50 to 53, where the first and second packets are received from a same device.

Example 55. The device of one of examples 50 to 54, where the second hopping sequence is different from the first hopping sequence.

Example 56. The device of one of examples 50 to 55, where the first synchronization sequence is different form the second synchronization sequence.

Example 57. The device of one of examples 50 to 56, where the first subcarrier is different from the second subcarrier.

Example 58. The device of one of examples 50 to 57, where the first and second packets are consecutive packets.

Example 59. The device of one of examples 50 to 58, where the first packet includes orthogonal frequency-division multiplexing (OFDM) symbols encoded using differential binary phase shift keying (DBPSK).

Example 60. The device of one of examples 50 to 59, where a rest of the first packet includes a long training field (LTF), a header field, and a payload field.

Example 61. A method including: providing, by a receiver path, a modulated signal; detecting, by a first STF synchronization circuit coupled to the receiver path, a first synchronization sequence of a first packet in a first subcarrier of a plurality of subcarriers; in response to detecting the first synchronization sequence, causing a demodulator to process a rest of the first packet, where the first packet is received by the receiver path using a single subcarrier at a time, using a first hopping sequence hopping through subcarriers of the plurality of subcarriers; detecting, by a second STF synchronization circuit, a second synchronization sequence of a second packet in a second subcarrier of the plurality of subcarriers; and in response to detecting the second synchronization sequence, causing the demodulator to process a rest of the second packet, where the second packet is received using a single subcarrier at a time, using a second hopping sequence hopping through subcarriers of the plurality of subcarriers.

Example 62. The method of example 61, further including providing, by an antenna, the modulated signal to the receiver path.

Example 63. The method of one of examples 61 or 62, where the first STF synchronization circuit includes an output coupled to the demodulator, and where the second STF synchronization circuit includes an output coupled to the demodulator.

Example 64. The method of one of examples 61 to 63, further including: receiving, by the receiver path, the first packet from a first device; and receiving, by the receiver path, the second packet from the first device.

Example 65. The method of one of examples 61 to 64, further including: receiving, by the receiver path, the first packet from a first device; and receiving, by the receiver path, the second packet from a second device.

Example 66. The method of one of examples 61 to 65, where the first synchronization sequence is different form the second synchronization sequence.

Example 67. The method of one of examples 61 to 66, where the first and second packets are consecutive packets.

Example 68. The method of one of examples 61 to 67, where the first packet includes orthogonal frequency-division multiplexing (OFDM) symbols encoded using differential binary phase shift keying (DBPSK).

Example 69. The method of one of examples 61 to 68, where a rest of the first packet includes a long training field (LTF), a header field, and a payload field.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A device comprising:
a first receiver configured to:
detect a first synchronization sequence of a first packet in a first subcarrier of a plurality of subcarriers, and
in response to detecting the first synchronization sequence, receive, using a single subcarrier of the plurality of subcarriers at a time, a rest of the first packet using a first hopping sequence hopping through subcarriers of the plurality of subcarriers; and
a second receiver configured to:
detect a second synchronization sequence of a second packet in multiple subcarriers of the plurality of subcarriers, and
in response to detecting the second synchronization sequence, receive a rest of the second packet using multiple subcarriers at a time.

2. The device of claim 1, further comprising a demodulator configured to process the first and second packets.

3. The device of claim 2, wherein the demodulator is a reconfigurable demodulator, wherein, in response to detecting the first synchronization sequence, the first receiver is configured to reconfigure the demodulator as a single-carrier demodulator to process the first packet, and wherein in response to detecting the second synchronization sequence, the second receiver is configured to reconfigure the demodulator as a multiple-carrier demodulator to process the second packet.

4. The device of claim 1, further comprising a single-carrier demodulator configured to process the first packet, and a multiple-carrier demodulator configured to process the second packet.

5. The device of claim 1, wherein the first and second packets are received from a same device.

6. The device of claim 1, wherein the first and second packets are consecutive packets.

7. The device of claim 1, wherein the first receiver includes a single-carrier short training field (STF) synchronization circuit, and wherein the second receiver includes a multiple-carrier STF synchronization circuit.

8. The device of claim 7, further comprising:
a single-carrier long training field (LTF) synchronization circuit configured to process a portion of the first packet; and
a multiple-carrier LTF synchronization circuit configured to process a portion of the second packet.

9. The device of claim 1, wherein the second receiver is configured to receive and process the first synchronization sequence in parallel to the first receiver receiving and processing the first synchronization sequence, and wherein the first receiver is configured to receive and process the second synchronization sequence in parallel to the second receiver receiving and processing the second synchronization sequence.

10. The device of claim 1, further comprising a transmitter configured to:
during a first time,
transmit a third synchronization sequence of a third packet in a first subcarrier of the plurality of subcarriers, and
transmit, using a single subcarrier at a time, a rest of the first packet using a first hopping sequence hopping through subcarriers of the plurality of subcarriers; and
during a second time,
transmit a second synchronization sequence of a second packet using multiple subcarriers at a time.

11. The device of claim 10, further comprising an antenna coupled to the transmitter and to the first and second receivers.

12. The device of claim 1, wherein the first and second packets are consecutive packets.

13. A device comprising:
a transmitter; and
a controller configured to:
during a first time,
transmit, via the transmitter, a first synchronization sequence of a first packet in a first subcarrier of a plurality of subcarriers, and
transmit, via the transmitter using a single subcarrier at a time, a rest of the first packet using a first hopping sequence hopping through subcarriers of the plurality of subcarriers; and
during a second time,
transmit a second synchronization sequence of a second packet using multiple subcarriers at a time.

14. The device of claim 13, wherein the controller is configured to transmit, via the transmitter and after transmission of the second synchronization sequence, a rest of the second packet using multiple subcarriers at a time.

15. The device of claim 13, wherein the multiple subcarriers used for transmission of the second packet are subcarriers of the plurality of subcarriers.

16. The device of claim 13, wherein the first and second packets are consecutive packets.

17. The device of claim 12, wherein transmitting the first synchronization sequence comprises transmitting the first synchronization sequence using direct sequence spread spectrum (DSSS) with a first DSSS value, and wherein transmitting the rest of the first packet comprises transmitting a portion of the rest of the first packet using DSSS with a second DSSS value different than the first DSSS value.

18. A method comprising:
detecting a first synchronization sequence of a first packet in a first subcarrier of a plurality of subcarriers;
in response to detecting the first synchronization sequence, receiving, using a single subcarrier of the plurality of subcarriers at a time, a rest of the first packet using a first hopping sequence hopping through subcarriers of the plurality of subcarriers; and
detecting a second synchronization sequence of a second packet in multiple subcarriers of the plurality of subcarriers.

19. The method of claim 4, further comprising, in response to detecting the second synchronization sequence, receiving a rest of the second packet using multiple subcarriers at a time.

20. The method of claim 18, wherein the first and second packets are consecutive packets.

21. The method of claim 18, wherein a rest of the first packet comprises a long training field (LTF), a header field, and a payload field.

22. A method comprising:
during a first time,
transmitting, by a device, a first synchronization sequence of a first packet in a first subcarrier of a plurality of subcarriers; and
transmitting, by the device using a single subcarrier at a time, a rest of the first packet using a first hopping sequence hopping through subcarriers of the plurality of subcarriers; and
during a second time,
transmitting, by the device, a second synchronization sequence of a second packet using multiple subcarriers at a time.

23. The method of claim 22, further comprising:
receiving first data from a MAC layer, wherein the first packet comprises the first data; and
receiving second data from the MAC layer, wherein the second packet comprises the second data.

24. The method of claim 22, wherein the first packet comprises orthogonal frequency-division multiplexing (OFDM) symbols encoded using differential binary phase shift keying (DBPSK).

25. The method of claim 24, wherein the second packet comprises OFDM symbols.

26. The method of claim 22, further comprising:
waking up the device from a sleep mode, wherein transmitting the first synchronization sequence comprises transmitting the first synchronization sequence after waking up the device from the sleep mode; and
after transmitting the first synchronization sequence, transitioning the device into the sleep mode.
